(19) United States
(12) Patent Application Publication
(10) Pub. No.: US 2025/0196725 A1
(43) Pub. Date: Jun. 19, 2025

(54) VEHICLE

(71) Applicant: TS TECH CO., LTD., Asaka-shi, Saitama (JP)

(72) Inventors: Akira MIYOSHI, Tochigi (JP); Munetaka KOWA, Tochigi (JP); Tomoyuki KURIMOTO, Tochigi (JP)

(21) Appl. No.: 18/697,345

(22) PCT Filed: Sep. 21, 2022
(86) PCT No.: PCT/JP2022/035268

§ 371 Date: Dec. 30, 2024

Related U.S. Application Data
(60) Provisional application No. 63/250,479, filed on Sep. 30, 2021.
(60) Provisional application No. 63/250,486, filed on Sep. 30, 2021.
(60) Provisional application No. 63/250,489, filed on Sep. 30, 2021.
(60) Provisional application No. 63/250,480, filed on Sep. 30, 2021.

(51) Int. Cl. B60N 2/005; B60J 7/043; B60N 2/16

(52) U.S. Cl. CPC B60N 2/005; B60J 7/043; B60N 2/16

(57) ABSTRACT

There is provided a vehicle in which a sense of release can be given to an occupant as a passenger compartment can expand and vehicle seats can be freely arranged. A vehicle includes a vehicle body (1) and vehicle seats that are arranged in an interior space of the vehicle body (1). A sunroof (16) is provided to be switchable between a closed position (P1) at which an interior space of the vehicle body (1) is closed and an open position (P2) at which the interior space of the vehicle body (1) is opened. A lifting device (30) includes a lifting operation part (32) to be operated by an occupant, and moves a seat body (20) between a reference position (P3) and an upper position (P4) moved upward from the reference position (P3) as the lifting operation part (32) is operated. An upper end portion of a headrest (23) is disposed above the sunroof (16) having been in the closed position (P1) when the sunroof (16) is in the open position (P2) and the seat body (20) is in the upper position (P4).

### TECHNICAL FIELD

The present invention relates to a vehicle, and more particularly, to a vehicle that includes a vehicle body and vehicle seats arranged in an interior space of the vehicle body.

### BACKGROUND ART

In the related art, a vehicle in which the arrangement of vehicle seats arranged in an interior space of a vehicle body can be changed in the interior space of the vehicle body as the vehicle seats are moved has been known.

For example, PATENT LITERATURE 1 discloses a vehicle in which a vehicle seat includes a rotating mechanism, a reclining mechanism, and a sliding mechanism and a bed surface on which an occupant is to lie down can be formed even in a small space as each of a plurality of vehicle seats is moved.

### CITATION LIST

### Patent Literature

PATENT LITERATURE 1: JP 2021-142771 A

### SUMMARY OF INVENTION

### Technical Problem

In recent years, a need to further change the arrangement of vehicle seats is increasing as autonomous cars spread.

However, since the vehicle disclosed in PATENT LITERATURE 1 has a configuration in which the vehicle seats are moved in the interior space of the vehicle body, a need of an occupant who wants to change the arrangement of the vehicle seats even in an exterior space of the vehicle body could not be sufficiently met.

The present invention has been made in consideration of the above-mentioned problem, and an object of the present invention is to provide a vehicle in which a sense of release can be given to an occupant as a passenger compartment can expand more than that in the related art and vehicle seats can be freely arranged.

### Solution to Problem

In order to achieve the object, according to an aspect of the present invention, there is provided a vehicle that includes a vehicle body and vehicle seats arranged in an interior space of the vehicle body. The vehicle body includes a vehicle body floor on which the vehicle seats are arranged and a vehicle body-outer wall part that is disposed to surround the vehicle seats; the vehicle seat includes a seat body on which an occupant is seated, and a moving device that allows the seat body to be mounted and to move with respect to the vehicle body floor; at least a part of the vehicle body-outer wall part is provided to be switchable between a closed position at which an interior space of the vehicle body is closed and an open position at which the interior space of the vehicle body is opened; the moving device includes an operation part to be operated by the occupant and moves the seat body between a reference position and an upper position moved upward from the reference position as the operation part is operated; and at least a part of the seat body is disposed above at least the part of the vehicle body-outer wall part having been in the closed position when at least the part of the vehicle body-outer wall part is in the open position and the seat body is in the upper position.

According to the above-mentioned configuration, it is possible to realize a vehicle in which a sense of release can be given to an occupant as a passenger compartment can expand and vehicle seats can be freely arranged.

Specifically, since at least a part of the vehicle body-outer wall part can be switched from the reference position to the open position, the seat body is moved upward as being operated by the occupant. Then, at least a part of the seat body is moved to an exterior space of the vehicle body. Accordingly, since the passenger compartment expands and the seat body is moved to the exterior space of the vehicle body, a sense of release can be given to the occupant. Particularly, since an occupant can operate by oneself to move the vehicle seats to a desired position, it is possible to arrange the seat bodies in various ways.

In this case, the seat body may include a seat back and a headrest provided above the seat back. When at least the part of the vehicle body-outer wall part is in the open position and the seat body is in the upper position, an upper end portion of the headrest may be disposed above at least the part of the vehicle body-outer wall part having been in the closed position.

According to the above-mentioned configuration, since the height position of the headrest (the position of the sight line of the occupant) is moved to the exterior space of the vehicle body, the position of the sight line of the occupant becomes higher than the interior space of the vehicle body. As a result, a sense of release of the occupant can be further improved.

In this case, the vehicle body-outer wall part may include a vehicle body-upper wall portion that is disposed above the vehicle seats, and a sunroof that is mounted on the vehicle body-upper wall portion and is disposed at a position corresponding to the seat bodies. The sunroof may be provided to be switchable between the closed position and the open position. When the sunroof is in the open position and the seat body is in the upper position, at least the part of the seat body may be disposed above the sunroof having been in the closed position.

According to the above-mentioned configuration, as the sunroof disposed above the seat bodies is switched from the reference position to the open position, the passenger compartment expands and the seat body is moved up to the exterior space of the vehicle body. As a result, a sense of release can be given to the occupant.

In this case, one end portion and the other end portion of the sunroof in a front to rear direction may be arranged at the same height position as the vehicle body-upper wall portion when the sunroof is in the closed position, and the one end portion and the other end portion may be arranged at a position higher than the vehicle body-upper wall portion when the sunroof is in the open position.

According to the above-mentioned configuration, as the entire sunroof is switched from the reference position to the open position, the passenger compartment can further expand.

In this case, one end portion and the other end portion of the sunroof in a front to rear direction may be arranged at the same height position as the vehicle body-upper wall portion when the sunroof is in the closed position, and the one end portion may be disposed at the same height position as the vehicle body-upper wall portion and the other end portion may be disposed at a position higher than the vehicle body-upper wall portion when the sunroof is in the open position.

According to the above-mentioned configuration, as one side of the sunroof is switched from the reference position to the open position, the passenger compartment can expand with a simple configuration.

In this case, the vehicle may include a first seat body and a second seat body disposed behind the first seat body, on the vehicle body floor, the moving device may move the second seat body between the reference position and the upper position as the operation part is operated, and an upper end portion of the second seat body may be disposed above the sunroof having been in the closed position and above an upper end portion of the first seat body when the sunroof is in the open position and the second seat body is in the upper position.

According to the above-mentioned configuration, since the position of the sight line of an occupant seated on the rear seat body becomes higher the position of the front seat body, the sight line of the rear occupant is not blocked and a sense of release can be given to the rear occupant.

In this case, the vehicle body-outer wall part may include a first sunroof mounted on the vehicle body-upper wall portion and a second sunroof disposed behind the first sunroof, and at least one of the first sunroof and the second sunroof may be provided to be switchable between the closed position and the open position.

According to the above-mentioned configuration, since the sunroof is divided and switched from the reference position to the open position, the passenger compartment can expand in various ways.

In this case, the vehicle may include a first seat body disposed below the vehicle body-upper wall portion and a second seat body disposed below the sunroof and behind the first seat body, on the vehicle body floor, the moving device may move the second seat body between the reference position and the upper position as the operation part is operated, and at least a part of the second seat body may be disposed above the sunroof having been in the closed position when the sunroof is in the open position and the second seat body is in the upper position.

According to the above-mentioned configuration, as the sunroof disposed above the rear seat body is switched from the reference position to the open position, the passenger compartment expands and the rear seat body is moved up to the exterior space of the vehicle body. As a result, a sense of release can be given to the rear occupant even when the front occupant drives the vehicle.

In this case, the vehicle may include a first seat body and a second seat body disposed behind the first seat body, on the vehicle body floor, the moving devices may move the first seat body and the second seat body between the reference position and the upper position as the operation parts are operated, and the first seat body may be disposed at a height position different from a height position of the second seat body when at least the part of the vehicle body-outer wall part is in the open position and the first seat body and the second seat body are in the upper position.

According to the above-mentioned configuration, since each of the plurality of seat bodies can be moved, it is possible to freely arrange the vehicle seats.

In this case, the vehicle seat may include a rotating device that allows the seat body to be mounted and to rotate with respect to the vehicle body floor about an axis parallel to an up to down direction, and the rotating device may rotate the seat body by being operated by the occupant when at least the part of the vehicle body-outer wall part is in the open position and the seat body is in the upper position.

According to the above-mentioned configuration, since the seat body can be rotated, it is possible to freely arrange the vehicle seats.

### Advantageous Effects of Invention

According to the present invention, it is possible to realize a vehicle in which a sense of release can be given to an occupant as a passenger compartment can expand and vehicle seats can be freely arranged.

Further, according to the present invention, the position of the sight line of the occupant becomes higher than the interior space of the vehicle body, so that a sense of release of the occupant can be further improved.

Furthermore, according to the present invention, a sense of release can be given to the occupant.

Moreover, according to the present invention, the passenger compartment can further expand.

Further, according to the present invention, the passenger compartment can expand with a simple configuration.

Furthermore, according to the present invention, the sight line of a rear occupant is not blocked and a sense of release can be given to the rear occupant.

Moreover, according to the present invention, the passenger compartment can expand in various ways.

Further, according to the present invention, a sense of release can be given to a rear occupant even when a front occupant drives the vehicle.

Furthermore, according to the present invention, it is possible to freely arrange the vehicle seats.

### BRIEF DESCRIPTION OF DRAWINGS

FIG. 1 is a side view of a vehicle according to a first embodiment showing a state where a sunroof is in a closed position and seat bodies are in a reference position.

FIG. 2 is a side view of the vehicle showing a state where the sunroof is in an open position and the seat bodies are in an upper position.

FIG. 3 is a side view of a vehicle according to a second embodiment showing a state where a sunroof is in an open position and seat bodies are in upper positions.

FIG. 4 is a side view of a vehicle according to a third embodiment showing a state where sunroofs are in open positions and seat bodies are in upper positions.

FIG. 5 is a side view of a vehicle according to a fourth embodiment showing a state where a sunroof is in an open position and a rear seat body is in an upper position.

FIG. 6 is a top view of a vehicle according to a fifth embodiment showing a state where sliding doors are in closed positions and seat bodies are in a reference position.

FIG. 7 is a top view of the vehicle showing a state where the sliding doors are in open positions and the seat bodies are in a side position.

FIG. 8 is a top view of a vehicle according to a sixth embodiment showing a state where sliding doors are in closed positions and seat bodies are in reference positions.

FIG. 9 is a front view of the vehicle showing a state where the sliding doors are in the closed positions and the seat bodies are in the reference positions.

FIG. 10 is a top view of the vehicle showing a state where the sliding doors are in open positions and the seat bodies are in side positions.

FIG. 11 is a front view of the vehicle showing a state where the sliding doors are in the open positions and the seat bodies are in the side positions.

FIG. 12 is a front view of the vehicle showing a state where the seat bodies are in upper positions.

FIG. 13 is a top view of a vehicle according to a seventh embodiment showing a state where sliding doors are in open positions and right seat bodies are in side positions.

FIG. 14 is a top view of the vehicle showing a state where sunroofs are in closed positions.

FIG. 15 is a diagram showing a state where the arrangement of the seat bodies shown in FIG. 13 is changed.

FIG. 16 is a diagram showing a state where the arrangement of the seat bodies shown in FIG. 15 is changed.

FIG. 17 is a front view of the vehicle showing a state where the sliding doors are in the open positions and the right seat bodies are in the side position.

FIG. 18 is a diagram showing a state where the arrangement of the seat bodies shown in FIG. 16 is changed.

FIG. 19 is a front view of a vehicle according to an eighth embodiment showing a state where sliding doors are in open positions and right seat bodies are in side positions and upper positions.

FIG. 20 is a side view of a vehicle according to a ninth embodiment showing a state where a sunroof and a tailgate are in open positions and seat bodies are in an upper position or a rear position.

FIG. 21 is a top view of the vehicle showing a state where rear seat bodies are in rear positions.

FIG. 22 is a diagram showing a first modification example of FIG. 21.

FIG. 23 is a diagram showing a second modification example of FIG. 21.

FIG. 24 is a diagram showing a third modification example of FIG. 21.

FIG. 25 is a side view of a vehicle according to a tenth embodiment showing a state where seat bodies are in upper positions.

FIG. 26 is a side view of a vehicle according to an eleventh embodiment showing a state where an occupant works out the upper half of one's body.

FIG. 27 is a side view of a vehicle according to a twelfth embodiment showing a state where occupants face each other.

FIG. 28 is a diagram showing a state where the arrangement of seat bodies shown in FIG. 27 is changed.

FIG. 29 is a side view of a vehicle according to a thirteenth embodiment showing a state where occupants work out the lower halves of their bodies.

FIG. 30 is a diagram showing a state where a vehicle seat of a vehicle according to a fourteenth embodiment is rotated.

FIG. 31 is a diagram showing a vehicle seat and a door panel of a vehicle according to a fifteenth embodiment.

FIG. 32 is a diagram showing a vehicle seat of a vehicle according to a sixteenth embodiment.

FIG. 33 is a diagram showing a door panel of the vehicle.

FIG. 34 is a diagram showing an interior space of a vehicle according to a seventeenth embodiment.

FIG. 35 is a diagram showing a vehicle seat of a vehicle according to an eighteenth embodiment.

FIG. 36 is a side view of the vehicle seat showing a state where a sterilization device is caused to emit light.

FIG. 37 is a side view of a vehicle according to a nineteenth embodiment showing a traveling mode.

FIG. 38 is a diagram showing a state where a vehicle body has been transformed from the traveling mode shown in FIG. 37 into a getting-in/off mode.

FIG. 39 shows a modification example of the storage device shown in FIG. 38.

FIG. 40 is a side view of a vehicle according to a twentieth embodiment showing a getting-in/off mode.

FIG. 41 is a side view of a vehicle according to a twenty-first embodiment showing a state where a door is open.

FIG. 42 is a side view of a vehicle according to a twenty-second embodiment showing a structure of a seat-air conditioner.

FIG. 43 is a diagram showing a state where heating/cooling devices are arranged on a vehicle seat and a door panel of a vehicle according to a twenty-third embodiment.

FIG. 44 is a top view of a vehicle according to a twenty-fourth embodiment showing a state where seat bodies are moved.

FIG. 45 shows a first modification example of a partition part shown in FIG. 44.

FIG. 46 shows a second modification example of the partition part shown in FIG. 44.

FIG. 47 is a top view of a vehicle according to a twenty-fifth embodiment showing a state where a seat body is rotated.

FIG. 48 is a top view of a vehicle according to a twenty-sixth embodiment showing a state where a seat body is rotated.

FIG. 49 is a side view of a vehicle.

FIG. 50 is a top view of a vehicle according to a twenty-seventh embodiment showing a state where seat bodies are rotated.

FIG. 51 is a diagram showing a state where the seat bodies are moved from the state of FIG. 50 in which the seat bodies are rotated.

FIG. 52 is a top view of a vehicle according to a twenty-eighth embodiment showing a state where seat backs and armrests are moved.

### DESCRIPTION OF EMBODIMENTS

### First Embodiment

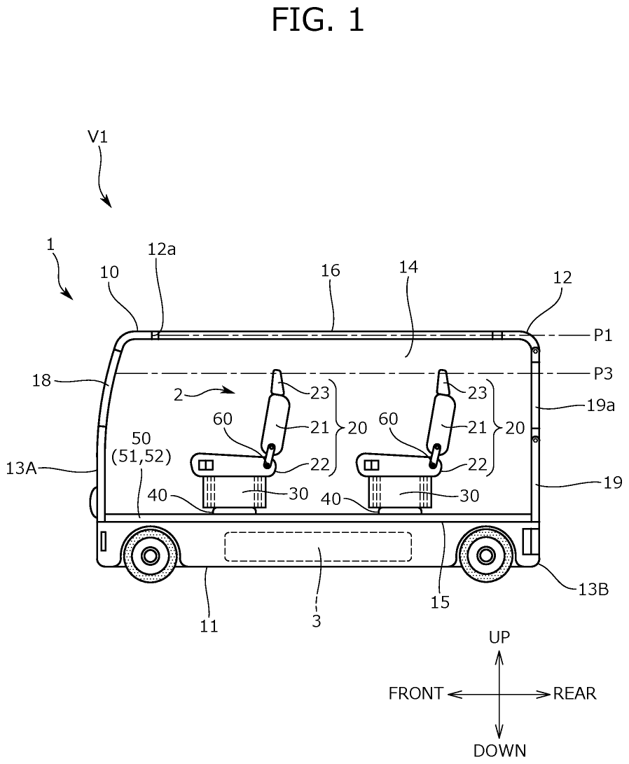

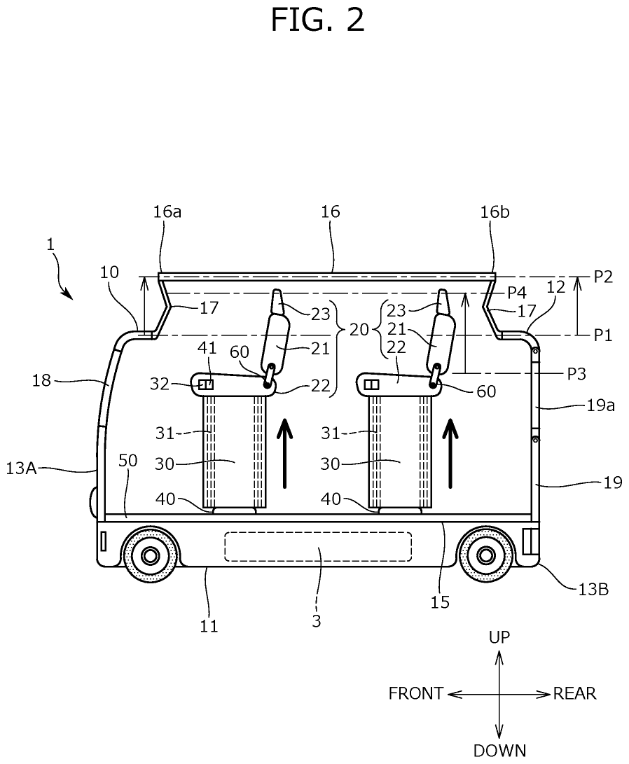

A vehicle V1 according to a first embodiment will be described with reference to FIGS. 1 and 2.

A first embodiment provides a vehicle that includes a vehicle body and vehicle seats, the vehicle body includes a vehicle body floor and a vehicle body-outer wall part, the vehicle seat includes a seat body and a moving device that allows the seat body to be mounted and to move with respect to the vehicle body floor, at least a part of the vehicle body-outer wall part is provided to be switchable between a closed position at which an interior space of the vehicle body is closed and an open position at which the interior space of the vehicle body is opened, the moving device includes an operation part to be operated by an occupant and moves the seat body between a reference position and an upper position moved upward from the reference position as the operation part is operated, and at least a part of the seat body is disposed above at least the part of the vehicle body-outer wall part having been in the closed position when at least a part of the vehicle body-outer wall part is in the open position and the seat body is in the upper position.

In the following description, “front to rear direction” means a front to rear direction when viewed from an occupant of a vehicle seat 2 (hereinafter, sometimes referred to as a seated occupant) as shown in FIG. 1 and is a direction coinciding with a traveling direction of the vehicle V1. “Seat width direction” or “vehicle width direction” is a lateral width direction of a vehicle body 1 and the vehicle seat 2, and coincides with a right to left direction when viewed from the occupant of the vehicle seat 2. Further, “up to down direction” is an up to down direction of the vehicle V1 as shown in FIG. 1, and is a direction coinciding with a vertical direction when the vehicle V1 travels on a horizontal surface. Further, in a case where “outside” is simply mentioned, the “outside” refers to a side closer to the outside of the vehicle V1 in a direction from a center of the vehicle V1 to the outside thereof. In a case where the “inside” is mentioned, “inside” means a side closer to a center of the vehicle V1 in a direction from the outside of the vehicle V1 to the center thereof.

<<Overall Configuration of Vehicle Seat>>

The vehicle V1 according to a first embodiment is, for example, a four-wheeled electric vehicle (EV) that can be automatically driven as shown in FIGS. 1 and 2, and includes a vehicle body 1, vehicle seats 2 that are arranged in an interior space of the vehicle body 1, and a battery 3 for driving a vehicle that supplies electric power to an electric motor.

The vehicle V1 can be switched between a manual driving mode in which a driver drives the vehicle and an automatic driving mode in which a driver does not need to drive the vehicle.

Meanwhile, the vehicle V1 is, for example, a minivan-based camper in the following embodiments, but the present invention can also be applied to any type of vehicle, such as a regular automobile, a wagon, or a sport utility vehicle (SUV). Further, the vehicle is not limited to an electric vehicle that can be automatically driven, and may be a vehicle that is not automatically driven. Furthermore, the vehicle is not limited to an electric vehicle, and may be an engine vehicle, a hybrid vehicle that includes both a motor and an engine for traveling, a vehicle on which a battery and a fuel cell are mounted as an electric power source, or the like.

As shown in FIGS. 1 and 2, the vehicle body 1 includes a vehicle body-outer wall part 10 that is disposed to surround the vehicle seats 2 and a vehicle body floor 15 on which the vehicle seats 2 are arranged.

The vehicle body-outer wall part 10 is to partition off the interior space of the vehicle body 1 from an exterior space of the vehicle body 1. The vehicle body-outer wall part 10 includes a vehicle body-bottom wall portion 11 that is disposed below the vehicle seats 2, a vehicle body-upper wall portion 12 that is disposed above the vehicle seats 2, a vehicle body-front wall portion 13A that is disposed in front of the vehicle seats 2, a vehicle body-rear wall portion 13B that is disposed behind the vehicle seats 2, and vehicle body-side wall portions 14 that are disposed on sides of the vehicle seats 2.

The vehicle body-outer wall part 10 further includes a sunroof 16 that is mounted on the vehicle body-upper wall portion 12, sunroof drive mechanisms 17 that move the sunroof 16 to open and close the sunroof 16, a windshield 18, and a tailgate 19.

Here, the interior space of the vehicle body 1 refers to an inside space of the vehicle body 1 that is surrounded by the vehicle body-upper wall portion 12, the vehicle body-front wall portion 13A, the vehicle body-rear wall portion 13B, the vehicle body-side wall portions 14, the vehicle body floor 15, the sunroof 16 that is not yet moved, the windshield 18, and the tailgate 19.

The exterior space of the vehicle body 1 refers to an outside space of the vehicle body 1 that is surrounded by the vehicle body-upper wall portion 12, the vehicle body-front wall portion 13A, the vehicle body-rear wall portion 13B, the vehicle body-side wall portions 14, the vehicle body floor 15, the sunroof 16 that is not yet moved, the windshield 18, and the tailgate 19.

The vehicle body-bottom wall portion 11 is to partition off the interior space from the exterior space at a lower portion of the vehicle V1. Equipments, such as the battery 3, an ECU of an automatic driving control device, and harness, are arranged on the vehicle body-bottom wall portion 11.

The vehicle body-upper wall portion 12 is to partition off the interior space from the exterior space above the vehicle V1. An opening 12a is formed in a middle portion of the vehicle body-upper wall portion 12. The sunroof 16 is mounted on the vehicle body-upper wall portion 12 to cover the opening 12a. That is, the vehicle body-upper wall portion 12 and the sunroof 16 form a ceiling portion of the vehicle body 1.

The vehicle body-front wall portion 13A is to partition off the interior space from the exterior space in front of the vehicle V1, and the windshield 18 is mounted on the vehicle body-front wall portion 13A.

The vehicle body-rear wall portion 13B is to partition off the interior space from the exterior space behind the vehicle V1, and the tailgate 19 is mounted on the vehicle body-rear wall portion 13B.

The vehicle body-side wall portions 14 are to partition off the interior space from the exterior space on the sides of the vehicle V1, and doors that allows occupants to get in and off the vehicle are mounted on the vehicle body-side wall portions 14.

The vehicle body floor 15 includes a space in which equipments, such as the battery 3, the ECU of the automatic driving control device, and the harness, are stored between the vehicle body-bottom wall portion 11 and itself. Since the vehicle V1 can store the equipments, such as the battery 3, the ECU, and the harness, below the vehicle body floor 15, the vehicle seats 2 can be moved without interfering with the equipments, such as the battery 3, the ECU, and the harness.

Meanwhile, the battery 3 is disposed behind a front end portion of a front seat body 20 as shown in FIG. 1. Further, the battery 3 is disposed in front of a rear end portion of the rear seat body 20.

The sunroof 16 is made of, for example, a translucent material, such as glass, and is disposed above the vehicle seats 2. That is, the sunroof 16 is disposed at a position corresponding to the seat bodies 20 of the vehicle seats 2 (above the seat bodies 20).

Meanwhile, the sunroof 16 may be provided with a shade panel that adjusts the amount of light entering the vehicle from the opening 12a. The shade panel may adjust the amount of light entering the vehicle as the transparency of the shade panel is changed on the basis of the intensity of sunlight.

As shown in FIGS. 1 and 2, the sunroof 16 is mounted to be openable and closable with respect to the vehicle body-upper wall portion 12 by the sunroof drive mechanisms 17. That is, the sunroof 16 is provided to be switchable between a closed position P1 at which the interior space of the vehicle body 1 is closed and an open position P2 at which the interior space of the vehicle body 1 is opened.

Here, opening the interior space of the vehicle body 1 refers to causing the interior space and the exterior space to communicate with each other. When the interior space of the vehicle body 1 is opened, a passenger compartment can be expanded.

Meanwhile, the passenger compartment refers to an area in which an occupant can move, and refers to an inside space (or a space around the inside space) that is surrounded by, for example, the vehicle body-upper wall portion 12, the vehicle body-front wall portion 13A, the vehicle body-rear wall portion 13B, the vehicle body-side wall portions 14, the vehicle body floor 15, the sunroof 16 having been moved, the windshield 18, and the tailgate 19. That is, when the sunroof 16 is in the open position P2, the interior space and a part of the exterior space serves as the passenger compartment.

As shown in FIG. 2, the sunroof drive mechanisms 17 are link members that allow the sunroof 16 to be opened and closed manually or to be opened and closed by the driving of a motor. Upper end portions of the sunroof drive mechanisms 17 are mounted on a front end portion 16a and a rear end portion 16b of the sunroof 16, respectively, and lower end portions thereof are mounted on peripheral edge portions of the opening 12a of the vehicle body-upper wall portion 12, respectively.

As shown in FIG. 2, the front end portion 16a and the rear end portion 16b of the sunroof 16 in the front to rear direction are arranged at the same height position as the vehicle body-upper wall portion 12 when the sunroof 16 is in the closed position P1, and the front end portion 16a and the rear end portion 16b are arranged at a position higher than the vehicle body-upper wall portion 12 when the sunroof 16 is in the open position P2.

The windshield 18 is provided in front of the vehicle seat 2, and is mounted on the vehicle body-front wall portion 13A. The windshield 18 is provided at a position at which a field of view in front of occupants seated on the seat bodies 20 is secured even when the seat bodies 20 of the vehicle seats 2 are moved in the up to down direction or the right to left direction.

The tailgate 19 is mounted to be openable and closable with respect to the vehicle body-rear wall portion 13B by a tailgate drive mechanism (not shown), and includes a rear glass 19a. The tailgate 19 is provided to be switchable between a closed position at which the interior space of the vehicle body 1 is closed and an open position at which the interior space of the vehicle body 1 is opened.

The rear glass 19a is provided at a position at which a field of view behind occupants seated on the seat bodies 20 is secured even when the vehicle seats 2 are moved in the up to down direction or the right to left direction.

As shown in FIGS. 1 and 2, the vehicle seat 2 includes a seat body 20 that includes a seat back 21 and a seat cushion 22, a lifting device 30 that allows the seat body 20 to be mounted and to move up and down with respect to the vehicle body floor 15, a rotating device 40 that allows the seat body 20 to be mounted and to rotate with respect to the vehicle body floor 15 about an axis parallel to the up to down direction, a rail device 50 that supports the seat body 20 to allow the seat body 20 to move forward and rearward with respect to the vehicle body floor 15, and a reclining device 60 that connects the seat back 21 to the seat cushion 22 to allow the seat back 21 to move rotationally.

Meanwhile, the vehicle V1 includes a plurality of seat bodies 20, a plurality of lifting devices 30, a plurality of rotating devices 40, and a plurality of reclining devices 60 on the vehicle body floor 15.

Each of the plurality of seat bodies 20 is provided with the lifting device 30, the rotating device 40, and the reclining device 60. However, the present invention is not limited thereto, and the lifting device 30, the rotating device 40, and the reclining device 60 may be shared by the plurality of seat bodies 20.

Further, the rail device 50 is shared by the plurality of seat bodies 20. However, the present invention is not limited thereto. A plurality of rail devices 50 may be provided on the vehicle body floor 15, and the plurality of seat bodies 20 may be provided with the rail devices 50, respectively.

The seat body 20 includes the seat back 21 that is a backrest part supporting a seated occupant from behind, the seat cushion 22 that is a seat part supporting the seated occupant from below, and a headrest 23 that supports a head of the seated occupant.

The headrest 23 is provided above the seat back 21. Accordingly, when an occupant is seated on the seat body 20, an upper end portion of the headrest 23 is in the same height position as the position of the sight line of an occupant.

The lifting device 30 includes a link mechanism 31 that moves the seat body 20 with respect to the vehicle body floor 15 to allow the seat body 20 to move up and down, and a lifting operation part 32 that is to be operated by an occupant.

The link mechanism 31 is mounted on the seat cushion 22, and moves the seat cushion 22 with respect to the vehicle body floor 15 to allow the seat cushion 22 to move up and down. When the link mechanism 31 is moved by a drive motor, the seat body 20 is movable up and down with respect to the vehicle body floor 15.

The lifting operation part 32 is, for example, a button to be operated by an occupant, and is provided on the seat body 20. When the lifting operation part 32 is operated by an occupant, the drive motor of the link mechanism 31 is driven. Meanwhile, the lifting operation part 32 may be provided on the vehicle body-side wall portion 14, or may be provided separately from the vehicle body 1 or the vehicle seat 2 like a remote controller.

An occupant can operate the drive motor of the link mechanism 31 by a button pressing operation for the lifting operation part 32 to adjust the height of the seat body 20 to a desired position.

Meanwhile, the present invention is not limited to a configuration in which the height of the seat body 20 is adjusted by the control of the drive motor, and may have a configuration in which, for example, the height of the seat body 20 is adjusted by a manual operation of an operation lever.

As shown in FIGS. 1 and 2, the lifting devices 30 move the seat bodies 20 between a reference position P3 and an upper position P4 moved upward from the reference position P3 as the lifting operation parts 32 are operated by occupants.

When the sunroof 16 is in the open position P2 and the seat bodies 20 are in the upper position P4 as shown in FIG. 2, upper end portions (the upper end portions of the headrests 23) of the seat bodies 20 are disposed above the sunroof 16 having been in the closed position P1.

An occupant switches the sunroof 16 of the vehicle body-outer wall part 10 to the open position P2 and operates the lifting operation part 32 to move the seat body 20 up. Accordingly, the occupant can move the headrest 23 of the seat body 20 to the exterior space of the vehicle body 1 to make the position of a sight line higher than the vehicle body-outer wall part 10. Therefore, a sense of release can be given to the occupant.

Since the passenger compartment can be expanded and the seat body 20 can be moved to the exterior space of the vehicle body 1 as described above, the moving distance of the seat body 20 in a height direction can be significantly increased. Particularly, since an occupant can operate the lifting operation part 32 by oneself to move the seat body 20 to a desired position, it is possible to arrange the seat bodies 20 in various ways.

The rotating device 40 is a device that allows the seat body 20 to move rotationally with respect to the vehicle body floor 15, and includes a rotating operation member 41 to be operated by an occupant. The rotating device 40 is mounted on a lower portion of the lifting device 30, and allows the seat body 20 and the lifting device 30 to be rotatably moved with respect to the vehicle body floor 15.

A drive motor provided in the rotating device 40 can be controlled to rotate the seat body 20 with respect to the vehicle body floor 15. Meanwhile, as with the lifting operation part 32, the rotating operation member 41 may also be provided on the vehicle body-side wall portion 14 or may be provided separately from the vehicle body 1 or the vehicle seat 2 like a remote controller.

An occupant can operate the drive motor by a button pressing operation for the rotating operation member 41 to adjust the orientation of the seat body 20 to a desired position.

Meanwhile, the present invention is not limited to a configuration in which the orientation of the seat body 20 is adjusted by the control of the drive motor, and may have a configuration in which, for example, the orientation of the seat body 20 is adjusted by a manual operation of a rotating operation lever.

When the seat body 20 is in the reference position P3 or the upper position P4, the rotating device 40 is operated by an occupant to rotate the seat body 20.

In addition, when the sunroof 16 is in the open position P2 and the seat body 20 is in the upper position P4, the rotating device 40 is operated by an occupant to rotate the seat body 20.

Since the seat body 20 can be rotated even in a state where the seat body 20 is moved up as described above, an occupant can operate the rotating operation member 41 by oneself to rotate the seat body 20 to a desired orientation. For this reason, the seat bodies 20 can be arranged in more various ways.

The rail device 50 is disposed between the seat body 20 and the vehicle body floor 15 in the up to down direction, and mainly includes right and left lower rails 51 that are fixed to the vehicle body floor 15 and extend in the front to rear direction of the seat and right and left upper rails 52 that are supported to be slidable along the lower rails 51.

An occupant can adjust the seat body 20 to a desired position in the front to rear direction using a rail operation lever.

Meanwhile, the present invention is not limited to a configuration in which the position of the seat body 20 in the front to rear direction is adjusted by a manual operation of the rail operation lever, and may have a configuration in which, for example, the position of the seat body 20 in the front to rear direction is adjusted by the control of the drive motor.

The reclining device 60 is a device that connects the seat back 21 to the seat cushion 22 to allow the seat back 21 to move rotationally and can lock the seat back 21.

The reclining device 60 has a configuration in which an occupant tilts the seat back 21 rearward while the state of the seat back 21 is an unlocked state, and the state of the seat back 21 returns to a locked state when a reclining operation lever is released at a point of time when a rearward tilt angle reaches a desired angle.

An occupant can tilt the seat back 21 rearward using the reclining operation lever to adjust the rearward tilt angle to a desired angle.

Meanwhile, the present invention is not limited to a configuration in which the tilt angle of the seat back 21 is adjusted by a manual operation of the reclining operation lever, and may have a configuration in which, for example, the tilt angle of the seat back 21 is adjusted by the control of the drive motor.

When the seat body 20 is moved to the exterior space of the vehicle body 1 by the lifting device 30 and the rail device 50 as described above, the orientation and the tilt angle of the seat can be changed by the rotating device 40 and the reclining device 60.

### Second Embodiment

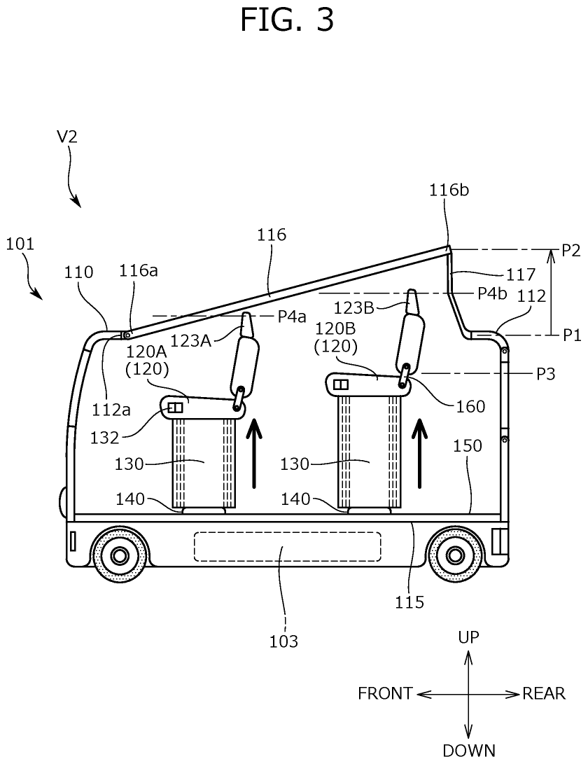

Next, a vehicle V2 according to a second embodiment will be described with reference to FIG. 3.

Meanwhile, the repeated description of the same contents as the vehicle V1 described above will be omitted. The vehicle V2 according to the second embodiment is mainly different from the vehicle V1 in terms of the configuration of a sunroof 116 and a sunroof drive mechanism 117 of a vehicle body-outer wall part 110.

The vehicle V2 includes a battery 103 and a plurality of seat bodies 120. Specifically, the vehicle V2 includes a front seat body 120A, a rear seat body 120B disposed behind the front seat body 120A, a plurality of lifting devices 130, and a plurality of rotating devices 140, on a vehicle body floor 115.

As shown in FIG. 3, a sunroof 116 is mounted such that a rear side of the sunroof 116 can be opened and closed with respect to a vehicle body-upper wall portion 112 by the sunroof drive mechanism 117. That is, the sunroof 116 is provided to be switchable between a closed position P1 at which an interior space of a vehicle body 101 is closed and an open position P2 at which the interior space of the vehicle body 101 is opened. Meanwhile, the sunroof 116 may be mounted such that a front side of the sunroof 116 can be opened and closed.

As shown in FIG. 3, the sunroof drive mechanism 117 is a link member that allows the sunroof 116 to be opened and closed manually or to be opened and closed by the driving of a motor. An upper end portion of the sunroof drive mechanism 117 is mounted on a rear end portion 116b of the sunroof 116, and a lower end portion thereof is mounted on a peripheral edge portion of an opening 112a of the vehicle body-upper wall portion 112.

As shown in FIG. 3, a front end portion 116a and a rear end portion 116b of the sunroof 116 in the front to rear direction are arranged at the same height position as the vehicle body-upper wall portion 112 when the sunroof 116 is in the closed position P1, and the front end portion 116a is disposed at the same height position as the vehicle body-upper wall portion 112 and the rear end portion 116b is disposed at a position higher than the vehicle body-upper wall portion 112 when the sunroof 116 is in the open position P2.

As shown in FIG. 3, the lifting devices 130 move the front seat body 120A and the rear seat body 120B between a reference position P3 and upper positions P4a and P4b moved upward from the reference position P3, respectively, as lifting operation parts 132 are operated by occupants.

When the sunroof 116 is in the open position P2 and the front seat body 120A and the rear seat body 120B are in the upper positions P4a and P4b as shown in FIG. 3, upper end portions of the seat bodies 120 (upper end portions of respective front and rear headrests 123A and 123B) are arranged above the sunroof 116 having been in the closed position P1.

When the sunroof 116 is in the open position P2 and the front seat body 120A and the rear seat body 120B are in the upper positions P4a and P4b, the front seat body 120A is disposed at a height position different from the height position of the rear seat body 120B.

Specifically, the upper end portion of the rear headrest 123B is disposed at a position higher than the upper end portion of the front headrest 123A.

The upper end portion of the rear headrest 123B is disposed above the sunroof 116 having been in the closed position P1 and above the upper end portion of the front headrest 123A.

For this reason, since the position of the sight line of an occupant seated in the rear seat body 120B is higher than that of an occupant seated in the front seat body 120A, the sight line of the rear occupant is not blocked and a sense of release can be given to the rear occupant.

When the seat bodies 120 are moved to an exterior space of the vehicle body 101 by the lifting devices 130 and a rail device 150 as described above, the orientations and the tilt angles of the seats can be changed by the rotating devices 140 and reclining devices 160.

### Third Embodiment

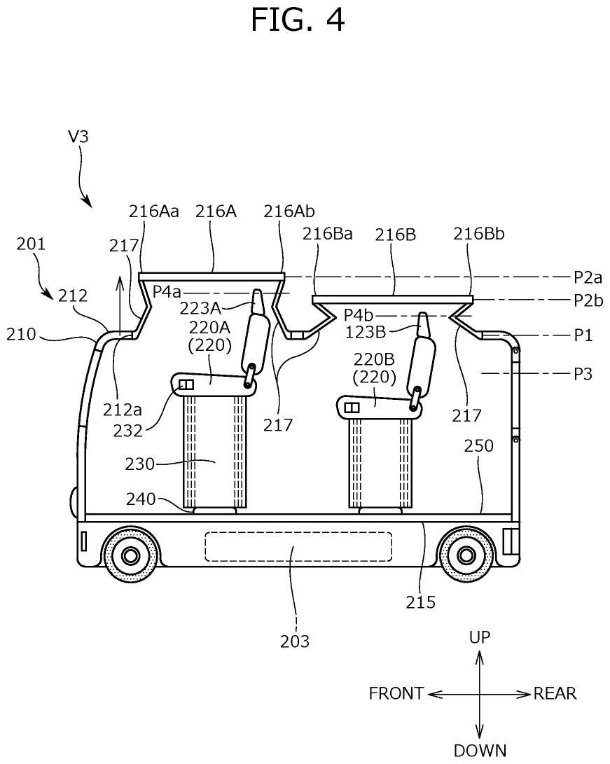

Next, a vehicle V3 according to a third embodiment will be described with reference to FIG. 4.

Meanwhile, the repeated description of the same contents as the vehicles V1 and V2 described above will be omitted.

The vehicle V3 according to the third embodiment is mainly different from the vehicles V1 and V2 in terms of the configuration of a front sunroof 216A, a rear sunroof 216B, and sunroof drive mechanisms 217 of a vehicle body 201.

The vehicle V3 includes a battery 203 and a plurality of seat bodies 220. Specifically, the vehicle V3 includes a front seat body 220A, a rear seat body 220B disposed behind the front seat body 220A, a plurality of lifting devices 230, and a plurality of rotating devices 240, on a vehicle body floor 215.

A vehicle body-outer wall part 210 includes a front sunroof 216A that is mounted on a vehicle body-upper wall portion 212 and a rear sunroof 216B that is disposed behind the front sunroof 216A.

That is, the front sunroof 216A and the rear sunroof 216B are provided to be switchable between a closed position P1 at which an interior space of the vehicle body 201 is closed and open positions P2a and P2b at which the interior space of the vehicle body 201 is opened.

As shown in FIG. 4, the sunroof drive mechanisms 217 are link members that allow the sunroofs 216 to be opened and closed manually or to be opened and closed by the driving of motors. Upper end portions of the front sunroof drive mechanisms 217 are mounted on a front end portion 216Aa and a rear end portion 216Ab of the front sunroof 216A, respectively, and lower end portions thereof are mounted on peripheral edge portions of an opening 212a of the vehicle body-upper wall portion 212.

Likewise, upper end portions of the rear sunroof drive mechanisms 217 are mounted on a front end portion 216Ba and a rear end portion 216Bb of the rear sunroof 216B, respectively, and lower end portions thereof are mounted on peripheral edge portions of the opening 212a of the vehicle body-upper wall portion 212.

As shown in FIG. 4, the lifting devices 230 move the front seat body 220A and the rear seat body 220B between a reference position P3 and upper positions P4a and P4b moved upward from the reference position P3, respectively, as lifting operation parts 232 are operated by occupants.

When the front sunroof 216A and the rear sunroof 216B are in the open positions P2a and P2b and the front seat body 220A and the rear seat body 220B are in the upper positions P4a and P4b, the front seat body 220A is disposed at a height position different from the height position of the rear seat body 220B.

Specifically, an upper end portion of a rear headrest 223B is disposed at a position lower than an upper end portion of a front headrest 223A.

When the seat bodies 220 are moved to an exterior space of the vehicle body 201 by the lifting devices 230 and a rail device 250 as described above, the orientations and the tilt angles of the seats can be changed by the rotating devices 240 and reclining devices 260.

### Fourth Embodiment

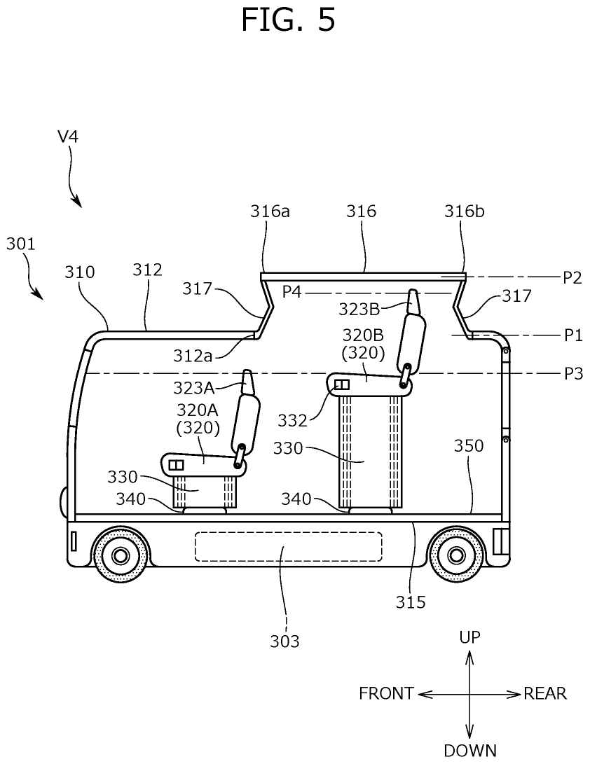

Next, a vehicle V4 according to a third embodiment will be described with reference to FIG. 5.

Meanwhile, the repeated description of the same contents as the vehicles V1 to V3 described above will be omitted.

The vehicle V4 according to the fourth embodiment is mainly different from the vehicles V1 to V3 in terms of the configuration of a sunroof 316 and sunroof drive mechanisms 317 of a vehicle body-outer wall part 310.

The vehicle V4 includes a battery 303 and a plurality of seat bodies 320. Specifically, the vehicle V4 includes a front seat body 320A, a rear seat body 320B disposed behind the front seat body 320A, a plurality of lifting devices 330, and a plurality of rotating devices 340, on a vehicle body floor 315.

In this case, the front seat body 320A is disposed on the vehicle body floor 315 below a vehicle body-upper wall portion 312, and the rear seat body 320B is disposed below the sunroof 316.

As shown in FIG. 5, the sunroof drive mechanisms 317 are link members that allow the sunroof 316 to be opened and closed manually or to be opened and closed by the driving of a motor. Upper end portions of the sunroof drive mechanisms 317 are mounted on a front end portion 316a and a rear end portion 316b of the sunroof 316, respectively, and lower end portions thereof are mounted on peripheral edge portions of an opening 312a of the vehicle body-upper wall portion 312.

As shown in FIG. 5, the lifting device 330 moves the rear seat body 320B between a reference position P3 and an upper position P4 moved upward from the reference position P3 as a lifting operation part 332 is operated by an occupant.

When the sunroof 316 is in an open position P2 and the rear seat body 320B is in the upper position P4, an upper end portion of a rear headrest 323B is disposed at a position lower than an upper end portion of a front headrest 323A.

An occupant can move the rear headrest 323B of the rear seat body 320B to an exterior space of a vehicle body 301 to make the position of a sight line higher than the vehicle body-outer wall part 310. Accordingly, a sense of release can be given to the occupant.

In addition, even when a driver is driving, a sense of release can be given to the occupant seated behind the driver.

When the seat body 320 is moved to the exterior space of the vehicle body 301 by the lifting device 330 and a rail device 350 as described above, the orientation and the tilt angle of the seat can be changed by the rotating device 340 and a reclining device 360.

### Fifth Embodiment

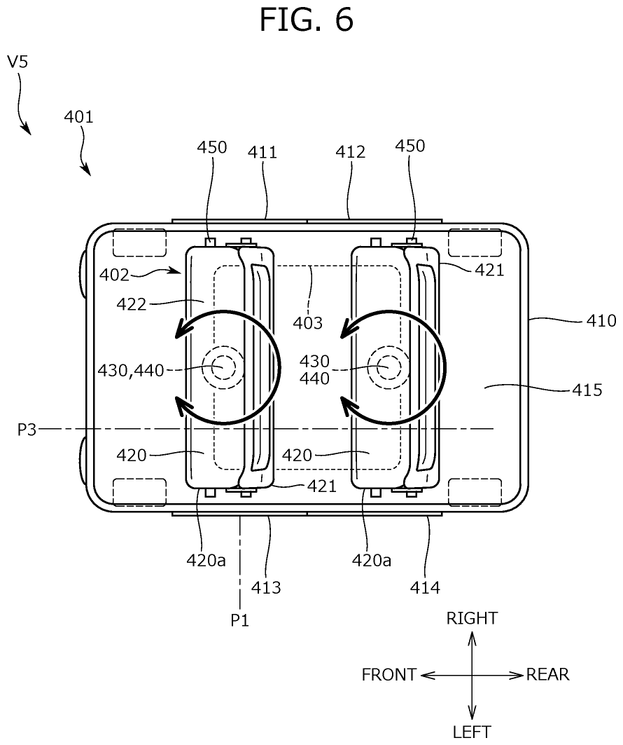

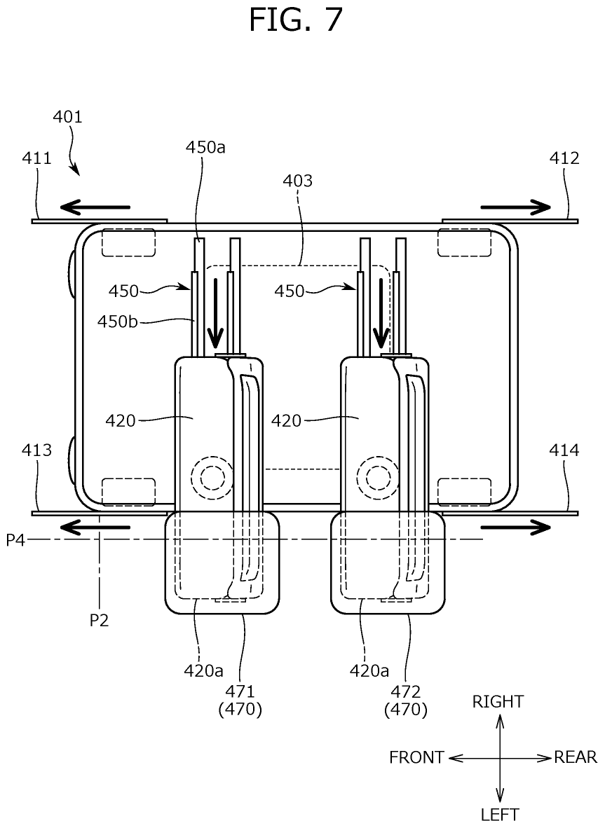

Next, a vehicle V5 according to a fifth embodiment will be described with reference to FIGS. 6 and 7.

Meanwhile, the repeated description of the same contents as the vehicles V1 to V4 described above will be omitted.

As shown in FIGS. 6 and 7, a vehicle body 401 includes a vehicle body-outer wall part 410 that is disposed to surround vehicle seats 402 and a vehicle body floor 415 on which the vehicle seats 402 are arranged.

The vehicle body-outer wall part 410 includes a right front sliding door 411, a right rear sliding door 412, a left front sliding door 413, and a left rear sliding door 414 as sliding doors that allow occupants to get in and off the vehicle.

Each sliding door is to partition off an interior space from an exterior space on a side of the vehicle V5.

As shown in FIGS. 6 and 7, each sliding door is mounted to be openable and closable with respect to the vehicle body-outer wall part 410. That is, each sliding door is provided to be switchable between a closed position P1 at which an interior space of the vehicle body 401 is closed and an open position P2 at which the interior space of the vehicle body 1 is opened.

As shown in FIGS. 6 and 7, the vehicle seat 402 includes a seat body 420 that includes a seat back 421 and a seat cushion 422, a lifting device 430 that allows the seat body 420 to be mounted and to move up and down with respect to the vehicle body floor 415, a rotating device 440 that allows the seat body 420 to be mounted and to rotate with respect to the vehicle body floor 415 about an axis parallel to the up to down direction, a rail device 450 that supports the seat body 420 to allow the seat body 420 to move rightward and leftward with respect to the vehicle body floor 415, a reclining device that connects the seat back 421 to the seat cushion 422 to allow the seat back 421 to move rotationally, and an awning device 470 that is mounted on an upper end portion of the vehicle body-outer wall part 410.

The seat body 420 is a bench-type seat body extending in the right to left direction. The seat body 420 is moved with respect to the vehicle body floor 415 in the right to left direction between a reference position P3 and a side position P4, which is moved to a side (outside) from the reference position P3, by the rail device 450.

The rail device 450 is disposed between the seat body 420 and the vehicle body floor 415 in the up to down direction, is fixed to the vehicle body floor 415, and includes two lower rails 450a that extend in the right to left direction and two upper rails 450b that are supported to be slidable along the lower rails 450a. The rail device 450 is provided for each of the plurality of seat bodies 420.

Meanwhile, as shown in FIG. 7, a battery 403 for driving a vehicle is disposed behind the front upper rail 450b for a front seat body 420. Further, the battery 403 is disposed in front of the rear lower rail 450a for a rear seat body 420.

The rail devices 450 move the seat bodies 420 between the reference position P3 and the side position P4 moved to a side (outside) from the reference position P3 as shown in FIGS. 6 and 7 as rail operation levers are operated by occupants.

For example, as shown in FIG. 7, when the left front sliding door 413 is in the open position P2 and the seat body 420 is in the side position P4, a seat end portion 420a of the seat body 420 is disposed on a side of (outside) the left front sliding door 413 having been in the closed position P1.

An occupant switches the left front sliding door 413 of the vehicle body-outer wall part 410 to the open position P2 and operates the rail operation lever to move the seat body 420 to a side. Accordingly, the occupant can move the seat end portion 420a of the seat body 420 to the exterior space of the vehicle body 401 to move the position of a sight line to the outside of the vehicle body-outer wall part 410. Therefore, a sense of release can be given to the occupant.

Since the passenger compartment can be expanded and the seat body 420 can be moved to the exterior space of the vehicle body 401 as described above, the moving distance of the seat body 420 in a vehicle width direction can be significantly increased. Particularly, since an occupant can operate the rail operation lever by oneself to move the seat body 420 to a desired position, it is possible to arrange the seat bodies 420 in various ways.

The awning device 470 is provided on an upper surface of the vehicle body-outer wall part 410, and includes a front awning part 471 and a rear awning part 472 used as a rain cover and a sunshade. The front awning part 471 and the rear awning part 472 are movably mounted on the vehicle body-outer wall part 410. That is, the front awning part 471 and the rear awning part 472 are provided to be switchable between a storage position at which the awning part overlaps an upper surface of the vehicle body-outer wall part 410 in the up to down direction and a use position at which the awning part overhangs the vehicle body-outer wall part 410 outward.

Meanwhile, the awning device 470 may be a rail-type awning device in which the front awning part 471 and the rear awning part 472 slide with respect to the upper surface of the vehicle body-outer wall part 410, or may be an extension-type awning device in which the front awning part 471 and the rear awning part 472 are extensible.

When the front seat body 420 is in the side position P4 and the front awning part 471 is in the use position, the front awning part 471 is disposed above the front seat body 420.

When the rear seat body 420 is in the side position P4 and the rear awning part 472 is in the use position, the rear awning part 472 is disposed above the rear seat body 420.

When the seat body 420 is moved to the exterior space of the vehicle body 401 by the lifting device 430 and the rail device 450 as described above, the orientation and the tilt angle of the seat can be changed by the rotating device 440 and the reclining device 460.

### Sixth Embodiment

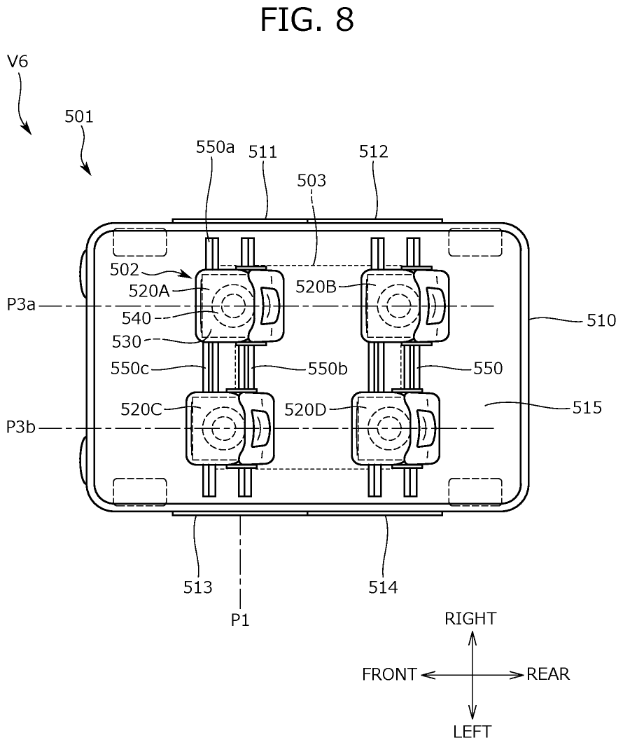

Next, a vehicle V6 according to a sixth embodiment will be described with reference to FIGS. 8 to 12.

Meanwhile, the repeated description of the same contents as the vehicles V1 to V5 described above will be omitted.

As shown in FIGS. 8 to 12, a vehicle body 501 includes a vehicle body-outer wall part 510 that is disposed to surround vehicle seats 502, a vehicle body floor 515 on which the vehicle seats 502 are arranged, and sunroofs 516.

The vehicle body-outer wall part 510 includes a right front sliding door 511, a right rear sliding door 512, a left front sliding door 513, and a left rear sliding door 514 as sliding doors that allow occupants to get in and off the vehicle.

As shown in FIGS. 8 to 12, the vehicle seat 502 includes a seat body 520 that includes a seat back 521 and a seat cushion 522, a lifting device 530 that allows the seat body 520 to be mounted and to allow the seat body 520 to move up and down with respect to the vehicle body floor 515, a rotating device 540 that allows the seat body 520 to be mounted and to rotate with respect to the vehicle body floor 515 about an axis parallel to the up to down direction, a rail device 550 that supports the seat bodies 520 to allow the seat bodies 520 to move rightward and leftward with respect to the vehicle body floor 515, a reclining device 560 that connects the seat back 521 to the seat cushion 522 to allow the seat back 521 to move rotationally, and an awning device 570 that is mounted on the sunroof 516.

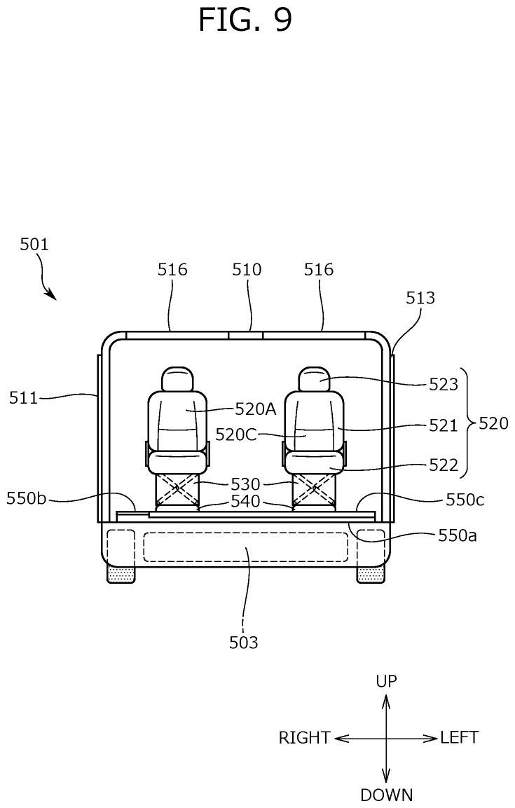

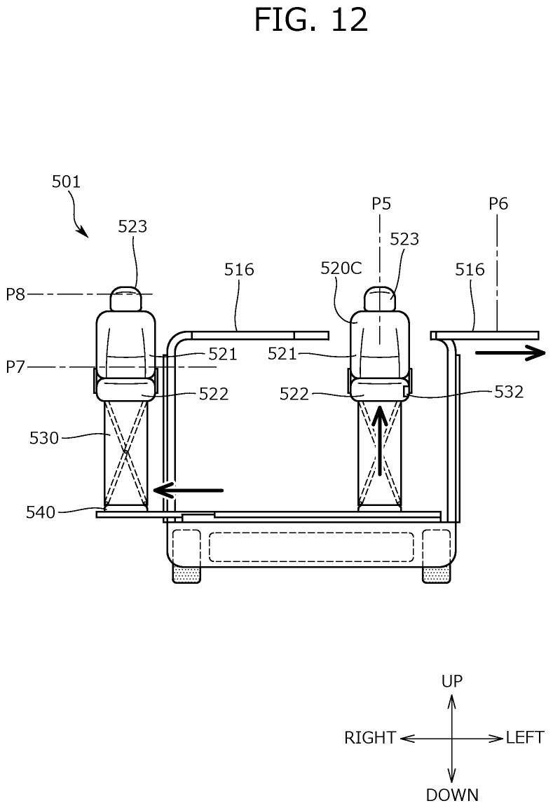

As shown in FIGS. 9 and 12, the sunroofs 516 are mounted to be openable and closable with respect to an upper surface of the vehicle body-outer wall part 510 in the right to left direction. That is, the sunroof 516 is provided to be switchable between a closed position P5 at which an interior space of the vehicle body 501 is closed and an open position P6 at which the interior space of the vehicle body 501 is opened.

The vehicle V6 includes a battery 503 and a plurality of seat bodies 520. Specifically, the vehicle V6 includes a right front seat body 520A, a right rear seat body 520B disposed behind the right front seat body 520A, a left front seat body 520C disposed on the left side of the right front seat body 520A, and a left rear seat body 520D disposed behind the left front seat body 520C, on the vehicle body floor 515.

As shown in FIG. 12, the lifting devices 530 move the right front seat body 520A and the left front seat body 520C between a reference position P7 and an upper position P8 moved upward from the reference position P7 as lifting operation parts 532 are operated by occupants.

When the sunroof 516 is in the open position P6 and the seat body 520 is in the upper position P8 as shown in FIG. 12, an upper end portion (an upper end portion of a headrest 523) of the seat body 520 is disposed above the sunroof 516 having been in the closed position P5.

The rail device 550 is disposed between the seat body 520 and the vehicle body floor 515 in the up to down direction, and includes two lower rails 550a that are fixed to the vehicle body floor 515 and extend in the right to left direction, two first upper rails 550b that are provided on the right seat body (the right front seat body 520A or the right rear seat body 520B) and are supported to be slidable along the lower rails 550a, and two second upper rails 550c that are provided on the left seat body (the left front seat body 520C or the left rear seat body 520D) and are supported to be slidable along the lower rails 550a.

The front rail device 550 allows the right front seat body 520A and the left front seat body 520C to move in the right to left direction, and the rear rail device 550 allows the right rear seat body 520B and the left rear seat body 520D to move in the right to left direction.

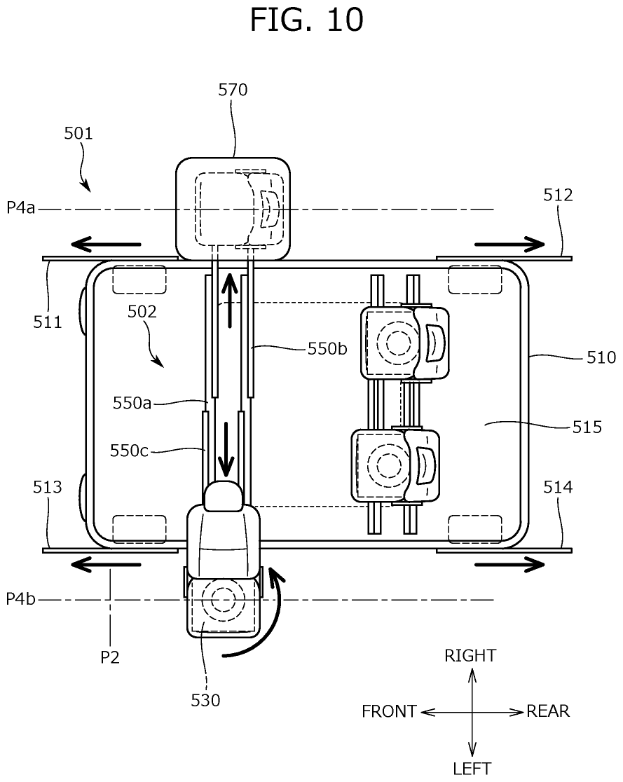

The rail devices 550 move the seat bodies 520 between reference positions P3a and P3b and side positions P4a and P4b moved to a side (outside) from the reference positions P3a and P3b as shown in FIGS. 8 and 10 as rail operation levers are operated by occupants.

For example, when the right front sliding door 511 and the left front sliding door 513 are in an open position P2 and the seat bodies 520 are in the side positions P4a and P4b, the seat bodies 520 are disposed on sides of (outside) the right front sliding door 511 and the left front sliding door 513 having been in a closed position P1.

Meanwhile, the seat body 520 includes a footrest 524 that can move rotationally with respect to the seat cushion 522.

The headrest 523 of the seat body 520 includes a seat awning part 523a that is used as a rain cover and a sunshade.

When the seat bodies 520 are moved to an exterior space by the lifting devices 530 and the rail devices 550 as described above, it is possible to arrange the seat bodies 520 in a desired form by changing the orientations and the tilt angles of the seats with the rotating devices 540 and the reclining devices 560 and causing the footrests 524 and the seat awning parts 523a to move rotationally.

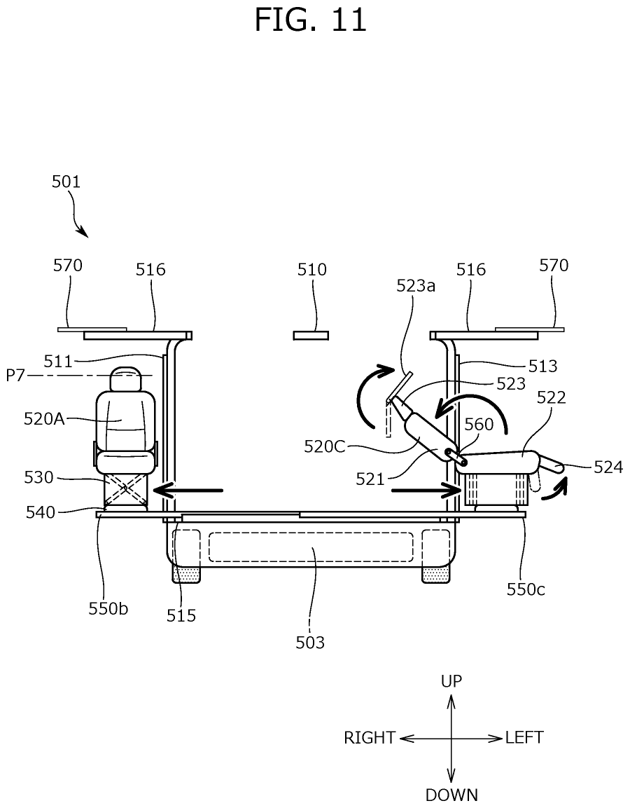

Meanwhile, since the orientations and the tilt angles of the seats can be changed not only when the seat bodies 520 are arranged at the reference position P7 as shown in FIG. 11 but also when the seat bodies 520 are arranged at the upper position P8, the seat bodies 520 can be arranged in a desired form. In addition, since the orientations and the tilt angles of the seats can be changed even when the seat bodies 520 are arranged in the interior space, the seat bodies 520 can be arranged in a desired form at various positions.

### Seventh Embodiment

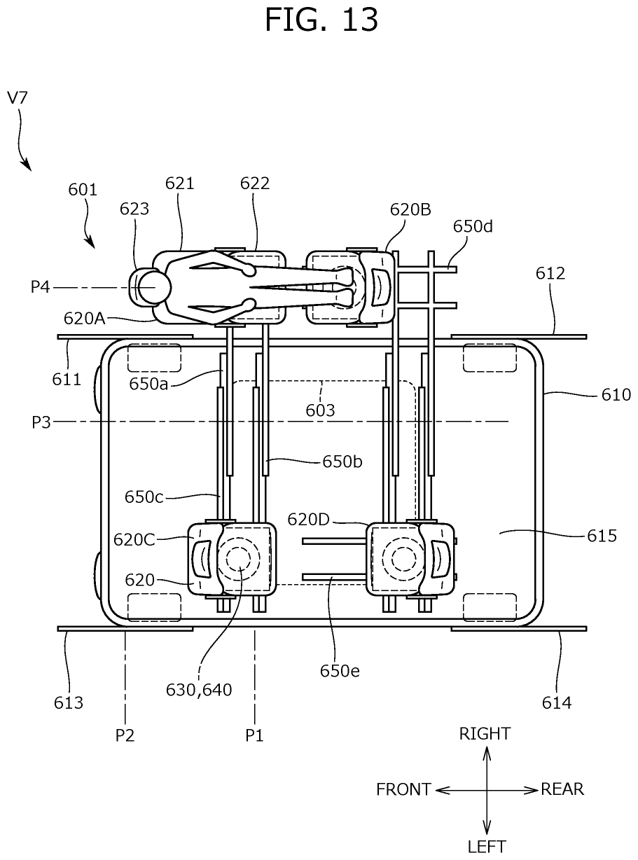

Next, a vehicle V7 according to a seventh embodiment will be described with reference to FIGS. 13 to 18.

Meanwhile, the repeated description of the same contents as the vehicles V1 to V6 described above will be omitted.

The vehicle V7 according to the seventh embodiment is mainly different from the vehicles V1 to V6 in terms of the configuration of sunroofs 616 and rail devices 650.

A vehicle body-outer wall part 610 includes a right front sunroof 616A mounted on a vehicle body-upper wall portion, a right rear sunroof 616B disposed behind the right front sunroof 616A, a left front sunroof 616C disposed on the left side of the right front sunroof 616A, and a left rear sunroof 616D disposed behind the left front sunroof 616C.

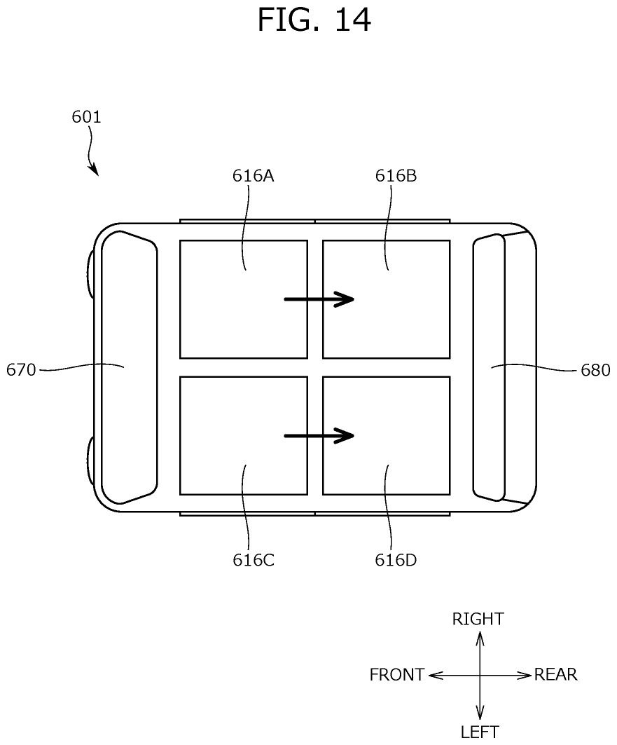

As shown in FIG. 14, the right front sunroof 616A and the left front sunroof 616C arranged on the front side are mounted to be slidable with respect to an upper surface of the vehicle body-outer wall part 610 in the front to rear direction. That is, the right front sunroof 616A and the left front sunroof 616C are moved from a windshield 670 side to a rear glass 680 side to open an interior space of a vehicle body 601.

The right front sunroof 616A and the left front sunroof 616C are adapted to slide in the front to rear direction to be openable and closable in this embodiment, but may slide in the right to left direction. Further, the right front sunroof 616A and the left front sunroof 616C are not limited to sliding, and may be adapted to move rotationally using rotating shafts extending in the right to left direction or rotating shafts extending in the front to rear direction and to be openable and closable.

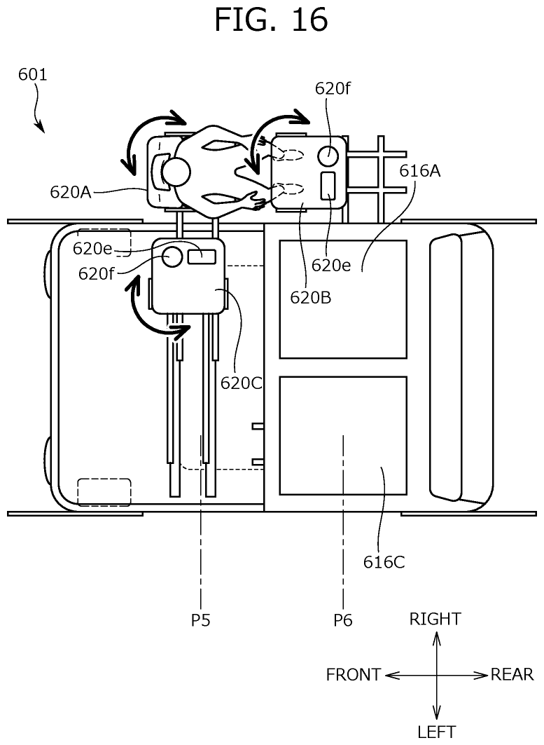

As shown in FIG. 16, the right front sunroof 616A and the left front sunroof 616C arranged on the front side are provided to be switchable between a closed position P5 at which the interior space of the vehicle body 601 is closed and an open position P6 at which the interior space of the vehicle body 601 is opened.

The right rear sunroof 616B and the left rear sunroof 616D arranged on the rear side are fixed to the upper surface of the vehicle body-outer wall part 610, and are arranged at positions at which the right front sunroof 616A and the left front sunroof 616C overlap the right rear sunroof 616B and the left rear sunroof 616D in the up to down direction when being moved rearward.

The vehicle body-outer wall part 610 includes a right front sliding door 611, a right rear sliding door 612, a left front sliding door 613, and a left rear sliding door 614 as sliding doors that allow occupants to get in and off the vehicle.

The vehicle V7 includes a battery 603 and a plurality of seat bodies 620. Specifically, the vehicle V7 includes a right front seat body 620A, a right rear seat body 620B disposed behind the right front seat body 620A, a left front seat body 620C disposed on the left side of the right front seat body 620A, and a left rear seat body 620D disposed behind the left front seat body 620C, on a vehicle body floor 615.

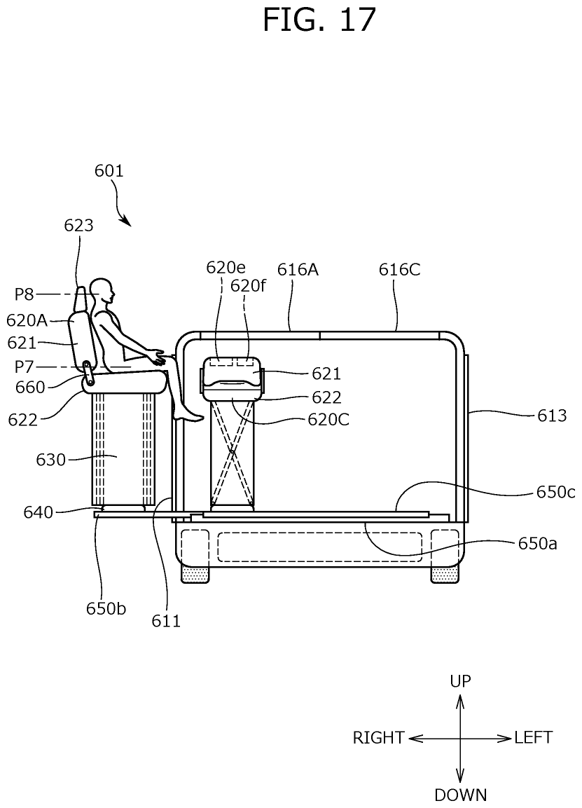

As shown in FIG. 17, a lifting device 630 moves the seat body 620 between a reference position P7 and an upper position P8 moved upward from the reference position P7 with an occupant's operation.

The rear rail device 650 of the vehicle body 601 includes two lower rails 650a that extend in the right to left direction, two first upper rails 650b that are provided on the right rear seat body 620B and are supported to be slidable along the lower rails 650a, and two second upper rails 650c that are provided on the left rear seat body 620D and are supported to be slidable along the lower rails 650a.

The rail device 650 further includes two first sub-rails 650d that are supported by the first upper rails 650b and two second sub-rails 650e that are supported by the second upper rails 650c.

The first sub-rails 650d and the second sub-rails 650e of the rear rail device 650 allow the right rear seat body 620B and the left rear seat body 620D to move in the front to rear direction, respectively.

Likewise, the front rail device 650 may also be adapted to include first sub-rails 650d and second sub-rails 650e.

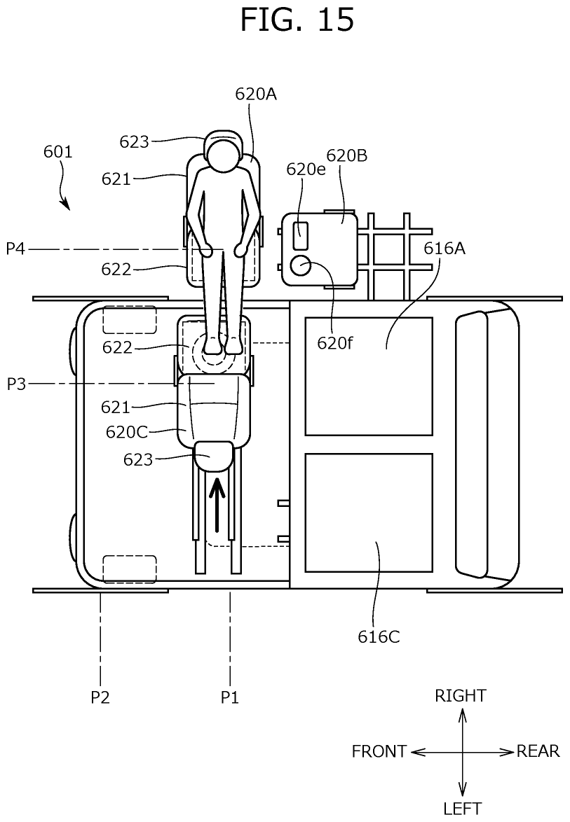

Further, a small object storage part 620e where a small object is to be placed and a drink storage part 620f where a drink is to be placed are formed on a back side of a seat back 621 of the seat body 620 as shown in FIGS. 15 to 17.

The seat back 621 is transformed into a desk shape when being folded down by a reclining device 660 such that the back side of the seat back 621 faces upward.

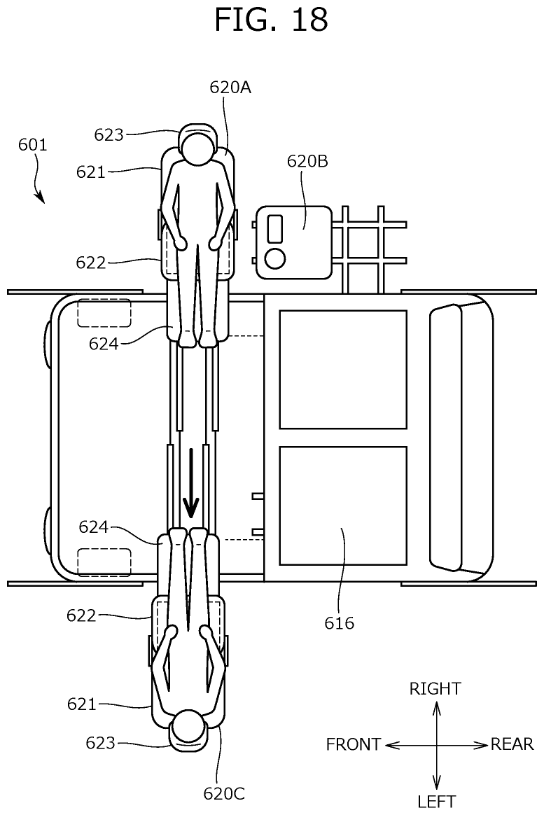

Meanwhile, as shown in FIG. 18, the seat body 620 may include a footrest 624 that is mounted on a seat cushion 622 to be rotationally movable.

When the seat bodies 620 are moved to an exterior space by the lifting devices 630 and the rail devices 650 as described above, it is possible to arrange the seat bodies 620 in a desired form, such as a footrest shape or a desk shape, by changing the orientations and the tilt angles of the seats with rotating devices 640 and the reclining devices 660. Further, since the positions of the seat bodies 620 can be finely adjusted in the front to rear direction with the first sub-rails 650d and the second sub-rails 650e, it is possible to arrange the seat bodies 620 in a more desired form.

Furthermore, when the right front seat body 620A and the left front seat body 620C are moved to the exterior space as shown in FIG. 18, it is possible to arrange the plurality of seat bodies 620 in a still more desired form by changing the orientations of the seats with the rotating devices 640 to allow the seats to face each other and changing the orientations and the tilt angles of the seats with the reclining devices 660.

### Eighth Embodiment

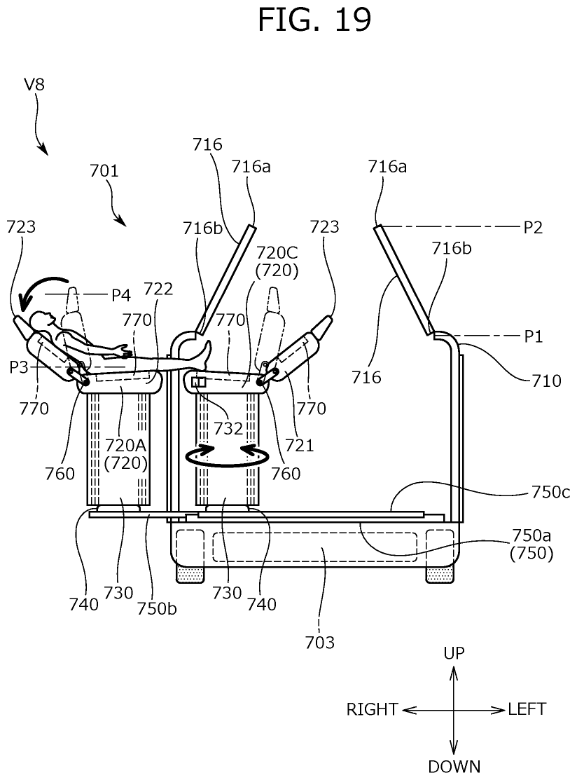

Next, a vehicle V8 according to an eighth embodiment will be described with reference to FIG. 19.

Meanwhile, the repeated description of the same contents as the vehicles V1 to V7 described above will be omitted.

The vehicle V8 according to the eighth embodiment is mainly different from the vehicles V1 to V7 in terms of the configuration of sunroofs 716 and seat bodies 720.

As shown in FIG. 19, the sunroofs 716 are mounted by shafts, which extend in the front to rear direction, to be rotationally movable with respect to an upper surface of a vehicle body-outer wall part 710. Specifically, fixed end portions 716b that are end portions of the sunroofs 716 in the right to left direction are mounted on the vehicle body-outer wall part 710 to be rotationally movable.

The sunroofs 716 are provided to be switchable between a closed position P1 at which an interior space of a vehicle body 701 is closed and an open position P2 at which the interior space of the vehicle body 701 is opened as movable end portions 716a are moved upward.

As shown in FIG. 10, lifting devices 730 move a right front seat body 720A and a left front seat body 720C between a reference position P3 and an upper position P4 moved upward from the reference position P3 as a lifting operation part 732 is operated by an occupant.

A front rail device 750 of the vehicle body 701 includes two lower rails 750a that extend in the right to left direction, two first upper rails 750b that are provided on the right front seat body 720A and are supported to be slidable along the lower rails 750a, and two second upper rails 750c that are provided on the left front seat body 720C and are supported to be slidable along the lower rails 750a.

Further, the seat body 720 includes massage devices 770 in a seat back 721 and a seat cushion 722.

The massage device 770 is to operate to correct the posture of an occupant seated in the seat. The massage device 770 is, for example, an air bag and bulges to correct the posture of a seated occupant as air is injected into the air bag.

Meanwhile, a mechanism for pressing the seated occupant is not limited to an object that bulges as with an air bag or a bag body, and may be a mechanism for pushing members having a fixed shape, such as roller-shaped bodies, ball-shaped bodies, or block-shaped bodies, against a seated occupant to press the seated occupant.

When the seat bodies 720 are moved to an exterior space of the vehicle body 701 by the lifting devices 730 and the rail devices 750 as described above, the orientations and the tilt angles of the seats can be changed by rotating devices 740 and reclining devices 760. Then, the right front seat body 720A is disposed at a position at which the massage devices 770 press the shoulder and waist of a seated occupant, and the left front seat body 720C is disposed at a position at which the massage device 770 presses legs of the seated occupant. Accordingly, since the occupant can get a massage in the exterior space of the vehicle body 701, the occupant can further feel a sense of release.

In addition, the left front seat body 720C is rotated by the rotating device 740 such that the back side of the seat back 721 faces the right front seat body 720A. Accordingly, the occupant seated in the right front seat body 720A can use the seat back 721 and a headrest 723 of the left front seat body 720C as a footrest.

### Ninth Embodiment

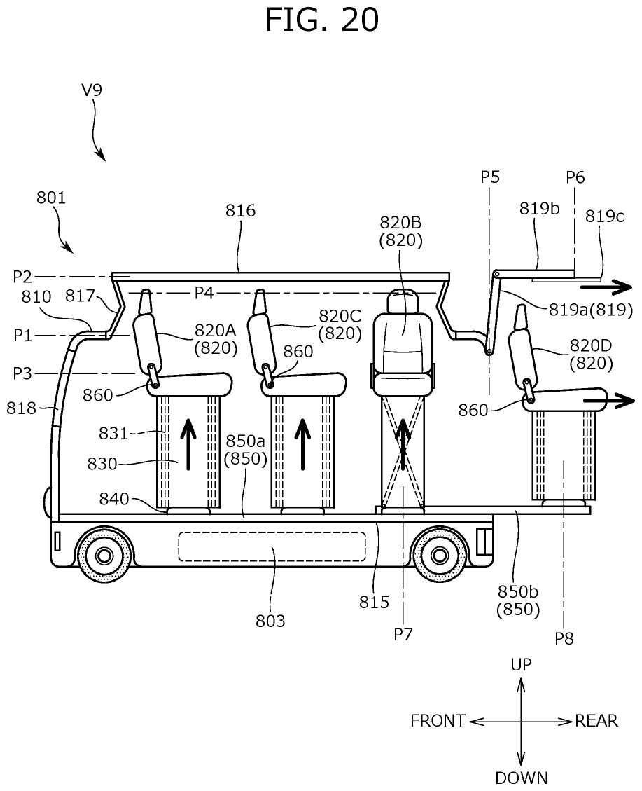

Next, a vehicle V9 according to a ninth embodiment will be described with reference to FIGS. 20 to 24.

Meanwhile, the repeated description of the same contents as the vehicles V1 to V8 described above will be omitted.

A tailgate 819 is mounted to be openable and closable with respect to a vehicle body-outer wall part 810, and includes a rear glass part 819a, a gate part 819b that is mounted to be rotationally movable with respect to the rear glass part 819a, and an awning part 819c that is slidably mounted on the gate part 819b.

The tailgate 819 is provided to be switchable between a closed position P5 at which an interior space of a vehicle body 801 is closed and an open position P6 at which the interior space of the vehicle body 801 is opened.

The gate part 819b is in a horizontal position when the rear glass part 819a rotationally moves rearward, and can be used as, for example, a rain cover and a sunshade for a left rear seat body 820D.

The awning part 819c slides rearward to extend from the gate part 819b when the gate part 819b is in the horizontal position. The awning part 819c can be used as a rain cover and a sunshade when, for example, the left rear seat body 820D has been moved to a rear position P8.

The vehicle V9 includes a plurality of seat bodies 820. Specifically, the vehicle V9 includes a right front seat body 820A, a right rear seat body 820B disposed behind the right front seat body 820A, a left front seat body 820C disposed on the left side of the right front seat body 820A, and a left rear seat body 820D disposed behind the left front seat body 820C, on a vehicle body floor 815.

As shown in FIG. 20, lifting devices 830 move the seat bodies 820 between a reference position P3 and an upper position P4 moved upward from the reference position P3 as being operated by occupants.

For example, when a sunroof 816 is in an open position P2 and each seat body 820 is in the upper position P4 as shown in FIG. 20, an upper end portion (an upper end portion of a headrest 823) of the seat body 820 is disposed above the sunroof 816 having been in a closed position P1.

A rail device 850 includes two lower rails 850a that extend in the front to rear direction, two upper rails 850b that are supported to be slidable along the lower rails 850a, and two sub-rails 850c that are slidably supported by the upper rails 850b.

Sub-rails 850c of a left rail device 850 of the vehicle body 801 allow the right rear seat body 820B and the left rear seat body 820D to move in the front to rear direction. Likewise, the front rail device 850 may also be adapted to include sub-rails 850c.

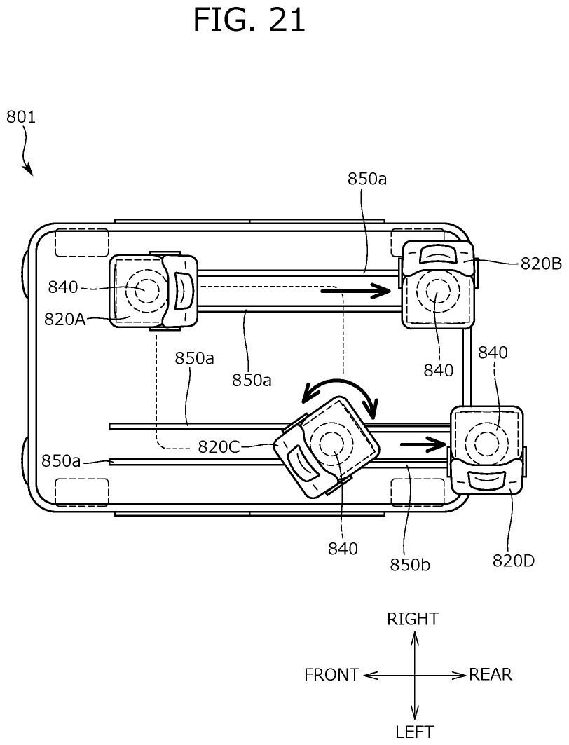

Meanwhile, as shown in FIG. 21, a battery 803 for driving a vehicle is disposed on the inner side than the right lower rail 850a of the rail device 850 for the right front seat body 820A and the right rear seat body 820B, which are provided on the right side in the vehicle body 801, in the right to left direction. Further, the battery 803 is disposed on the inner side than the left lower rail 850a of the rail device 850 for the left front seat body 820C and the left rear seat body 820D, which are provided on the left side in the vehicle body 801, in the right to left direction.

As shown in FIG. 20, the rail device 850 moves the seat body 820 between a reference position P7 and a rear position P8 moved to the rear side (outside) of the reference position P7 as a rail operation lever is operated by an occupant.

For example, when the tailgate 819 is in the open position P6 and the left rear seat body 820D is in the rear position P8 as shown in FIG. 20, the left rear seat body 820D is disposed behind the tailgate 819 having been in the closed position P5.

Since a passenger compartment can be expanded and the seat body 820 can be moved to an exterior space of the vehicle body 801 by the lifting device 830 and the rail device 850 as described above, the moving distance of the seat body 820 in the front to rear direction can be significantly increased. Particularly, since an occupant can operate by oneself to move the seat body 820 to a desired position, it is possible to arrange the seat bodies 820 in various ways.

Further, when the seat body 820 is moved to the exterior space, it is possible to change the orientation and the tilt angle of the seat by the rotating device 840 and the reclining device 860 and to arrange the seat body 620 at a desired position.

Modification examples of the vehicle V8 will be described below.

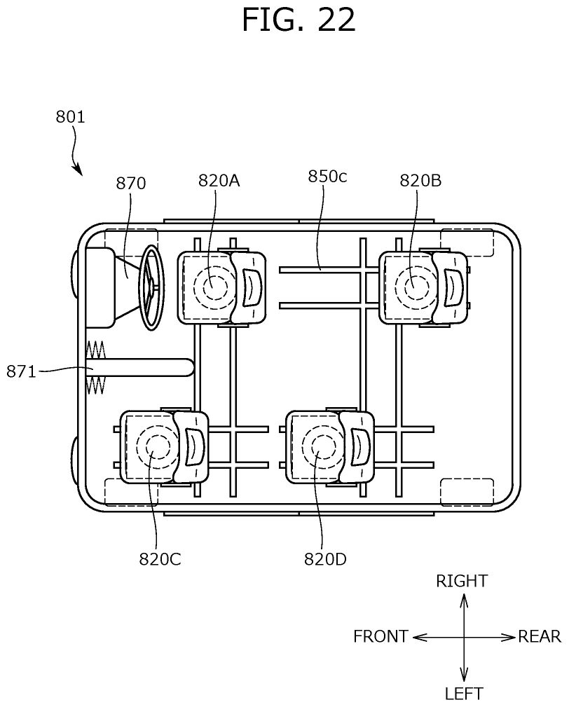

A first modification example shown in FIG. 22 is mainly different from FIG. 21 in terms of the configuration of rail devices 850 and a partition 871.

Specifically, lower rails 850a of a rail device 850 are formed in a shape in which portions extending in the front to rear direction and portions extending in the right to left direction cross each other. Accordingly, upper rails 850b mounted on the lower rails 850a are slidable with respect to the lower rails 850a not only in the front to rear direction but also in the right to left direction, so that the seat bodies 820 can be arranged at various positions.

Meanwhile, portions of the lower rails 850a extending in the front to rear direction are not provided on a driver seat side where a steering wheel 870 is provided. That is, the left front seat body 820C serving as a passenger seat is disposed in front of the right front seat body 820A serving as a driver seat when being moved forward along the rail device 850.

Further, the vehicle body 801 includes a partition 871 that divides the passenger compartment into a driver seat side (right area) and a passenger seat side (left area). The partition 871 is to partition off private spaces for occupants, is mounted on the vehicle body-outer wall part 810 or the vehicle body floor 815, and is provided to be switchable between a use position and a storage position. The partition 871 is, for example, a bellows-shaped curtain, extends up to a position at which the partition 871 divides the driver seat from the passenger seat at the use position (a solid line in FIG. 22), and is folded and stored at a position at which the partition 871 does not divide the driver seat from the passenger seat at the storage position (a dotted line in FIG. 22). Meanwhile, the partition 871 may be a sliding panel.

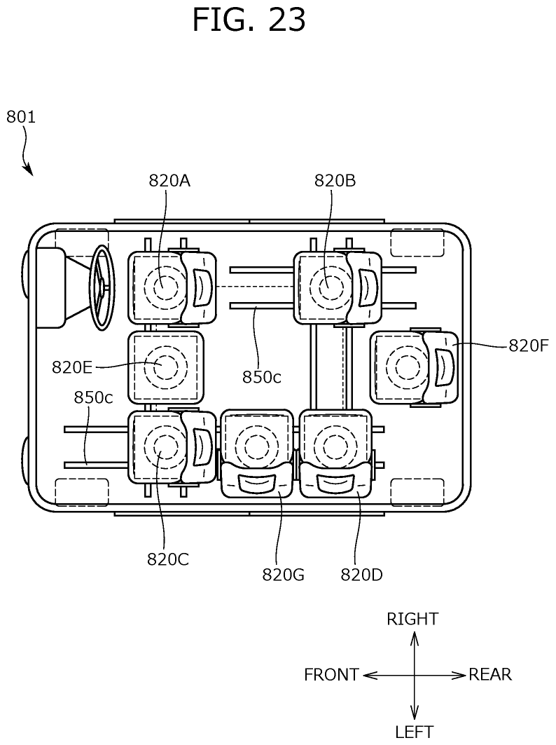

A second modification example shown in FIG. 23 mainly different from FIG. 21 in terms of the configuration of seat bodies 820 and rail devices 850.

Specifically, the vehicle V8 further includes a first auxiliary seat 820E that is disposed between the right front seat body 820A and the left front seat body 820C in the right to left direction, a second auxiliary seat 820F that is disposed between the right rear seat body 820B and the left rear seat body 820D in the right to left direction, and a third auxiliary seat 820G that is disposed between the left front seat body 820C and the left rear seat body 820D in the front to rear direction.

The first auxiliary seat 820E is moved between the right front seat body 820A and the left front seat body 820C in the right to left direction by the rail device 850. Meanwhile, since not including a seat back 821, the first auxiliary seat 820E is a cushion seat 822 in which an occupant can be seated not only from the front side but also the rear side.

The first auxiliary seat 820E is provided with the lifting device 830 and the rotating device 840.

The second auxiliary seat 820F is disposed on the vehicle body floor 815 at a position at which the rail device 850 is not provided.

The third auxiliary seat 820G is moved between the left front seat body 820C and the left rear seat body 820D in the front to rear direction by the rail device 850.

Each of the second auxiliary seat 820F and the third auxiliary seat 820G is provided with the lifting device 830, the rotating device 840, and the reclining device 860.

When the plurality of seat bodies 820 are provided as described above, the seat bodies 820 can be arranged in various ways.

Further, it is possible to change the orientations and the tilt angles of the plurality of seats by the lifting devices 830, the rotating devices 840, and the reclining devices 860 and to arrange the seat bodies 820 at still more desired positions.

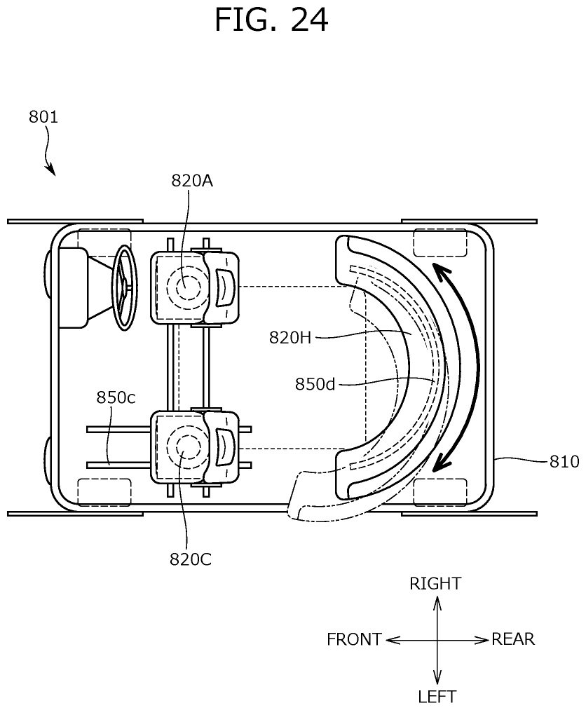

A third modification example shown in FIG. 24 is mainly different from FIG. 21 in terms of the configuration of seat bodies 820 and rail devices 850.

Specifically, the vehicle V8 includes a U-shaped seat 820H instead of the right rear seat body 820B and the left rear seat body 820D.

The U-shaped seat 820H is a bench seat having a substantially U shape in a top view, and is provided behind the right front seat body 820A and the left front seat body 820C.

The U-shaped seat 820H is moved between a reference position at which the entire U-shaped seat 820H is disposed in the interior space of the vehicle body 801 and a side position at which a part of the U-shaped seat 820H is disposed in the exterior space of the vehicle body 801 by a U-shaped rail 850d.

### Tenth Embodiment

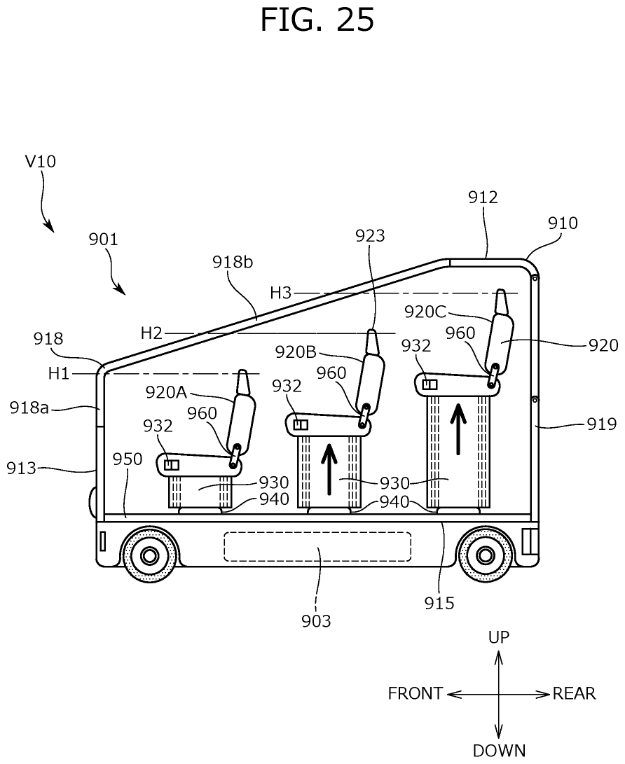

Next, a vehicle V10 according to a tenth embodiment will be described with reference to FIG. 25.

Meanwhile, the repeated description of the same contents as the vehicles V1 to V9 described above will be omitted.

The vehicle V10 according to the tenth embodiment is mainly different from the vehicles V1 to V9 in terms of the configuration of a front part 918 and seat bodies 920.

As shown in FIG. 25, the front part 918 is made of, for example, a translucent material, such as glass. The front part 918 includes a front portion 918a that extends in the up to down direction, and a rear portion 918b that extends to be inclined with respect to the front to rear direction.

The front portion 918a is a windshield extending in the up to down direction, and is mounted on a vehicle body-front wall portion 913 of a vehicle body 901.

The front portion 918a is provided at a position at which a field of view in front of occupants seated on the seat bodies 920 is secured even when the seat bodies 920 are moved in the up to down direction or the right to left direction.

The rear portion 918b is a sunroof extending in the front to rear direction, is connected to an upper end portion of the front portion 918a, and is mounted on a vehicle body-upper wall portion 912. The rear portion 918b is disposed to be inclined such that a rear end portion connected to the vehicle body-upper wall portion 912 is higher than a front end portion connected to the front portion 918a.

The rear portion 918b is disposed at a position corresponding to the seat bodies 920 disposed on a vehicle body floor 915 (above the seat bodies 920).

The vehicle V10 includes a battery 903 and a plurality of seat bodies 920. Specifically, the vehicle V10 includes a front seat body 920A, a middle seat body 920B disposed behind the front seat body 920A, and a rear seat body 920C disposed behind the middle seat body 920B, on the vehicle body floor 915.

As shown in FIG. 25, lifting devices 930 move the seat bodies 920 between a reference position and upper positions moved upward from the reference position as lifting operation parts 932 are operated by occupants.

When the middle seat body 920B and the rear seat body 920C are in the upper positions, upper end portions of the seat bodies 920 (upper end portions of headrests 923) are arranged above the upper end portion of the front portion 918a.

When the front seat body 920A, the middle seat body 920B, and the rear seat body 920C are in upper positions, respectively, the front seat body 920A, the middle seat body 920B, and the rear seat body 920C are arranged at height positions different from each seat body 920 as shown in FIG. 25.

In such a manner, a sight line-height-position H2 of the middle seat body 920B is higher than a sight line-height-position H1 of the front seat body 920A, and a sight line-height-position H3 of the rear seat body 920C is higher than the sight line-height-position H2 of the middle seat body 920B. For this reason, the sight line of the rear occupant is not blocked and a sense of release can be given to the rear occupant.

Since the seat bodies 920 can be moved by the lifting devices 930 and a rail device 950 as described above, it is possible to arrange the seat bodies 920 in various ways.

Further, it is possible to change the orientations and the tilt angles of the seats by rotating devices 940 and reclining devices 960 and to arrange the seat bodies 920 at desired positions.

### Eleventh Embodiment

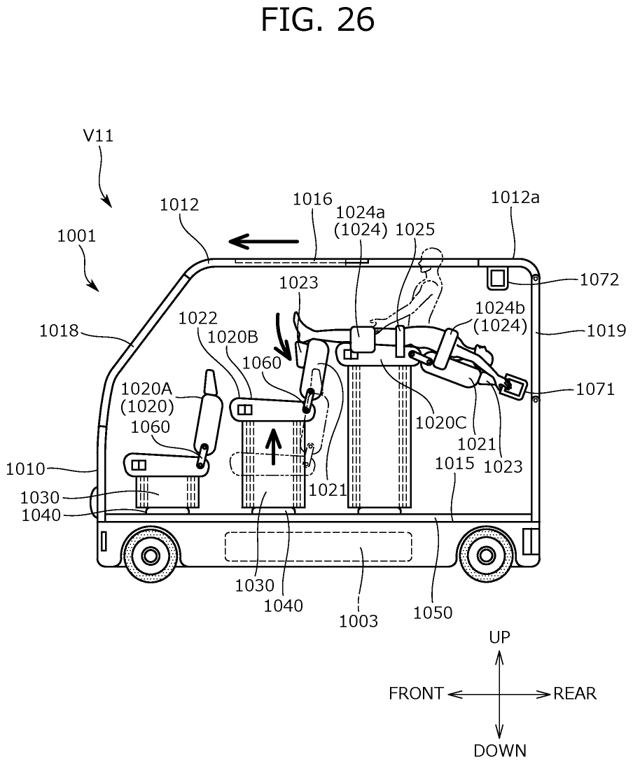

Next, a vehicle V11 according to an eleventh embodiment will be described with reference to FIG. 26.

Meanwhile, the repeated description of the same contents as the vehicles V1 to V10 described above will be omitted.

The vehicle V11 according to the eleventh embodiment is mainly different from the vehicles V1 to V10 in terms of the configuration of exercise devices 1070.

As shown in FIG. 26, a vehicle body-outer wall part 1010 includes a sunroof 1016 provided on a vehicle body-upper wall portion 1012.

The sunroof 1016 is mounted to be slidable with respect to the vehicle body-upper wall portion 1012 in the front to rear direction. That is, the sunroof 1016 is provided to be switchable between a closed position at which an interior space of a vehicle body 1001 is closed and an open position at which the interior space of the vehicle body 1001 is opened.

The vehicle V11 includes a battery 1003 and a plurality of seat bodies 1020. Specifically, the vehicle V11 includes a front seat body 1020A, a middle seat body 1020B disposed behind the front seat body 1020A, and a rear seat body 1020C disposed behind the middle seat body 1020B, on a vehicle body floor 1015.

The seat body 1020 includes support parts 1024 provided outside each of a seat back 1021 and a seat cushion 1022 in the seat width direction.

The support parts 1024 are mounted such that the protruding length of the support part 1024 from each of the seat back 1021 and the seat cushion 1022 can be adjusted. Meanwhile, the support parts 1024 may be fixed to the seat back 1021 and the seat cushion 1022.

The support parts 1024 may be mounted to be capable of protruding and retracting from the seat back 1021 and the seat cushion 1022. In this case, the support parts 1024 may be adapted to be capable of automatically protruding and retracting depending on a height position of the seat body 1020. Specifically, when the height of the seat is increased to a predetermined value (for example, 50 cm or more), the support parts 1024 may automatically protrude to support an occupant in the right to left direction.

The seat back 1021 includes first support parts 1024a mounted on both side portions thereof in the seat width direction. The first support parts 1024a are to support an upper half of the body of an occupant in the right to left direction, and are members for preventing the occupant from falling out of the seat body 1020.

Meanwhile, the first support parts 1024a may be to support arms of an occupant from below like armrests.

The seat cushion 1022 includes second support parts 1024b mounted on both side portions thereof in the seat width direction. The second support parts 1024b are to support a lower half of the body of an occupant in the right to left direction, and are members for preventing the occupant from falling out of the seat body 1020.

Further, the seat cushion 1022 includes a seat band 1025 that extends in the seat width direction and is detachably attached to an occupant. The seat band 1025 is a member that holds an occupant when the occupant performs abdominal exercises to raise the upper half of the body.

The headrest 1023 includes an exercise device 1070 (seat handle 1071) that is mounted on an upper end portion of the seat back 1021. The seat handle 1071 is a member that is gripped by an occupant when the occupant performs flexibility exercises to bend the upper half of the body backward.

The vehicle body-upper wall portion 1012 includes an exercise device 1070 (roof handle 1072) that is mounted on a rear end portion of the vehicle body 1001. The roof handle 1072 is a member that is gripped by an occupant when the occupant performs pull-up exercises to pull up the upper half of the body. Meanwhile, an occupant may exercise while placing one's feet on the roof handle 1072.

When the sunroof 1016 is in an open position and the rear seat body 1020C is in an upper position, an upper end portion (headrest 1023) of the rear seat body 1020C is disposed above the sunroof 1016 having been in the closed position.

FIG. 26 shows a state where the seat back 1021 is tilted rearward by a reclining device 1060 such that the headrest 1023 is disposed below the seat cushion 1022 when the rear seat body 1020C is in the upper position.

In this state, for example, an occupant can grip the seat handle 1071 and perform flexibility exercises or attach the seat band 1025 and perform abdominal exercises. In this case, the headrest 1023 of the middle seat body 1020B may be tilted forward to be used as a footrest that supports occupant's feet on the back side of the headrest 1023.

Further, the seat back 1021 may be tilted rearward by the reclining device 1060 such that the seat back 1021 is horizontal with respect to the seat cushion 1022 when the rear seat body 1020C is in the upper position. Accordingly, an occupant can take a relaxed posture on the seat body 1020 and rest one's body.

Only the rear seat body 1020C is provided with the support parts 1024, the seat band 1025, and the seat handle 1071 in this embodiment, but the present invention is not limited thereto. All the seat bodies 1020 may be provided with the support parts 1024, the seat bands 1025, and the seat handles 1071. Further, exercises to be performed by an occupant are not limited to the exercises described above, and an occupant can appropriately use each exercise device 1070 depending on the exercise to be performed.

Since the seat bodies 1020 can be moved by the lifting devices 1030 and the rail device 1050 as described above, it is possible to arrange the seat bodies 1020 in various ways.

Further, it is possible to change the orientations and the tilt angles of the seats by rotating devices 1040 and the reclining devices 1060 and to arrange the seat bodies 1020 at desired positions.

Particularly, an occupant can move the rear seat body 1020C to an exterior space of the vehicle body 1001 to make the position of a sight line higher than the vehicle body-upper wall portion 1012. Therefore, a sense of release can be given to the occupant.

The vehicle V11 according to this embodiment can be used as a gym vehicle in which an occupant can exercise as described above. Accordingly, it is possible to arrange the seat bodies 1020 in a way suitable for exercises while improving a sense of release.

### Twelfth Embodiment

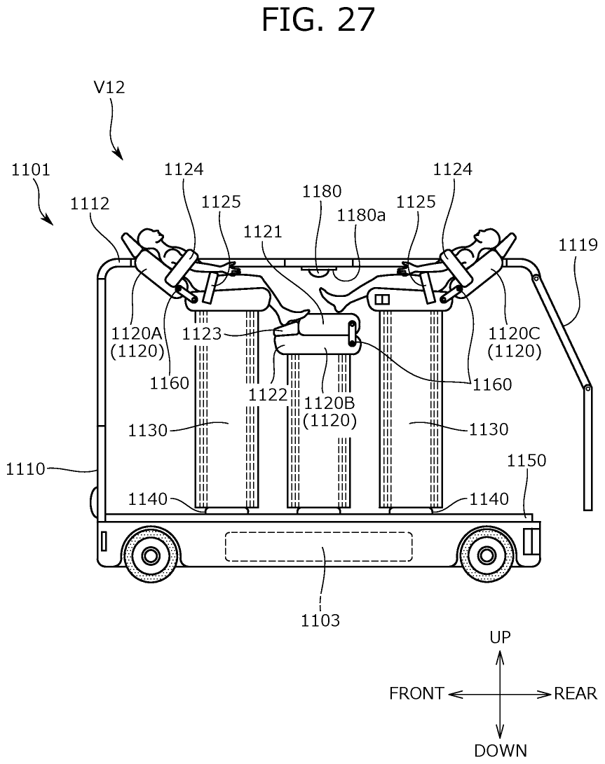

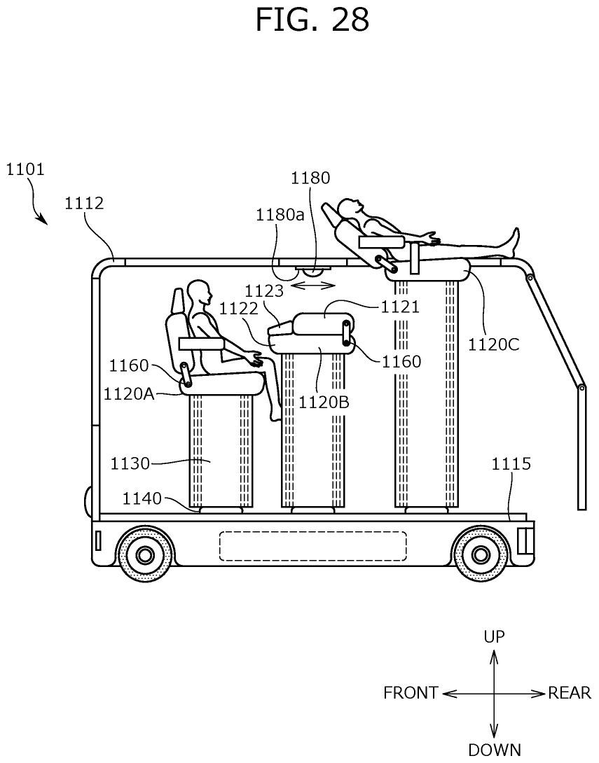

Next, a vehicle V12 according to a twelfth embodiment will be described with reference to FIGS. 27 and 28.

Meanwhile, the repeated description of the same contents as the vehicles V1 to V11 described above will be omitted.

A tailgate 1119 is provided to be switchable between a closed position at which an interior space of the vehicle body 1101 is closed and an open position at which the interior space of the vehicle body 1101 is opened.

The vehicle V12 includes a battery 1103 and a plurality of seat bodies 1120. Specifically, the vehicle V12 includes a front seat body 1120A, a middle seat body 1120B disposed behind the front seat body 1120A, and a rear seat body 1120C disposed behind the middle seat body 1120B, on a vehicle body floor 1115.

Each seat body 1120 includes support parts 1124 provided outside a seat cushion 1122 in the seat width direction.

The support parts 1124 are, for example, armrests supporting occupant's arms and are mounted on the seat cushion 1122 to be rotationally movable. The support parts 1124 are mounted to be rotationally movable between a storage position and a support position at which the support parts 1124 can support occupant's arms.

The support parts 1124 may be adapted to automatically move rotationally depending on a height position of the seat body 1120. Specifically, when the height of the seat is increased to a predetermined value (for example, 50 cm or more), the support parts 1124 may be adapted to automatically move rotationally to the support position from the storage position.

Further, the seat cushion 1122 includes a seat band 1125 that extends in the seat width direction and is detachably attached to an occupant. The seat band 1125 is a member that prevents the occupant from falling out of the seat body 1120.

When a sunroof (not shown) of a vehicle body-upper wall portion 1112 is opened and the front seat body 1120A and the rear seat body 1120C are in upper positions, upper end portions (headrests 1123) of the front seat body 1120A and the rear seat body 1120C are arranged above the vehicle body-upper wall portion 1112 as shown in FIG. 27.

In this state, an occupant may tilt a seat back 1121 of the middle seat body 1120B forward to use the back side of the seat back 1121 (or the headrest 1123) as a footrest that supports occupant's feet.

Further, the occupant may use an upper surface of the vehicle body-upper wall portion 1112 as a table in this state.

Furthermore, when the sunroof (not shown) is in the open position and the front seat body 1120A and the rear seat body 1120C are in the upper positions, the seat back 1121 of the middle seat body 1120B may be tilted forward such that the middle seat body 1120B is used as a desk for an occupant seated in the front seat body 1120A as shown in FIG. 28.

In this state, the upper surface side of the vehicle body-upper wall portion 1112 may be used as a footrest that supports the feet of an occupant seated in the rear seat body 1120C.

Further, the vehicle body 1101 includes an illumination device 1180 that is used to illuminate the interior space. The illumination device 1180 is mounted on an illumination mounting portion 1180a of the vehicle body-upper wall portion 1112 in the interior space of the vehicle body 1101. The illumination device 1180 is mounted to be horizontally movable with respect to illumination mounting portion 1180a.

The illumination device 1180 is, for example, an LED and is to illuminate an upper surface of the middle seat body 1120B that is transformed into a desk shape as shown in FIG. 28.

Since the seat bodies 1120 can be moved by lifting devices 1130 and a rail device 1150 as described above, it is possible to arrange the seat bodies 1120 in various ways.

Further, it is possible to change the orientations and the tilt angles of the seats by rotating devices 1140 and reclining devices 1160 and to arrange the seat bodies 1120 at desired positions.

Furthermore, since the seat body 1120 can be illuminated by the illumination device 1180, the seat body 1120 can be disposed at a more desired position.

### Thirteenth Embodiment

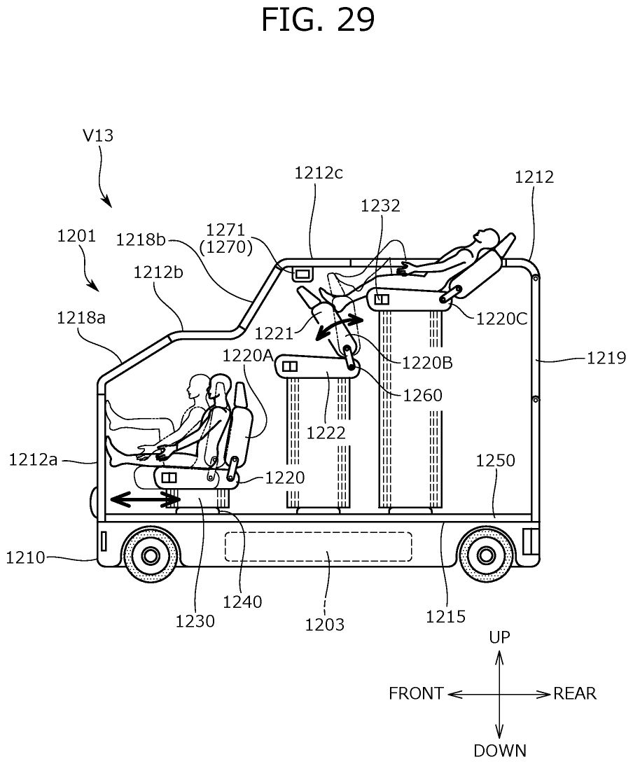

Next, a vehicle V13 according to a thirteenth embodiment will be described with reference to FIG. 29.

Meanwhile, the repeated description of the same contents as the vehicles V1 to V12 described above will be omitted.

As shown in FIG. 29, a front part 1218 includes a front portion 1218a and a rear portion 1218b.

A vehicle body-upper wall portion 1212 mainly includes an upper wall-front portion 1212a and an upper wall-rear portion 1212b.

The front portion 1218a, the upper wall-front portion 1212a, the rear portion 1218b, and the upper wall-rear portion 1212b connected in this order, so that a ceiling surface of a vehicle body 1201 is formed. Meanwhile, a sunroof (not shown) is mounted at an opening portion of the upper wall-rear portion 1212b to be openable and closable.

The front portion 1218a is a windshield that extends to be inclined with respect to the front to rear direction, and a front end portion of the front portion 1218a is mounted on the vehicle body-front wall portion 1213 of the vehicle body 1201 and a rear end portion of the front portion 1218a is mounted on the upper wall-front portion 1212a.

The rear portion 1218b is a windshield that extends to be inclined with respect to the front to rear direction, and a front end portion of the rear portion 1218b is mounted on the upper wall-front portion 1212a and a rear end portion of the rear portion 1218b is mounted on the upper wall-rear portion 1212b.

The vehicle V13 includes a battery 1203 and a plurality of seat bodies 1220. Specifically, the vehicle V13 includes a front seat body 1220A, a middle seat body 1220B disposed behind the front seat body 1220A, and a rear seat body 1220C disposed behind the middle seat body 1220B, on a vehicle body floor 1215.

The front seat body 1220A includes an elastic spring (not shown) that generates a biasing force toward the front. The front seat body 1220A is moved with respect to the vehicle body floor 1215 in a direction in which the front seat body 1220A approaches the vehicle body-front wall portion 1213 (forward) by the biasing force of the elastic spring. Accordingly, an occupant is seated in the front seat body 1220A, presses the vehicle body-front wall portion 1213 with feet against the biasing force, and moves the front seat body 1220A with respect to the vehicle body floor 1215 in a direction in which the front seat body 1220A is away from the vehicle body-front wall portion 1213 (rearward), so that the occupant can perform foot muscle exercises.

The middle seat body 1220B includes an elastic spring (not shown) that generates a biasing force toward the rear. A seat back 1221 is rotationally moved with respect to the seat cushion 1222 in a direction in which the seat back 1221 approaches the rear seat body 1220C (rearward) by the biasing force of the elastic spring. Accordingly, an occupant is seated in the rear seat body 1220C, presses the seat back 1221 of the middle seat body 1220B with feet against the biasing force, and moves the middle seat body 1220B in a direction in which the middle seat body 1220B is away from the rear seat body 1220C (forward), so that the occupant can perform foot muscle exercises.

An exercise device 1270 (roof handle 1271) is mounted on a lower surface of a front portion of the upper wall-rear portion 1212b. The roof handle 1271 is a member that is gripped by an occupant when the occupant seated in the middle seat body 1220B performs pull-up exercises to pull up the upper half of the body.

When the sunroof (not shown) is in an open position and the rear seat body 1220C is in an upper position, an upper end portion of the rear seat body 1220C is disposed above the sunroof having been in a closed position (that is, the upper wall-rear portion 1212b) as shown in FIG. 29.

When the front seat body 1220A, the middle seat body 1220B, and the rear seat body 1220C are in upper positions, respectively, the height of a sight line for the front seat body 1220A overlaps the front portion 1218a. The height of a sight line for the middle seat body 1220B overlaps the rear portion 1218b.

That is, the front portion 1218a and the rear portion 1218b are provided at positions at which a field of view in front of occupants seated on the seat bodies 1220 is secured even when the seat bodies 1220 are moved in the up to down direction.

Since the seat bodies 1220 can be moved by lifting devices 1230 and a rail device 1250 as described above, it is possible to arrange the seat bodies 1220 in various ways.

Further, it is possible to change the orientations and the tilt angles of the seats by rotating devices 1240 and reclining devices 1260 and to arrange the seat bodies 1220 at desired positions.

Furthermore, an occupant can move the rear seat body 1220C to an exterior space of the vehicle body 1201 to make the position of a sight line higher than the vehicle body-upper wall portion 1212. Therefore, a sense of release can be given to the occupant.

Since the vehicle V13 according to this embodiment can be used as a gym vehicle in which an occupant can exercise, it is possible to arrange the seat bodies 1220 in a way suitable for exercises while improving a sense of release.

### Fourteenth Embodiment

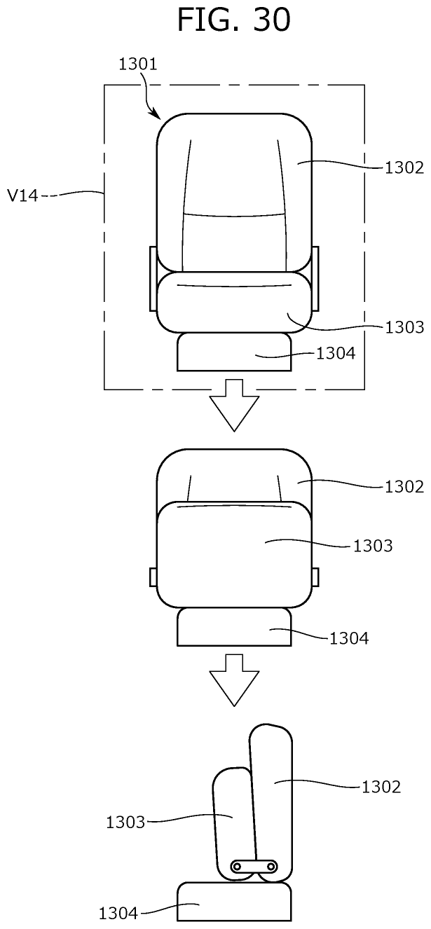

Next, a vehicle V14 according to a fourteenth embodiment will be described with reference to FIG. 30.

Meanwhile, the repeated description of the same contents as the vehicles V1 to V13 described above will be omitted.

The vehicle V14 according to the fourteenth embodiment is mainly different from the vehicles V1 to V13 in terms of the configuration of a vehicle seat 1301. The vehicle seat 1301 is applied to, for example, a passenger seat for an autonomous car. Meanwhile, the vehicle seat 1301 may be applied to seats other than the passenger seat.

The vehicle seat 1301 includes a seat body that includes a seat back 1302 and a seat cushion 1303, a rotating device 1304 that allows the seat body to be mounted and to rotate with respect to a vehicle body floor about an axis parallel to the up to down direction, and a cushion-rotational movement device 1305 that connects the seat cushion 1303 to the seat back 1302 to allow the seat cushion 1303 to move rotationally.

When an occupant seated in a driver seat is to move to a rear seat, the occupant causes the seat cushion 1303 to rotationally move (tip up) with respect to the seat back 1302 by the cushion-rotational movement device 1305 to make a tip-up state where the seat back 1302 and the seat cushion 1303 are in contact with each other. Then, in this tip-up state, the occupant rotates the seat body with respect to the vehicle body floor in a horizontal direction by an angle of 90 degrees with the rotating device 1304 to make a walk-through state where the occupant can move to the rear seat.

In this case, the occupant may rotate the seat body in the tip-up state or may make the tip-up state after rotating the seat body. Alternatively, the occupant may tip up the seat cushion and rotate the seat body at the same time.

When the disposition of the seat body is changed by the rotating device 1304 and the cushion-rotational movement device 1305 as described above, it is possible to meet a need in which an occupant wants to relax in the rear seat during autonomous driving. Particularly, an occupant seated in the driver seat can easily move to the rear seat even in the case of a compact car having a small interior space of a vehicle body.

A publicly known technique can be used for drive mechanisms of the rotating device 1304 and the cushion-rotational movement device 1305, and the rotating device 1304 and the cushion-rotational movement device 1305 may be manually driven or driven by motors.

The rotating device 1304 may be embedded below the vehicle body floor. In this case, a pillar member connecting the rotating device 1304 and the seat cushion 1303 may be provided.

A hook for hanging baggage, a wireless charger for charging an electronic equipment, a USB port for communication with the vehicle V14, or the like may be provided on back surfaces or side surfaces of the seat back 1302 and the seat cushion 1303 of the vehicle seat 1301.

A folding table and the like may be further provided on the back surface of the seat cushion 1303.

Further, a passenger seat may be adapted to be capable of being manually driven in a walk-through state. In this case, the rotation angle of the seat body may be adapted to be fixed at an angle (for example, 45 degrees) other than 90 degrees. Accordingly, a field of view on the side can be secured even in the walk-through state.

Furthermore, a seat belt reminder detecting that an occupant is seated in a passenger seat may be provided. At this time, in a case where the seat belt reminder detects that an occupant is seated, it is preferable to perform control to prevent the rotation of the seat body.

In addition, even in a case where the seat belt reminder detects that a child seat, baggage, or the like is placed on the seat body, control to prohibit the rotation of the seat body may be performed.

### Fifteenth Embodiment

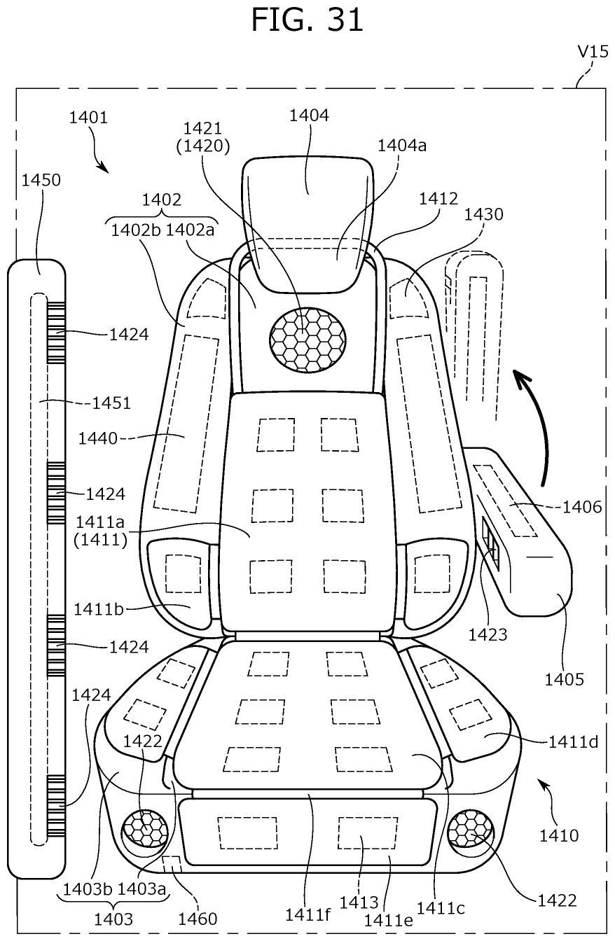

Next, a vehicle V15 according to a fifteenth embodiment will be described with reference to FIG. 31.

Meanwhile, the repeated description of the same contents as the vehicles V1 to V14 described above will be omitted.

The vehicle V15 according to the fifteenth embodiment is mainly different from the vehicles V1 to V14 in terms of the configuration of a vehicle seat 1401 and a door panel 1450.

The vehicle seat 1401 includes a seat back 1402, a seat cushion 1403, a headrest 1404, an armrest 1405 that is mounted to be rotationally movable with respect to the seat back 1402, an operation device 1410 that is mounted on a seating surface for an occupant, and a control device 1460.

The armrest 1405 is mounted to be rotationally movable between a storage position at which the armrest 1405 is stored on the side surface of the seat back 1402 and a support position at which the armrest 1405 can support an occupant's arm.

As shown in FIG. 31, a blower device 1420, heating devices 1430, and airbag modules 1440 are arranged on the seat back 1402.

The blower device 1420 is adapted to blow air out of a first blow-out port 1421 toward a seated occupant through a duct from a blower body. The first blow-out port 1421 is provided on the surface of a middle support portion 1402a of the seat back 1402 facing a seated occupant.

The heating devices 1430 are heaters for heating a seated occupant and are provided in side support portions 1402b of the seat back 1402.

The airbag modules 1440 are provided in the side support portions 1402b of the seat back 1402 below the heating devices 1430.

As shown in FIG. 31, second blow-out ports 1422 of the blower device 1420 are arranged on the seat cushion 1403.

The second blow-out ports 1422 are provided on front surfaces of a middle support portion 1403a and side support portions 1403b of the seat cushion 1403.

As shown in FIG. 31, a third blow-out port 1423 of the blower device 1420 is disposed on the armrest 1405.

The third blow-out port 1423 is provided on the surface of the armrest 1405 facing a seated occupant at a tip portion of the armrest 1405 in a longitudinal direction. Meanwhile, an armrest ventilation channel 1406 that allows air from the blower body to pass therethrough is formed in the armrest 1405.

Since the armrest 1405 is mounted to be rotationally movable with respect to the seat back 1402, the position of the third blow-out port 1423 can be adjusted. Accordingly, since the position of the third blow-out port 1423 can be adjusted, an occupant can apply air having passed through the armrest ventilation channel 1406 to a desired position.

Meanwhile, the tip portion of the armrest 1405 in the longitudinal direction may be adapted to be rotatable about an axis parallel to the longitudinal direction of the armrest 1405. Accordingly, since an angle of the third blow-out port 1423 provided at the tip portion of the armrest 1405 in the longitudinal direction can be adjusted, the third blow-out port 1423 can be directed to an occupant and air can be efficiently sent to the occupant.

Further, the armrest 1405 is provided at a position at which the third blow-out port 1423 does not overlap the seat back 1402 in the right to left direction when being in the storage position. That is, since the armrest 1405 is disposed at a position at which the third blow-out port 1423 is not closed by the seat back 1402 when being in the storage position, air can be efficiently sent to the neck or chest of an occupant.

Meanwhile, the present invention is not limited to a configuration in which the armrest 1405 is provided on only one side of the seat back 1402, and it is preferable that armrests 1405 are provided on both right and left sides of the seat back 1402 in the seat width direction. Accordingly, air can be more efficiently sent to an occupant.

The operation device 1410 includes a mat part 1411 that is formed of a cushion member, a mat holding part 1412 that allows the mat part 1411 to be detachably mounted on the seat body, and sensor parts 1413 that are provided in the mat part 1411.

As shown in FIG. 31, the mat part 1411 includes a first mat portion 1411a that is disposed at a position corresponding to the middle support portion 1402a of the seat back 1402, second mat portions 1411b that are arranged at positions corresponding to the side support portions 1402b of the seat back 1402, a third mat portion 1411c that is disposed at a position corresponding to an upper surface of the middle support portion 1403a of the seat cushion 1403, fourth mat portions 1411d that are arranged at positions corresponding to the side support portions 1403b of the seat cushion 1403, and a fifth mat portion 1411e that is disposed at a position corresponding to a front surface of the middle support portion 1403a of the seat cushion 1403.

The thickness of the cushion member at a mat bending portion 1411f that is a connection portion of each of the mat portions (1411a to 1411e) is smaller than the thickness of the cushion member at each of the mat portions.

Meanwhile, since the mat bending portions 1411f are arranged at connection portions of the seat body (for example, connection portions of the middle support portion 1402a and the side support portions 1402b), the positions of the mat bending portions 1411f in the seat width direction are regulated. For this reason, the shift of the position of the operation device 1410 from the seat body can be suppressed.

As shown in FIG. 31, the mat holding part 1412 has a string shape and is mounted on an upper portion of the first mat portion 1411a. The mat holding part 1412 is hooked to headrest pillars of the headrest 1404, so that the mat part 1411 is detachably mounted on the seat body.

In this case, the mat part 1411 is disposed at a position that does not overlap the first blow-out port 1421 and the second blow-out ports 1422 of the blower device 1420, the heating devices 1430, and the airbag modules 1440 in the front to rear direction. Accordingly, the influence of the mat part 1411 on the blower device 1420, the heating devices 1430, and the airbag modules 1440 can be suppressed.

As shown in FIG. 31, the sensor part 1413 is a sheet-shaped pressure sensor that detects a seating pressure applied to the seating surface of the seat body when an occupant is seated in the seat, and is mounted inside the mat part 1411.

Here, “seating pressure” s a value that is periodically changed depending on the physiological activity, specifically, respiration of the seated occupant in a state where the occupant is seated on the seat body, and is an object value that is detected by the pressure sensor.

Meanwhile, the sensor part 1413 may be a seating sensor that is turned on or off depending on the seating pressure of the seated occupant. Preferably, the sensor part 1413 may be a push switch type seating sensor. The sensor part 1413 is not limited to the seating sensor, and may be a heart rate sensor, a respiration sensor, a blood pressure sensor, a pulse wave sensor, or the like.

As shown in FIG. 31, fourth blow-out ports 1424 of the blower device 1420 are arranged on the door panel 1450.

The fourth blow-out ports 1424 are provided on the surface of the door panel 1450 facing a seated occupant. A plurality of fourth blow-out ports 1424 are provided in the up to down direction and are arranged at positions corresponding to the neck, the waist, the femoral region, and the feet of an occupant, respectively.

Meanwhile, a door panel ventilation channel 1451 that allows air from the blower body to pass therethrough is formed in the door panel 1450.

The vehicle seat 1401 can be applied to the following seats.

### <<Health Seat>>

A health seat is a seat that allows an occupant to perform core-strengthening exercises while the occupant is seated. In the related art, an EXA-RIDE seat in which a seating surface of a vehicle seat moves has been proposed as a health seat (for example, JP 2018-086996).

However, since the EXA-RIDE seat in which a seating surface moves as in the related art has large movement of the seating surface, there is a concern that a sense of incompatibility is given to an occupant. For this reason, a seat in which a sense of incompatibility to be given to an occupant is further suppressed has been required.

The present invention is to provide a health seat in which a sense of incompatibility to be given to an occupant is further suppressed.

The vehicle seat 1401 as a health seat further includes a vibration device in addition to the above-mentioned configuration.

The vibration device includes a vibration unit that is provided in a seat body at a position corresponding to a seating surface for an occupant (seated occupant) and applies vibration to the seated occupant, and a moving unit that moves the vibration unit to a seated occupant side.

The vibration unit is to provide a stimulus to the back and hips of the seated occupant, and is provided on a seated occupant side in the seat back 1402 and the seat cushion 1403.

The moving unit is, for example, an air cell and is provided on the back side and the lower side (a side away from the seated occupant) of the vibration unit in the seat back 1402 and the seat cushion 1403. The moving unit moves the vibration unit to the seated occupant side in response to a seated occupant's operation.

Specifically, the moving unit moves the vibration unit toward the seated occupant side from the back side in the seat back 1402 by the driving of a motor to press the vibration unit against the back portion and the waist of the seated occupant.

Further, the moving unit moves the vibration unit toward the seated occupant side from the lower side in the seat cushion 1403 by the driving of the motor to press the vibration unit against the hips or the femoral region of the seated occupant.

As described above, the vibration unit is moved to the seating surface of the seat body by the moving unit only when vibration is to be applied to the seated occupant. Accordingly, a sense of incompatibility to be given to the seated t can be suppressed as compared to a configuration in which the vibration unit is always disposed on the seating surface of the seat body.

Meanwhile, the vibration device may be provided with a pressure sensor detecting that the vibration unit is moved to the seating surface. When the pressure sensor detects that the vibration unit is moved to the seating surface, the vibration device limits (stops) the movement of the vibration unit toward the seated occupant side that is performed by the moving unit. Accordingly, the excessive movement of the vibration unit to the seated occupant side can be suppressed.

An example in which the present invention is applied to the vibration device has been described in this embodiment, but the present invention may be applied to a notification device (a light emitting unit or a voice generation unit) in addition to the vibration device. In this case, the light emitting unit or the voice generation unit is moved to the seating surface of the seat body by the moving unit only when a seated occupant is to be notified with light or voice. For this reason, a sense of incompatibility to be given to the seated occupant can be suppressed as compared to a configuration in which the light emitting unit or the voice generation unit is always disposed on the seating surface of the seat body.

Moreover, the present invention may be applied to a detection device (a detection unit to be moved to the seating surface) or a temperature adjustment device (a heater unit to be moved to the seating surface) in addition to the notification device.

### <<Desk Seat>>

A desk seat is a seat that can be used as a desk for work or study. In the related art, a seat in which a heater panel provided on the back of a front seat of vehicle seats can be used as a table has been proposed as a desk seat (for example, WO 2018/086996).

However, since a table surface of a desk seat as in the related art is also shaken in a case where a vehicle is shaken, there is a concern that work or study may be disrupted. For this reason, a seat that can notify an occupant in a case where shaking is large has been required.

The present invention is to provide a desk seat that can notify an occupant in a case where shaking is large.

The vehicle seat 1401 as a desk seat further includes a table, a vibration detection device, and a notification device that are provided on the back of a front seat in addition to the above-mentioned configuration.

The vibration detection device includes a shaking detection unit that detects the shaking of a vehicle, and a transmission unit that shaking transmits information detected by the shaking detection unit to the notification device.

The shaking detection unit is to detect vibration that is generated when a vehicle passes through a connection portion or a stepped portion of a road, vibration that is generated when a vehicle is overtaken by a large vehicle, such as a large truck, and the like.

In a case where vibration equal to or higher than a predetermined value is detected by the shaking detection unit, the transmission unit transmits shaking information, which corresponds to the level of the vibration, to the notification device.

The notification device includes a light emitting unit and a voice generation unit that inform an occupant depending on information transmitted from the transmission unit. For example, the notification device turns on the light emitting unit in yellow in a case where the level of the vibration is slightly high, and turns on the light emitting unit in red in a case where the level of the vibration is high.

Meanwhile, in a case where the level of the vibration is very high, the notification device may turn off all illumination for a desk so that an occupant cannot continue work or study.

Since the notification device notifies an occupant of the shaking information detected by the vibration detection device as described above, work or study can be limited (or prohibited).

Meanwhile, the vibration detection device may be adapted not to be provided with the shaking detection unit and to inform an occupant of information on the uneven state of a road surface stored in an in-vehicle navigation device or shaking information (predictive value) calculated on the basis of information on surrounding vehicles acquired by an imaging device. In addition, the vibration detection device may correct the calculated predictive value with a vehicle speed and display the corrected predictive value. In this case, the vibration detection device may display a time required until a state where study can be performed is made in addition to displaying the predictive value.

### <<Active Seat>>

An active seat is, for example, a seat that can be used as a controller for a game displayed on a smartphone. An occupant can operate characters in the game displayed on a display by alternately moving up and down the right and left legs on the vehicle seat 1401 or tilting the body.

Since the control device 1460 outputs pressure values acquired from the pressure sensors of the sensor parts 1413 provided in the mat part 1411 to the smartphone as signals for operating a game application of the smartphone, an occupant seated in the vehicle seat 1401 can operate the smartphone by moving one's legs or shoulder on the seat body.

For this reason, an occupant does not need to operate the smartphone with a hand and can operate the smartphone by moving one's body on the seat body.

In addition, it is also possible to vibrate the seating surface of the seat body depending on the development of the game to provide a realistic experience of the game to the occupant. For example, when a balance between the right and left is poor in a game in which a user drives an automobile, the user may feel vibrations that make the user feel bad roads.

Further, the seat body may be rotated by a rotating device or may be moved up and down by a lifting device depending on the progress of the game. In this case, the vehicle seat 1401 may include support parts that prevent an occupant from falling out of the vehicle seat.

The support parts are to support an occupant from the outside in the seat width direction, and are provided on, for example, the seat cushion 1403. The support parts are mounted such that the protruding length of the support part from the seat cushion 1403 can be adjusted.

In addition, it is preferable that the protruding length of the support part can be automatically adjusted depending on the progress of the game by the control device 1460. In this case, information on a situation (the protruding length of the support part, and the like) corresponding to the progress of the game may be displayed on the display.

### <<Refreshing Seat>>

A refreshing seat is a seat that provides pleasant wind (cold wind, warm wind), a desired aroma, a desired music, and pleasant vibration to an occupant.

A case where the control device 1460 provides effects of wind, an aroma, a music, and vibration to a seated occupant on the basis of biological information (for example, an electrocardiogram, a blood pressure, a body temperature, respiration, and the like) detected from the sensor parts 1413 provided in the mat part 1411, and the like are assumed.

In addition, the control device 1460 may include artificial intelligence (AI). In this case, a comfort level of an occupant is calculated on the basis of the biological information detected from the sensor parts 1413, and an effect corresponding to the comfort level is provided.

For example, a case where the blower device 1420 is controlled by the control device 1460 including artificial intelligence (AI) to send wind suitable for the characteristics (sensitivity to cold, sensitivity to heat, or the like) of a seated occupant to the occupant, and the like are assumed. In this case, information on the comfort level may be displayed on the display.

### <<Stretch Seat>>

A stretch seat is a seat that allows an occupant to perform stretching exercises, such as stretching and twisting one's body. The stretch seat includes a seat rotating device that rotates the seat cushion 1403 with respect to the seat back 1402 about an axis parallel to the seat front to rear direction of the seat as a rotation axis in response to an occupant's operation, and a reclining device that connects the seat back 1402 to the seat cushion 1403 to allow the seat back 1402 to move rotationally in response to an occupant's operation.

An occupant can perform an exercise to twist the lower half of the body by rotating the seat cushion 1403 with respect to the seat back 1402 with the seat rotating device while holding the upper half of the body with the armrest 1405.

Further, an occupant can perform an exercise to bend the body backward and to stretch the body by rotating the seat back 1402 with respect to the seat cushion 1403 with the reclining device such that the seat back 1402 is disposed on the lower side.

In this case, information on the degree of flexibility (the degree of twisting, the degree of stretching, and the like) may be displayed on the display.

### <<Sport Gym Seat>>

A sport gym seat is a seat that allows an occupant to train muscles. The vehicle seat 1401 as a sport gym seat includes elastic members on the members (the seat back 1402, the seat cushion 1403, the armrest 1405, and the like), respectively.

An occupant can perform exercises to strength muscles by pressing the elastic member against a biasing force with arms or legs.

In this case, information on training results (the degree of pressing, the number of times of pressing, and the like) may be displayed on the display.

### Sixteenth Embodiment

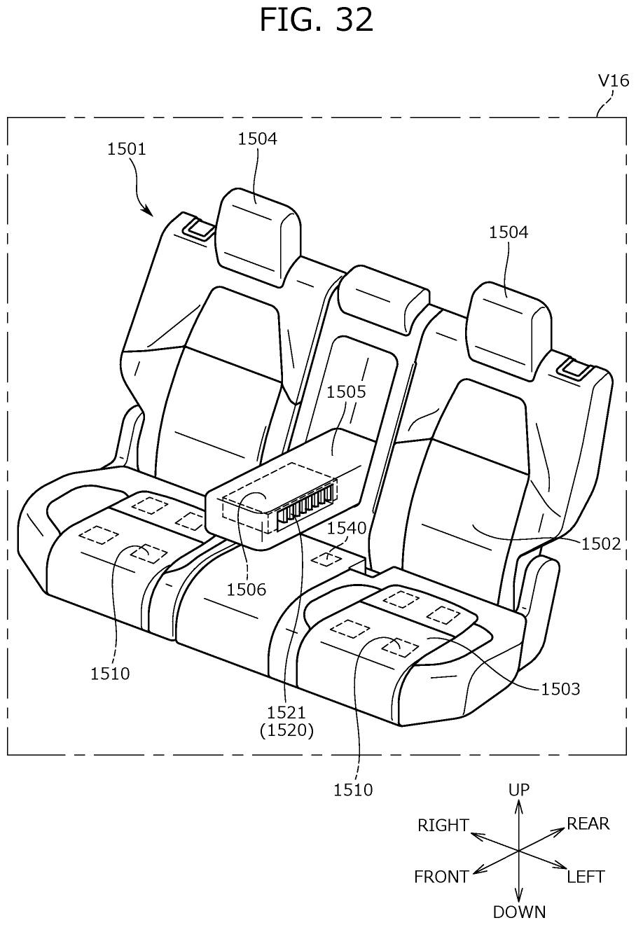

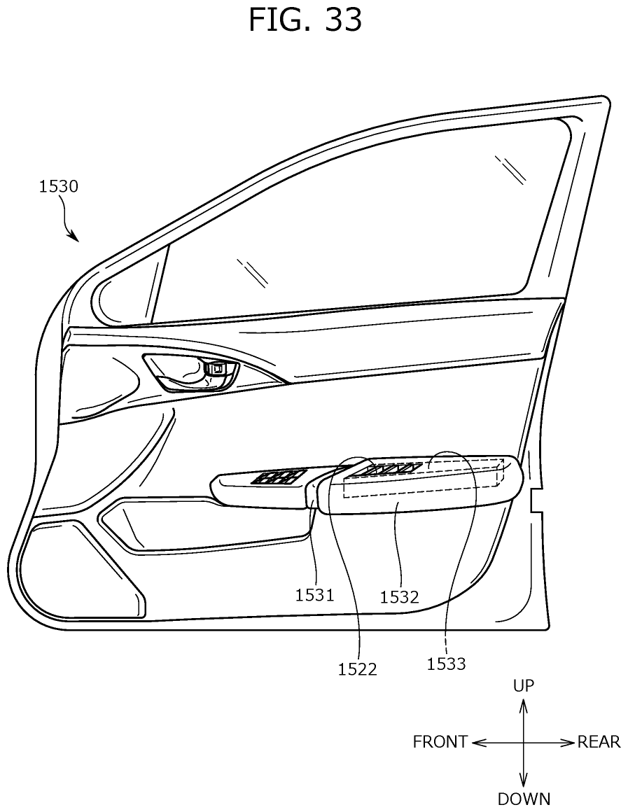

Next, a vehicle V16 according to a sixteenth embodiment will be described with reference to FIGS. 32 and 33.

Meanwhile, the repeated description of the same contents as the vehicles V1 to V15 described above will be omitted. The vehicle V16 according to the sixteenth embodiment is mainly different from the vehicles V1 to V15 in terms of the configuration of a vehicle seat 1501 and a door panel 1530.

As shown in FIG. 32, the vehicle seat 1501 includes a seat back 1502, a seat cushion 1503, headrests 1504, an armrest 1505 that is mounted to be rotationally movable with respect to the seat back 1502, sensor parts 1510, a blower device 1520, and a control device 1540.

The armrest 1505 is mounted to be rotationally movable between a storage position at which the armrest 1505 is stored in the side surface of the seat back 1502 and a support position at which the armrest 1505 can support an occupant's arm.

The blower device 1520 is adapted to blow air out of a seat-side blow-out port 1521 toward a seated occupant through a duct from a blower body. The seat-side blow-out port 1521 is provided on the side surface of the armrest 1505 facing a seated occupant. Meanwhile, an armrest ventilation channel 1506 that allows air from the blower body to pass therethrough is formed in the armrest 1505.

Since the armrest 1505 is mounted to be rotationally movable with respect to the seat back 1502, the position of the seat-side blow-out port 1521 can be adjusted. Accordingly, since the position of the seat-side blow-out port 1521 can be adjusted, an occupant can apply air having passed through the armrest ventilation channel 1506 to a desired position.

As shown in FIG. 33, the door panel 1530 includes a movable door armrest 1531. A door-side blow-out port 1522 of the blower device 1520 is disposed on the surface of a movable arm part 1532 of the door armrest 1531.

Meanwhile, a movable arm ventilation channel 1533 that allows air from the blower body to pass therethrough is formed in the door armrest 1531.

Since the movable arm part 1532 is mounted to be slidable with respect to the door armrest 1531 in the front to rear direction, the position of the door-side blow-out port 1522 can be adjusted. Accordingly, since an occupant can adjust the position of the door-side blow-out port 1522, the occupant can apply air having passed through the movable arm ventilation channel 1533 to a desired position.

The control device 1540 may drive the blower device 1520 according to a seating state of the occupant that is detected by the sensor parts 1510. Accordingly, since the blower device 1520 can be driven only when the occupant is seated, power consumption can be reduced.

### Seventeenth Embodiment

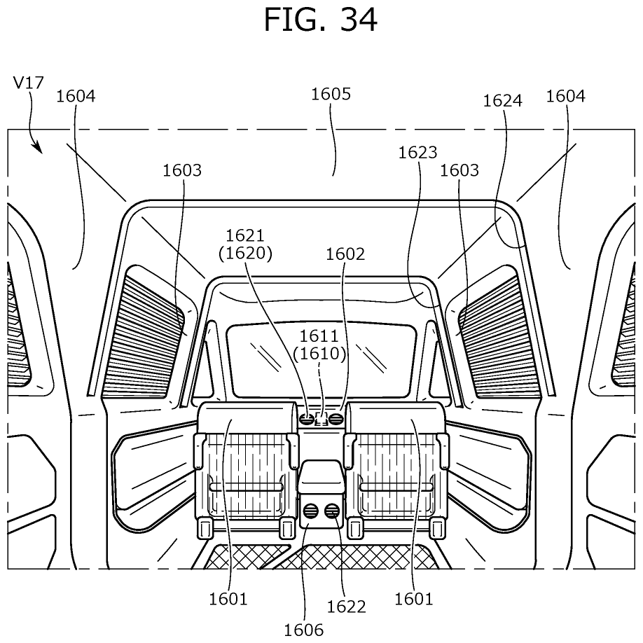

Next, a vehicle V17 according to a seventeenth embodiment will be described with reference to FIG. 34.

Meanwhile, the repeated description of the same contents as the vehicles V1 to V16 described above will be omitted.

The vehicle V17 includes vehicle seats 1601, an instrument panel part 1602, first pillar portions 1603, second pillar portions 1604, a ceiling portion 1605, a console box 1606, a sterilization device 1610, and a blower device 1620.

The sterilization device 1610 is to perform sterilization treatment, such as sterilization, disinfection, air cleaning, deodorization, and ventilation for an interior space of the vehicle V17.

For example, ozone having a strong sterilization effect can be used for sterilization treatment for the vehicle V17. The closed interior space of the vehicle V17 is fumigated with ozone by an ozone generation device, so that sterilization treatment is performed.

A first slit blow-out port 1623 and a second slit blow-out port 1624 are fumigation ports of the ozone generation device. The first slit blow-out port 1623 is provided over the first pillar portions 1603 and the ceiling portion 1605. The second slit blow-out port 1624 is provided over the second pillar portions 1604 and the ceiling portion 1605.

Meanwhile, the first slit blow-out port 1623 and the second slit blow-out port 1624 may also be used as blow-out ports of the blower device 1620. In this case, fumigation ports and blow-out ports are alternately arranged at interval of, for example, 50 mm.

The sterilization treatment is started when various sensors detects that no occupant is present in the vehicle V17. In the vehicle V17, doors are locked when the sterilization treatment is started and the opening of the doors is prohibited until the sterilization treatment ends. Accordingly, an occupant is prevented from accidentally getting in the vehicle V17 during the sterilization treatment. In this case, an occupant may be informed that an occupant cannot get in the vehicle during the sterilization treatment.

After fumigation using ozone ends, ventilation for making an air state where an occupant can get in the vehicle V17 is performed by a ventilator. When the sterilization treatment ends, an occupant may be informed that disinfection has been performed.

For the sterilization treatment, ozone does not necessarily need to be used and a disinfectant, such as alcohol, may be sprayed. In this case, the disinfectant is stored in a chemical storage part 1611 and is sprayed into the interior space of the vehicle V17 from instrument panel blow-out ports 1621 of the instrument panel part 1602 by the blower device 1620.

Meanwhile, the disinfectant may be sprayed into the interior space of the vehicle V17 from console box blow-out ports 1622 of the console box 1606. Further, the disinfectant may be sprayed using ventilation channels formed in the seat bodies of the vehicle seats 1601.

After the spray of the disinfectant ends, ventilation for making an air state where an occupant can get in the vehicle V17 is performed by the ventilator.

### Eighteenth Embodiment

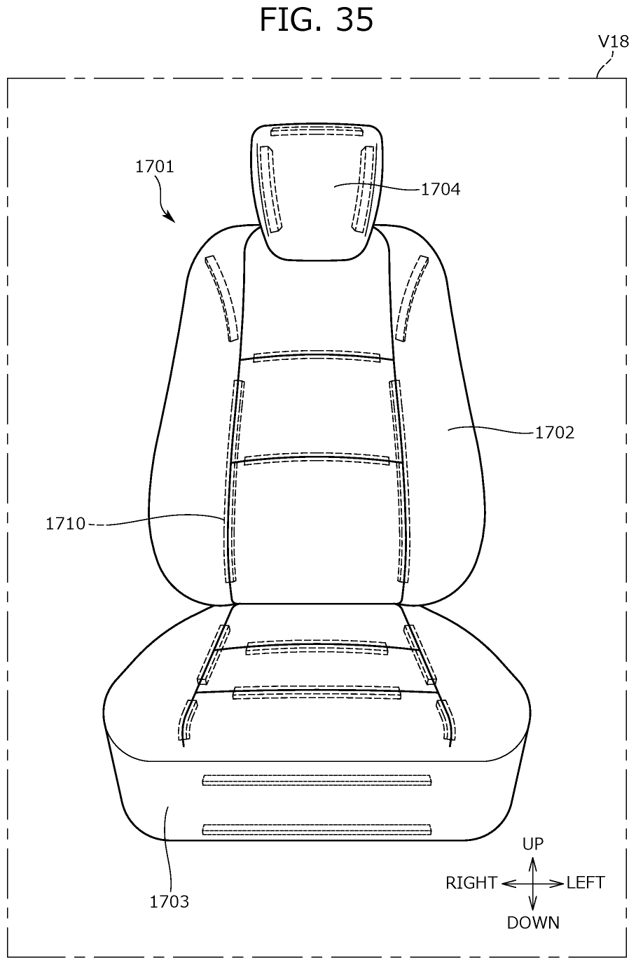

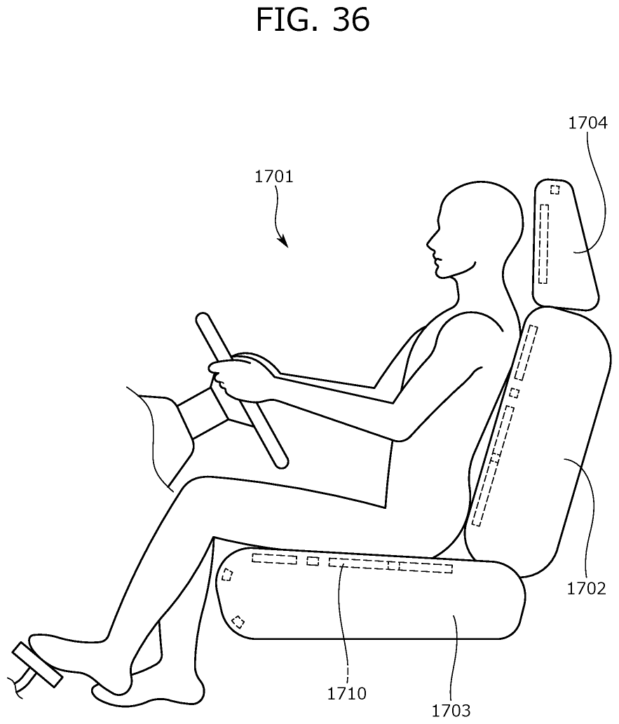

Next, a vehicle V18 according to an eighteenth embodiment will be described with reference to FIGS. 35 and 36.

Meanwhile, the repeated description of the same contents as the vehicles V1 to V17 described above will be omitted.

As shown in FIGS. 35 and 36, a vehicle seat 1701 includes a seat back 1702, a seat cushion 1703, a headrest 1704, and sterilization devices 1710.

The sterilization devices 1710 are to perform sterilization treatment for an occupant seated in the vehicle seat 1701. The sterilization devices 1710 are, for example, LEDs that can apply ultraviolet light or LEDs that use a specific wavelength in visible light, and are arranged in the seat back 1702, the seat cushion 1703, and the headrest 1704. Meanwhile, the shape of the LED may be a rod shape or a dot shape. Further, a cloth-shaped member that emits ultraviolet light may be disposed under an outer skin.

As shown in FIGS. 35 and 36, the sterilization devices 1710 are arranged at positions corresponding to apocrine glands of an occupant in the seat back 1702, the seat cushion 1703, and the headrest 1704. Groove portions or concave portions are formed on the seat back 1702, the seat cushion 1703, and the headrest 1704, and the sterilization devices 1710 are arranged in the groove portions or the concave portions.

Since the sterilization devices 1710 are arranged in the groove portions or the concave portions, a sense of incompatibility to be given to an occupant can be suppressed as compared to a case where the sterilization devices 1710 are arranged on the seating surface of the seat.

### Nineteenth Embodiment

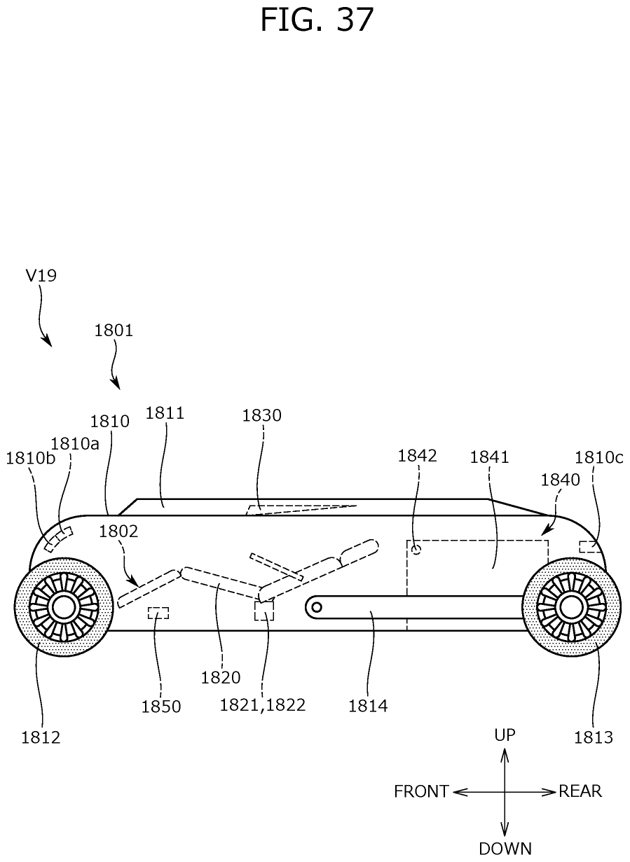

Next, a vehicle V19 according to a nineteenth embodiment will be described with reference to FIGS. 37 to 39.

Meanwhile, the repeated description of the same contents as the vehicles V1 to V18 described above will be omitted.

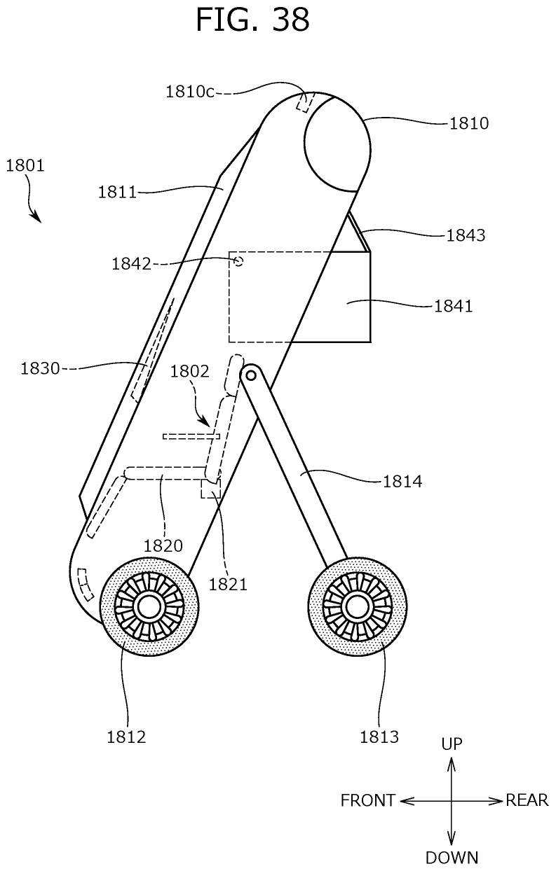

The vehicle V19 is an autonomous four-wheeled electric vehicle (EV) of which the form is changed, for example, when an occupant drives the vehicle and when an occupant gets in and off the vehicle as shown in FIGS. 37 and 38, and includes a vehicle body 1801 that is long in the front to rear direction and a vehicle seat 1802 that is disposed in an interior space of the vehicle body 1801.

Meanwhile, the vehicle V19 is not limited to a four-wheeled autonomous car, and may be, for example, three-wheeled (two front wheels, one rear wheel) autonomous car.

The vehicle V19 is adapted to be switchable between a traveling mode (FIG. 37) in which the vehicle travels and a getting-in/off mode (FIG. 38) in which an occupant can get in and off. The traveling mode is a state where the vehicle body 1801 lies down, and the getting-in/off mode is a state where the vehicle body 1801 stands up.

Meanwhile, the vehicle V19 may include an informing unit that allows an occupant to check a change in the form of the vehicle body 1801 and a permission operation unit that allows an occupant to perform an operation for permitting a change in the form of the vehicle body 1801, when the traveling mode and the getting-in/off mode are switched. Accordingly, for example, when two or more occupants get in the vehicle, it is possible to suppress the unexpected operation of the vehicle body 1801.

Since the vehicle body 1801 is long in the front to rear direction and a front end portion thereof has a rounded shape, wind resistance of the vehicle body 1801 is reduced in the traveling mode. As a result, fuel efficiency can be improved. Further, since the interior space of a passenger compartment can be made small, air-conditioning performance in the interior space can be improved.

Furthermore, when the vehicle V19 is to be parked, the vehicle V19 may be switched to the getting-in/off mode. Accordingly, a parking space can be reduced in size.

The vehicle body 1801 includes a vehicle body-outer wall part 1810 that partitions off the interior space of the vehicle body 1801 from an exterior space of the vehicle body, a door part 1811 that allows an occupant to get in and off the vehicle, front tires 1812, rear tires 1813, a tire link part 1814 that is mounted on a middle portion of the vehicle body-outer wall part 1810 in a longitudinal direction, a display device 1830 that is mounted on the inside of the door part 1811, and a storage device 1840 that is mounted on the vehicle body-outer wall part 1810 to be rotationally movable.

The vehicle body-outer wall part 1810 includes, at a front end portion (a position corresponding to a lower end portion in the getting-in/off mode), a charging unit 1810a that is used to charge the vehicle V19 and a state detection sensor 1810b that detects the state of the vehicle body 1801. Further, the vehicle body-outer wall part 1810 includes, at a rear end portion (a position corresponding to an upper end portion in the getting-in/off mode), an upper detection sensor 1810c that detects an obstacle present above the vehicle body 1801.

A battery (not shown) of the vehicle V19 can be charged through a wire or wirelessly by the charging unit 1810a.

Furthermore, whether the vehicle body 1801 is in the traveling mode or the getting-in/off mode is detected by the state detection sensor 1810b. When the vehicle body 1801 is in the traveling mode, a control device 1850 provided in the vehicle body 1801 controls the vehicle such that the door part 1811 is not opened and closed. Further, when the vehicle body 1801 is in the getting-in/off mode, the control device 1850 controls the vehicle to limit traveling. In this case, it is preferable that the vehicle is controlled to be capable of traveling at a speed equal to or lower than a predetermined speed (for example, a speed at which the vehicle can travel in a parking lot) while the vehicle body is in the getting-in/off mode. Accordingly, the vehicle can travel in the parking lot while the vehicle body is in the getting-in/off mode.

In addition, in a case where an obstacle (the ceiling of the parking lot, or the like) present above the vehicle body 1801 is detected by the upper detection sensor 1810c when the vehicle body 1801 is to be transformed from the traveling mode into the getting-in/off mode, the control device 1850 controls the vehicle to limit the transformation of the vehicle body 1801. Accordingly, it is possible to suppress interference with the obstacle, which is present above, when the vehicle body 1801 is transformed from the traveling mode into the getting-in/off mode.

The door part 1811 is, for example, an opening/closing door of a canopy type, a gull wing type, a scissor door type, or the like and is mounted on the vehicle body-outer wall part 1810 to be rotationally movable.

The door part 1811 is mounted to be openable and closable with respect to the rear end portion of the vehicle body-outer wall part 1810. The door part 1811 can be opened and closed in the getting-in/off mode. When the front end portion of the door part 1811 flips upward, the door part 1811 is opened and an occupant can get in and off the vehicle.

The tire link part 1814 is to switch the vehicle body 1801 between the traveling mode and the getting-in/off mode, and one end portion of the tire link part 1814 is mounted on the vehicle body-outer wall part 1810 to be rotationally movable and the other end thereof is fixed to the rear tires 1813.

The tire link part 1814 is rotationally moved to a position at which the rear tires 1813 are close to the front tires 1812 by a motor (not shown), so that the vehicle body 1801 is switched between the traveling mode and the getting-in/off mode.

The display device 1830 is a touch panel type display that allows an occupant to check the surroundings of the vehicle body 1801. The display device 1830 displays a video acquired from a camera (not that images the shown) surroundings of the vehicle body 1801. Further, when an occupant sets a destination using a touch panel, the vehicle V19 can be autonomously driven.

Meanwhile, when the vehicle body 1801 is in the getting-in/off mode, the display device 1830 may be made optically transparent so that a field of view in front of an occupant seated in the vehicle seat 1802 is not blocked by the display device 1830.

The storage device 1840 is a trunk in which occupant's baggage can be stored. The storage device 1840 includes a storage part 1841 in which occupant's baggage is placed, a storage rotating part 1842 that allows the storage part 1841 to rotationally move with respect to the vehicle body-outer wall part 1810, and a storage link part 1843 that holds a placement surface of the storage part 1841 having rotationally moved at a position at which the placement surface is held horizontal.

The storage part 1841 is moved from the interior space of the vehicle body 1801 to the exterior space when the vehicle body 1801 is transformed from the traveling mode into the getting-in/off mode.

The storage rotating part 1842 allows the storage part 1841 to be rotationally moved by the driving of a motor in response to an occupant' operation. When the vehicle body 1801 is transformed from the traveling mode into the getting-in/off mode, the storage rotating part 1842 allows the storage part 1841 to rotationally move to a position at which the stored baggage can be taken in and out in conjunction with the transformation of the vehicle body 1801 from the traveling mode to the getting-in/off mode.

The control device 1850 provided in the vehicle body 1801 controls the storage rotating part 1842 such that the placement surface of the storage part 1841 is kept in a horizontal state by a horizontal sensor detecting a horizontal state when the vehicle body 1801 is transformed from the traveling mode into the getting-in/off mode.

Accordingly, for example, in a case where a cup containing beverage is placed in the storage part 1841 in the traveling mode, it is possible to suppress the spilling of the beverage contained in the cup when the vehicle body 1801 is transformed into the getting-in/off mode.

As shown in FIGS. 37 and 38, the vehicle seat 1802 includes a seat body 1820 that includes a seat back, a seat cushion, and a footrest, a seat drive device 1821 that allows the seat body 1820 to be rotatably mounted on a bottom of the vehicle body-outer wall part 1810, and a seat transformation device 1822 that changes the shape of the seat body 1820.

The seat drive device 1821 allows the seat body 1820 to rotationally move between a traveling position at which the seat body 1820 lies down when the vehicle body 1801 is in the traveling mode and a getting-in/off position at which the seat body 1820 stands up when the vehicle body 1801 is in the traveling mode.

The seat transformation device 1822 changes angles of the seat back and the footrest with respect to the seat cushion. Specifically, when the seat body 1820 is in the getting-in/off position, the seat body 1820 is brought into a state (the shape of a bed substantially flat in a horizontal direction) where the angles of the seat back and the footrest with respect to the seat cushion are changed to about 180 degrees by the seat transformation device 1822. When the seat body 1820 is in the traveling position, the seat body 1820 is brought into a state (the shape of a chair in which an occupant can be seated) where the angles of the seat back and the footrest with respect to the seat cushion are changed to about 90 degrees by the seat transformation device 1822.

Since the seat body 1820 is rotationally moved in accordance with the form of the vehicle body 1801 by the seat drive device 1821 as described above, it is possible to obtain the vehicle seat 1802 where an occupant easily gets in and off while making the vehicle body 1801 compact in size.

In addition, since the seat body 1820 is transformed in accordance with the form of the vehicle body 1801 by the seat transformation device 1822, it is possible to suppress the slip-down of an occupant's body from the seat body 1820 when the seat body 1820 rotationally moves from the traveling position to the getting-in/off position.

A modification example of the vehicle V19 will be described below.

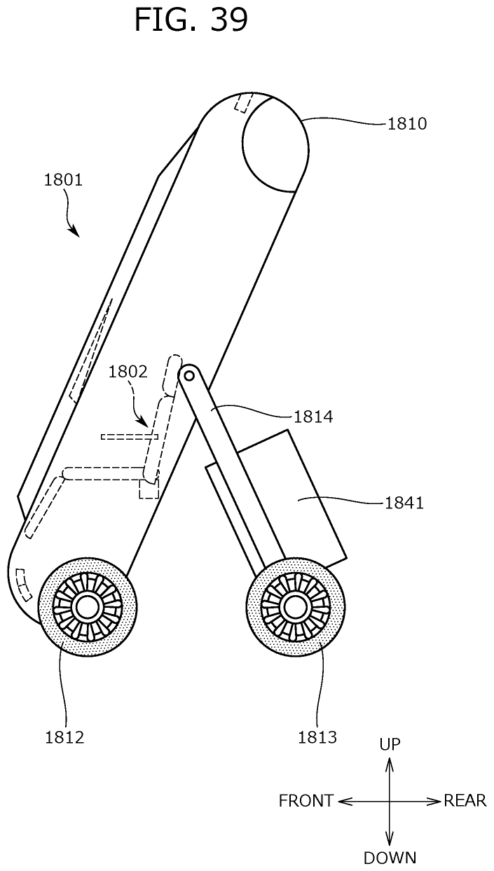

A modification example shown in FIG. 39 is mainly different from FIG. 38 in terms of the configuration of a storage device 1840.

The storage device 1840 includes a storage part 1841 fixed to the tire link part 1814. When the vehicle body 1801 is transformed from the traveling mode into the getting-in/off mode, the storage part 1841 is moved from the interior space of the vehicle body 1801 to the exterior space with the rotational movement of the tire link part 1814.

When the vehicle body 1801 is transformed from the traveling mode into the getting-in/off mode as described above, it is possible to move the storage part 1841 to a position where stored baggage can be taken in and out with a simple configuration.

### Twentieth Embodiment

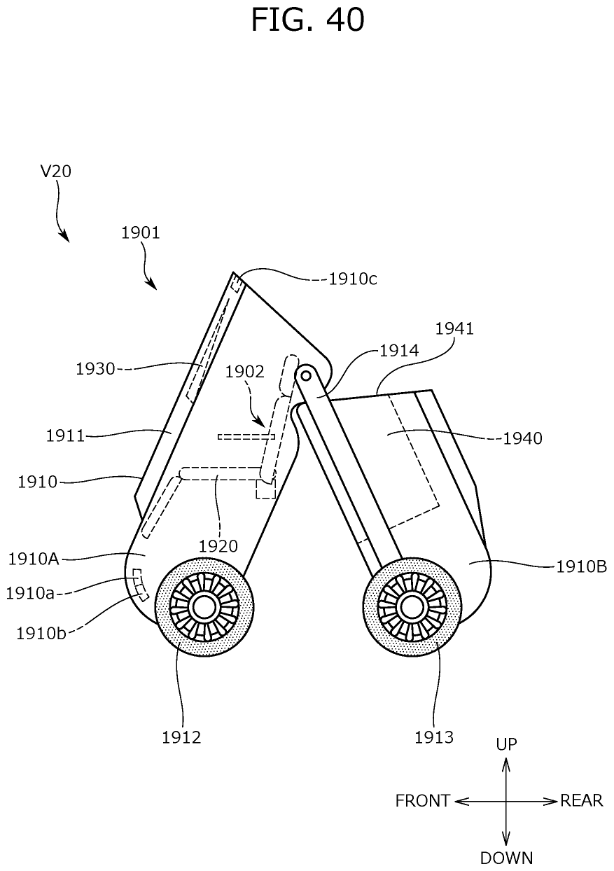

Next, a vehicle V20 according to a twentieth embodiment will be described with reference to FIG. 40.

Meanwhile, the repeated description of the same contents as the vehicles V1 to V19 described above will be omitted.

The vehicle V20 according to the twentieth embodiment is mainly different from the vehicles V1 to V19 in terms of the configuration of a vehicle body 1901.

The vehicle body 1901 includes a vehicle body-outer wall part 1910 that partitions off an interior space of the vehicle body 1901 from an exterior space of the vehicle body, a door part 1911 that allows an occupant to get in and off the vehicle, front tires 1912, rear tires 1913, a tire link part 1914 that is mounted on a middle portion of the vehicle body-outer wall part 1910 in a longitudinal direction, a display device 1930 that is mounted on the inside of the door part 1911, and a storage device 1940 that is mounted on the tire link part 1914 to be rotationally movable.

The vehicle body-outer wall part 1910 is divided into two parts at the middle portion in the longitudinal direction. A front vehicle body part 1910A provided on a front side and a rear vehicle body part 1910B provided on a rear side are connected to each other by the tire link part 1914.

Meanwhile, the vehicle body-outer wall part 1910 includes a charging unit 1910a, a detection sensor 1910b that detects a state where the vehicle body-outer wall part 1910 is divided into two parts, and an upper detection sensor 1910c that is provided at a position corresponding to an upper end portion in the getting-in/off mode and detects an obstacle present above the vehicle body 1901.

The front vehicle body part 1910A is provided with a door part 1911, the front tires 1912, and a display device 1930. Further, a vehicle seat 1902 is disposed in an interior space of the front vehicle body part 1910A.

The rear vehicle body part 1910B is provided with the rear tires 1913. Further, a storage device 1940 is disposed in an interior space of the rear vehicle body part 1910B.

The storage device 1940 includes a storage part 1941 fixed in the interior space of the rear vehicle body part 1910B. When the vehicle body 1901 is transformed from a traveling mode into a getting-in/off mode, the storage part 1941 is moved to a position where stored baggage can be taken in and out with the rotational movement of the tire link part 1914.

When the vehicle body 1901 is transformed from the traveling mode into the getting-in/off mode as described above, it is possible to move the storage part 1941 to a position where stored baggage can be taken in and out with a simple configuration.

### Twenty-First Embodiment

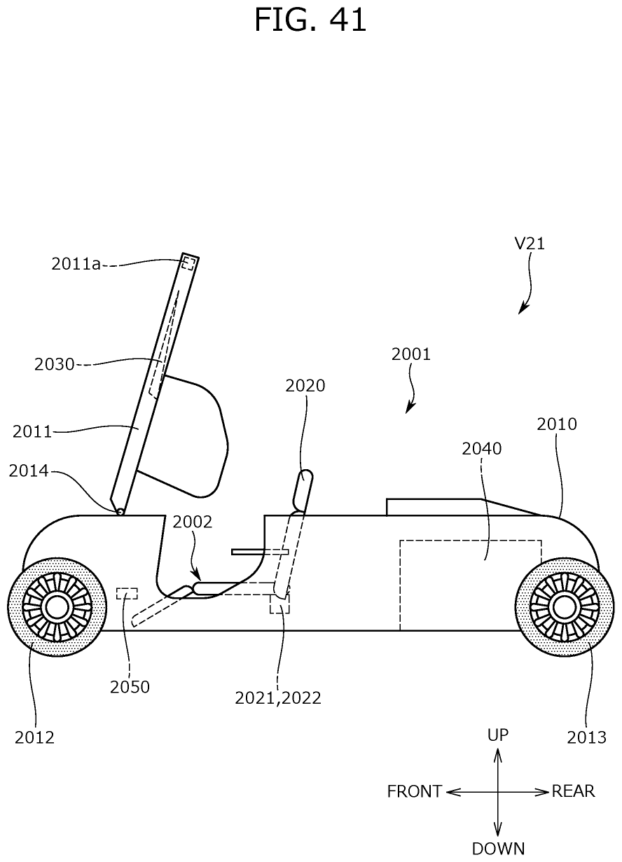

Next, a vehicle V21 according to a twenty-first embodiment will be described with reference to FIG. 41.

Meanwhile, the repeated description of the same contents as the vehicles V1 to V20 described above will be omitted.

The vehicle V21 according to the twenty-first embodiment is mainly different from the vehicles V1 to V20 in terms of the configuration of a vehicle body 2001.

The vehicle body 2001 includes a vehicle body-outer wall part 2010 that partitions off an interior space of the vehicle body 2001 from an exterior space of the vehicle body, a door part 2011 that allows an occupant to get in and off the vehicle, front tires 2012, rear tires 2013, a door drive unit 2014 that is mounted on a front portion of the vehicle body-outer wall part 2010 in a longitudinal direction, a display device 2030 that is mounted on the inside of the door part 2011, and a storage device 2040 that is mounted in an interior space of the vehicle body-outer wall part 2010.

In this embodiment, the positions of the front tires 2012 and the rear tires 2013 with respect to the vehicle body-outer wall part 2010 are fixed.

The door part 2011 is mounted to be openable and closable with respect to the vehicle body-outer wall part 2010, and is mounted on a front end portion of the vehicle body-outer wall part 2010.

The door drive unit 2014 allows the door part 2011 to rotationally move to switch the door part 2011 between a traveling position and a getting-in/off position. When the door part 2011 is in the traveling position, the door part 2011 is disposed at a position where the door part 2011 is closed with respect to the vehicle body-outer wall part 2010. When the door part 2011 is in the getting-in/off position, a rear end portion of the door part 2011 is moved upward, so that the interior space of the vehicle body 2001 is opened. Meanwhile, a front end portion of the door part 2011 may be moved upward, so that the interior space of the vehicle body 2001 may be opened.

As shown in FIG. 41, the rear end portion of the door part 2011 is moved upward by the door drive unit 2014, so that the door part 2011 is opened and an occupant can get in and off the vehicle. A state where the door part 2011 is in the traveling position is the getting-in/off mode of the vehicle body 2001, and a state where the door part 2011 is in the getting-in/off position is the getting-in/off mode of the vehicle body 2001.

An upper detection sensor 2011a is mounted on the rear end portion of the door part 2011. In a case where an obstacle (for example, the ceiling of a parking lot, or the like) present above the vehicle body 2001 is detected by the upper detection sensor 2011a when the vehicle body 2001 is to be transformed into the getting-in/off mode, the control device 2050 controls the vehicle to limit the transformation of the vehicle body 2001. Accordingly, it is possible to suppress interference with the obstacle, which is present above, when the vehicle body 2001 is transformed from the traveling mode into the getting-in/off mode.

A seat drive device 2021 allows a seat body 2020 to rotationally move between a traveling position at which the seat body 2020 lies down when the vehicle body 2001 is in the traveling mode and a getting-in/off position at which the seat body 2020 stands up when the vehicle body 2001 is in the traveling mode.

A seat transformation device 2022 changes angles of a seat back and a footrest with respect to a seat cushion. Specifically, when the seat body 2020 is in the getting-in/off position, the seat body 2020 is brought into a state (the shape of a bed substantially flat in a horizontal direction) where the angles of the seat back and the footrest with respect to the seat cushion are changed to about 180 degrees by the seat transformation device 2022. When the seat body 2020 is in the traveling position, the seat body 2020 is brought into a state (the shape of a chair in which an occupant can be seated) where the angles of the seat back and the footrest with respect to the seat cushion are changed to about 90 degrees by the seat transformation device 2022.

Since the seat body 2020 is rotationally moved in accordance with the form of the vehicle body 2001 by the seat drive device 2021 as described above, it is possible to obtain the vehicle seat 2002 where an occupant easily gets in and off while making the vehicle body 2001 compact in size.

In addition, since the seat body 2020 is transformed in accordance with the form of the vehicle body 2001 by the seat transformation device 2022, it is possible to suppress the slip-down of an occupant's body from the seat body 2020 when the seat body 2020 rotationally moves from the traveling position to the getting-in/off position.

### Twenty-Second Embodiment

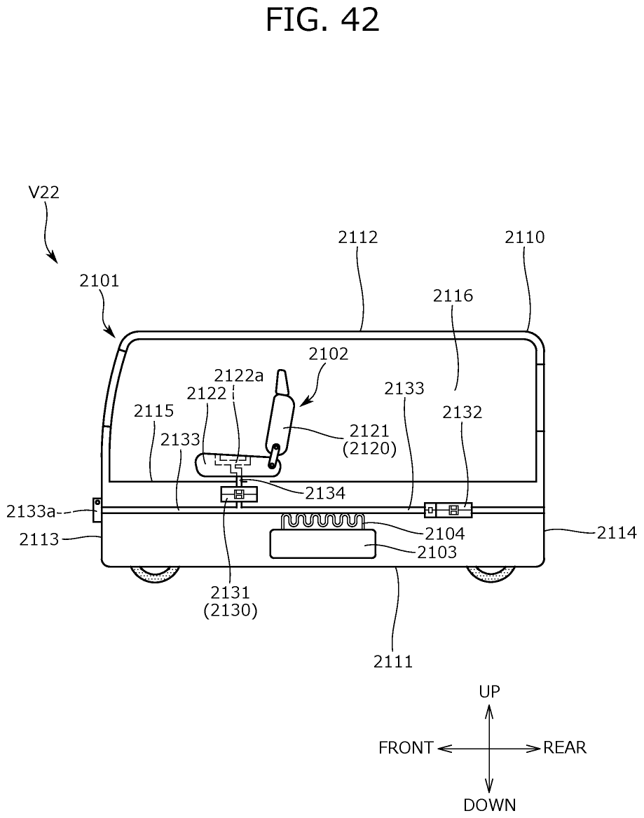

Next, a vehicle V22 according to a twenty-second embodiment will be described with reference to FIG. 42.

Meanwhile, the repeated description of the same contents as the vehicles V1 to V21 described above will be omitted.

As shown in FIG. 42, the vehicle V22 includes a vehicle body 2101, a vehicle seat 2102 that is disposed in an interior space of the vehicle body 2101, a battery 2103 for driving a vehicle that supplies electric power to an electric motor, a heat sink 2104 that dissipates the heat of the battery 2103, and a seat-air conditioner 2130.

As shown in FIG. 42, the vehicle body 2101 includes a vehicle body-outer wall part 2110 that partitions off an interior space of the vehicle body 2101 from an exterior space of the vehicle body and a vehicle body floor 2115 on which a vehicle seat 2 is disposed. The vehicle body-outer wall part 2110 includes a vehicle body-bottom wall portion 2111, a vehicle body-upper wall portion 2112, a vehicle body-front wall portion 2113, a vehicle body-rear wall portion 2114, and vehicle body-side wall portions 2116.

The vehicle body-bottom wall portion 2111 is to partition off the interior space from the exterior space at a lower portion of the vehicle V22. Equipments, such as the battery 2103, the heat sink 2104, the seat-air conditioner 2130, an ECU of an automatic driving control device, and harness, are arranged on the vehicle body-bottom wall portion 2111.

The heat sink 2104 is a plurality of fins provided on an upper surface of the battery 2103. The heat sink 2104 is connected to a blower passage 2133 of the seat-air conditioner 2130, and radiates heat generated from the battery 2103 to the blower passage 2133.

The seat-air conditioner 2130 includes a first blower body 2131 that sends air to a seat body 2120, a second blower body 2132 that sends air to the outside of the vehicle body 2101, a blower passage 2133 that allows air heated by heat radiated from the heat sink 2104 to pass therethrough, and a cabin-connecting passage 2134 that allows air to pass from the first blower body 2131 to the seat body 2120.

The first blower body 2131 is disposed below the seat body 2120, and discharges air, which is heated in the blower passage 2133, toward the seat body 2120.

Further, the first blower body 2131 sucks air in a passenger compartment of the vehicle body 2101 (a space surrounded by the vehicle body-upper wall portion 2112, the vehicle body-front wall portion 2113, the vehicle body-rear wall portion 2114, the vehicle body floor 2115, and the vehicle body-side wall portions 2116).

As described above, the first blower body 2131 can be switched between a state where air heated in the blower passage 2133 is discharged toward the seat body 2120 and a state where air in the passenger compartment of the vehicle body 2101 is sucked.

The second blower body 2132 is to discharge air, which is heated in the blower passage 2133, to the outside, and is disposed at a rear portion of the vehicle body-outer wall part 2110.

The blower passage 2133 is a hollow pipe member extending in the front to rear direction of the vehicle body 2101, a front end portion of the blower passage 2133 is connected to the vehicle body-front wall portion 2113, and a rear end portion thereof is connected to the vehicle body-rear wall portion 2114.

An openable and closable lid 2133a is provided at the front end portion of the blower passage 2133. When the lid 2133a is opened, air flows in from the outside. Accordingly, even though the first blower body 2131 or the second blower body 2132 is not driven, air in the passenger compartment can be sucked and can be discharged from the rear end portion of the blower passage 2133.

As shown in FIG. 42, the vehicle seat 2102 includes a seat body 2120 that includes a seat back 2121 and a seat cushion 2122.

A cushion ventilation channel 2122a that allows air from the first blower body 2131 to pass therethrough is formed in the seat cushion 2122. Air sent from the first blower body 2131 passes through the cushion ventilation channel 2122a and is blown out from blow-out ports provided on the surface of the seat cushion 2122 toward a seated occupant.

When a temperature in the passenger compartment of the vehicle body 2101 is low, a control device provided in the vehicle body 2101 controls the first blower body 2131 to drive the first blower body 2131 and to send air, which is heated in the blower passage 2133, toward the seat body 2120.

When a temperature in the passenger compartment of the vehicle body 2101 is appropriate, the control device controls the second blower body 2132 to drive the second blower body 2132 and to discharge air, which is heated in the blower passage 2133, to the outside.

When a temperature in the passenger compartment of the vehicle body 2101 is high, the control device controls the first blower body 2131 and the second blower body 2132 to drive the first blower body 2131 and the second blower body 2132, to suck air in the passenger compartment, and to discharge the air to the outside.

Accordingly, since it is possible to heat the passenger compartment with the exhaust heat of the battery 2103 while appropriately cooling the battery 2103, it is possible to improve a power-saving effect.

Meanwhile, in a case where a lithium-air battery is used as the battery 2103, the blower passage 2133 may be used to supply oxygen. When the blower passage 2133 is used for two purposes, an energy loss can be reduced as compared to a case where the flow of air is made separately.

### Twenty-Third Embodiment

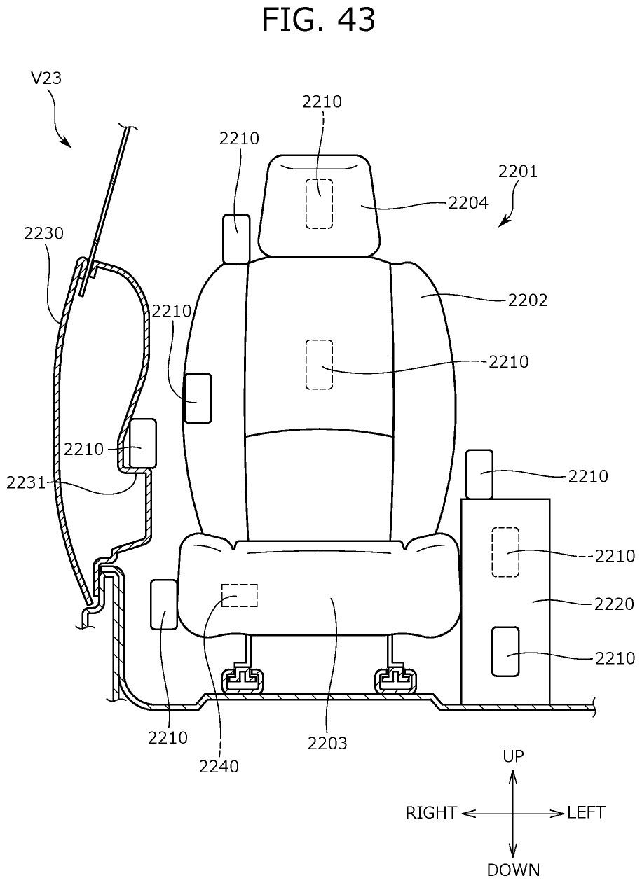

Next, a vehicle V23 according to a twenty-third embodiment will be described with reference to FIG. 43.

Meanwhile, the repeated description of the same contents as the vehicles V1 to V22 described above will be omitted.

A charging system that can simultaneously charge electric vehicles has been proposed in the related art (for example, JP 2021-141648).

However, the charging system in the related art supplies electric power according to a priority, but there is a concern that an electric vehicle with a low priority may have a long waiting time for charging.

As a waiting time for charging is increased, an occupant takes a nap or snack in a passenger compartment during charging and becomes absorbed in a smartphone. For this reason, there is a concern that the occupant cannot notice the completion of charging or the occurrence of a problem in charging. Further, in a case where vehicles stay at a charging station for so long, there is a concern that other vehicles cannot be charged which causes inconvenience.

An object of the present invention is to provide a vehicle that can notify an occupant of the completion of charging or the occurrence of a problem in charging and can also allow an occupant to be considerate of other vehicles.

Further, the use of an air conditioner provided in a vehicle is usually limited during charging (for example, a power saving mode). For this reason, as a waiting time for charging is increased, there is a concern that the passenger compartment cannot be kept at a comfortable temperature.

An object of the present invention is to provide a vehicle that makes a passenger compartment as a comfortable space even during charging.

As shown in FIG. 43, the vehicle V23 includes a vehicle seat 2201, heating/cooling devices 2210, a console box 2220, a door panel 2230, and a control device 2240.

The vehicle seat 2201 includes a seat back 2202, a seat cushion 2203, and a headrest 2204.

The heating/cooling device 2210 is a rechargeable panel member that can control heating and cooling, and is formed of, for example, a Peltier element that can radiate heat by being energized in one direction and absorb heat by being energized in the other direction.

As shown in FIG. 43, a plurality of heating/cooling devices 2210 are provided, and are arranged on the vehicle seat 2201, the console box 2220, and the door panel 2230. The heating/cooling devices 2210 are detachably mounted on mounting portions that are provided on the vehicle seat 2201, the console box 2220, and the door panel 2230.

As shown in FIG. 43, the mounting portions are arranged at, for example, a back portion, a side portion, and an upper portion of the seat back 2202, a side portion of the seat cushion 2203, a back portion of the headrest 2204, a front portion and a back portion of the console box 2220, an upper portion of a door armrest 2231 of the door panel 2230, and the like.

A rechargeable battery is built in the heating/cooling device 2210. When the heating/cooling device 2210 is mounted on each mounting portion, electric power is supplied to the rechargeable battery from a battery for driving a vehicle provided in a vehicle body and the heating/cooling device 2210 is charged.

While the electric vehicle is charged, an occupant can detach the heating/cooling device 2210 from each mounting portion and bring the heating/cooling device 2210 into contact with one's hand or body to adjust a body temperature.

Meanwhile, an occupant's body or air in the passenger compartment may be heated or cooled in a state where the heating/cooling device 2210 is mounted on the mounting portion. Further, the heating/cooling devices 2210 may be embedded in a pad member of the vehicle seat 2201.

At a predetermined time (for example, 5 minutes) before the completion of charging or when a problem occurs in charging, the control device 2240 vibrates a seat body of the vehicle seat 2201 to perform control to notify an occupant. Sound or voice from a speaker provided in the vehicle V23, display on a navigation device, lighting of door illuminations, and the like are exemplified for the notification. Further, the occupant may be notified of the completion of charging through an occupant's smartphone.

In a state where the seat back 2202 is significantly inclined with respect to the seat cushion 2203 (relax mode), the seat back 2202 may return to a state in driving to notify an occupant of the completion of charging.

Further, in a case where the charging station wirelessly supplies electric power to a vehicle V23 stopping at the charging station, the charging station may perform control to automatically evacuate the vehicle when the charging is completed.

Furthermore, in a case where the vehicle V23 does not move from the charging station even after a predetermined time has passed from the completion of charging, the charging station may impose a penalty on an occupant. For example, the penalty may be to reduce a reward rate of reward points for the charging station.

### Twenty-Fourth Embodiment

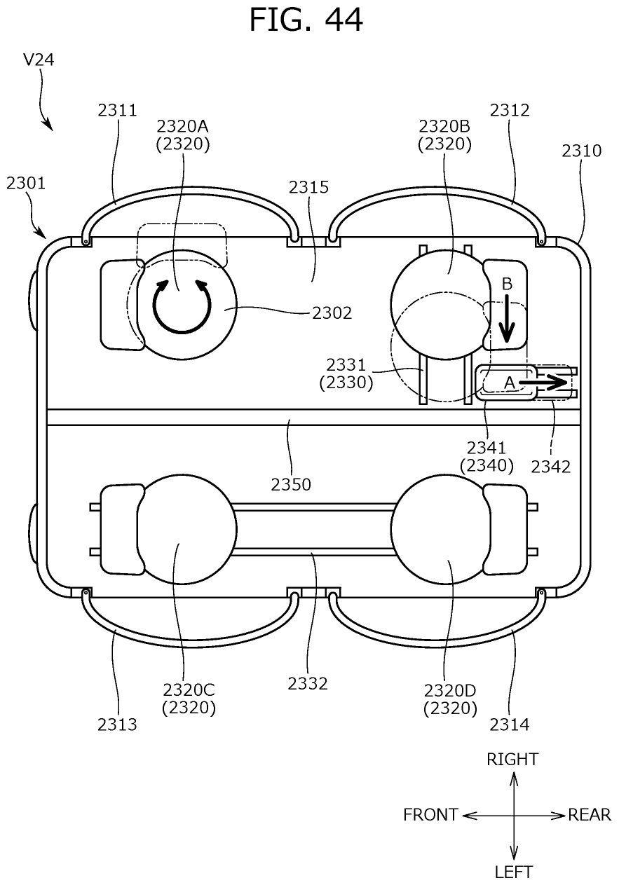

Next, a vehicle V24 according to a twenty-fourth embodiment will be described with reference to FIGS. 44 to 46.

Meanwhile, the repeated description of the same contents as the vehicles V1 to V23 described above will be omitted.

As shown in FIGS. 44 to 46, a vehicle body 2301 includes a vehicle body-outer wall part 2310 that is disposed to surround vehicle seats 2302 and a vehicle body floor 2315 on which the vehicle seats 2302 are arranged.

The vehicle body-outer wall part 2310 includes a right front curved door 2311, a right rear curved door 2312, a left front curved door 2313, and a left rear curved door 2314 as doors that allow occupants to get in and off the vehicle.

As shown in FIG. 44, each door is a curved door that bulges outward in the vehicle width direction and has a curved shape. Each door includes a curved concave portion on a passenger compartment side. Accordingly, when a seat body 2320 of each of the vehicle seats 2302 arranged in an interior space is rotated, a part of the seat body 2320 enters the curved concave portion. As a result, interference between the seat body 2320 and the door can be suppressed. The curved door is particularly preferable for a seat that includes an armrest with a large overhang.

Since each of the right front curved door 2311 and the left front curved door 2313 is provided with a hinge at a front end portion thereof in the front to rear direction of the vehicle body, rear end portions of the right front curved door 2311 and the left front curved door 2313 are opened. Since each of the right rear curved door 2312 and the left rear curved door 2314 is provided with a hinge at a rear end portion thereof in the front to rear direction of the vehicle body, front end portions of the right rear curved door 2312 and the left rear curved door 2314 are opened. Meanwhile, the position of the hinge of each door is not limited thereto. For example, each door may be a so-called double hinged door which is provided with hinges at a front end portion thereof and a rear end portion thereof and of which either the front end portion or the rear end portion are opened.

As shown in FIGS. 44 to 46, the vehicle seat 2302 includes a seat body 2320, a rail device 2330 that supports the seat bodies 2320 to allow the seat bodies 2320 to move rightward and leftward or to move forward and rearward with respect to the vehicle body floor 2315, and a partition 2350 that divides a passenger compartment into a right area and a left area.

The vehicle V24 includes a plurality of seat bodies 2320. Specifically, the vehicle V24 includes a right front seat body 2320A, a right rear seat body 2320B disposed behind the right front seat body 2320A, a left front seat body 2320C disposed on the left side of the right front seat body 2320A, and a left rear seat body 2320D disposed behind the left front seat body 2320C, on the vehicle body floor 2315.

As shown in FIG. 44, the rail device 2330 is disposed between the seat body 2320 and the vehicle body floor 2315 in the up to down direction, and includes right-left rails 2331 extending in the right to left direction and front-rear rails 2332 extending in the front to rear direction.

The right-left rails 2331 support the right rear seat body 2320B to allow the right rear seat body 2320B to move rightward and leftward with respect to the vehicle body floor 2315.

The front-rear rails 2332 support the left front seat body 2320C and the left rear seat body 2320D to allow the left front seat body 2320C and the left rear seat body 2320D to move forward and rearward with respect to the vehicle body floor 2315.

As shown in FIG. 44, a movable storage unit 2340 includes a storage part 2341 that stores occupant's baggage, and storage part rails 2342 that extend in the front to rear direction.

The storage part rails 2342 support the storage part 2341 to allow the storage part 2341 to move forward and rearward with respect to the vehicle body floor 2315.

As shown in FIG. 44, the storage part rails 2342 allow the storage part 2341 to move in a direction of an arrow A. The right-left rails 2331 allow the right rear seat body 2320B to move in a direction of an arrow B.

In a case where the right rear seat body 2320B is to be moved in the direction of the arrow B as described above, the storage part 2341 is evacuated in the direction of the arrow A first, so that interference with the storage part 2341 can be suppressed. Meanwhile, a direction in which the storage part rails 2342 extend is not limited thereto, and may be a direction that allows the storage part 2341 to move without interference with the seat body 2320.

Since an occupant can move or rotate the seat body 2320 to a desired position such that the seat body 2320 does not interfere with the other members (the door, the storage part, and the like) as described above, it is possible to arrange the seat bodies 2320 in various ways.

The partition 2350 is a panel for partitioning off private spaces for occupants, and is provided on the vehicle body-outer wall part 2310. The partition 2350 extends in the front to rear direction, and divides the passenger compartment into a right area and a left area.

Meanwhile, the partition 2350 may be detachably mounted on the vehicle body-outer wall part 2310 or the vehicle body floor 2315. In addition, the partition 2350 may be provided to be switchable between a use position and a storage position.

Further, the partition 2350 may be provided with blow-out ports that are used to send air from a blower device (not shown) to occupants. In this case, a plurality of blow-out ports may be provided at different heights.

Since an occupant can move the seat body 2320 to a desired position while ensuring private spaces, it is possible to arrange the seat bodies 2320 in various ways.

A modification example of the vehicle V24 will be described below.

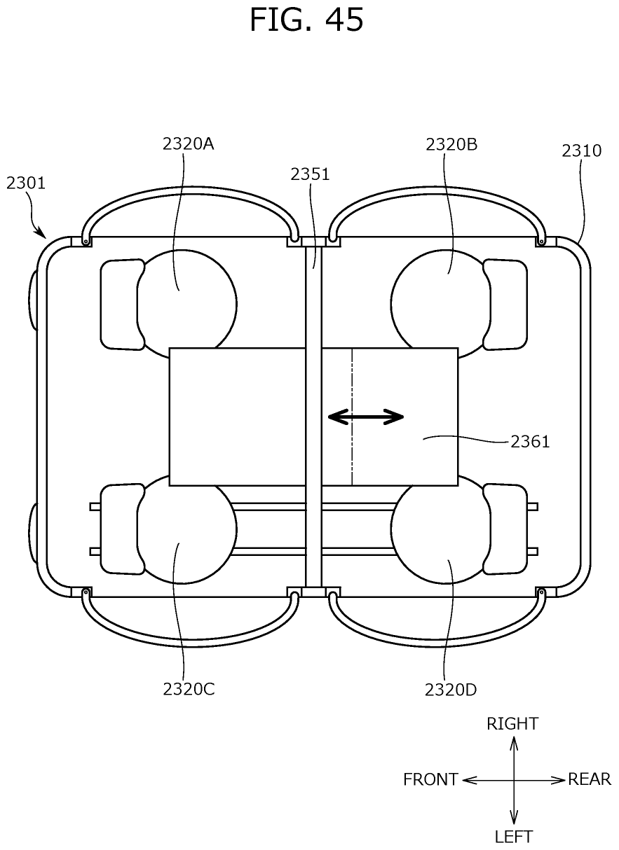

A first modification example shown in FIG. 45 is mainly different from FIG. 44 in terms of the configuration of a right-left partition part 2351.

The right-left partition part 2351 is a panel for partitioning off private spaces for occupants, and is provided on the vehicle body-outer wall part 2310. The right-left partition part 2351 extends in the vehicle width direction, and divides the passenger compartment into a front area and a rear area.

The right-left partition part 2351 includes rotary desks 2361 that are used as desks by occupants seated in the respective seat bodies 2320.

The rotary desk 2361 is provided to be switchable between a use position (a solid line in FIG. 45) at which occupants use the rotary desk as a desk and a storage position (a dotted line in FIG. 45).

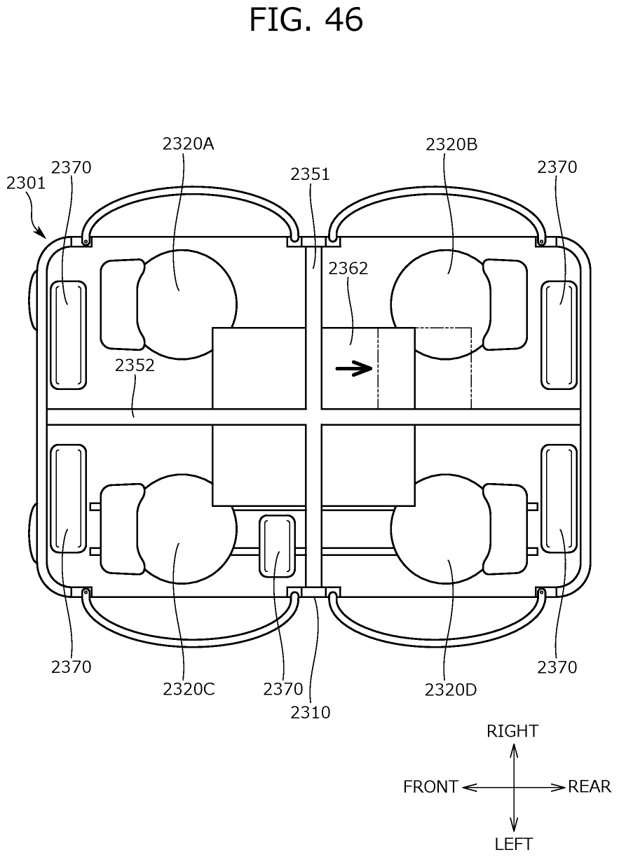

A second modification example shown in FIG. 46 is mainly different from FIG. 44 in terms of the configuration of a right-left partition part 2351, a front-rear partition part 2352, and fixed storage parts 2370.

The right-left partition part 2351 and the front-rear partition part 2352 are panels for partitioning off private spaces for occupants, and are provided on the vehicle body-outer wall part 2310. The right-left partition part 2351 extends in the vehicle width direction, and divides the passenger compartment into a front area and a rear area. The front-rear partition part 2352 extends in the front to rear direction, and divides the passenger compartment into a right area and a left area.

The right-left partition part 2351 and the front-rear partition part 2352 include sliding desks 2362 that are used as desks by occupants seated in the respective seat bodies 2320.

The sliding desk 2362 is provided to be switchable between a position (a solid line in FIG. 46) far from an occupant seated on the seat body 2320 and a position (a dotted line in FIG. 46) close to a seated occupant.

Accordingly, an occupant can move the sliding desk 2362 to a desired position to use the sliding desk 2362.

The vehicle seat 2302 includes the fixed storage part 2370 that is used for an occupant to store baggage.

As shown in FIG. 46, the fixed storage part 2370 is provided at a position near each seat body 2320. The fixed storage part 2370 is detachably mounted on the vehicle body-outer wall part 2310 or the vehicle body floor 2315.

Accordingly, an occupant can mount the fixed storage part 2370 at a desired position to use the fixed storage part 2370.

### Twenty-Fifth Embodiment

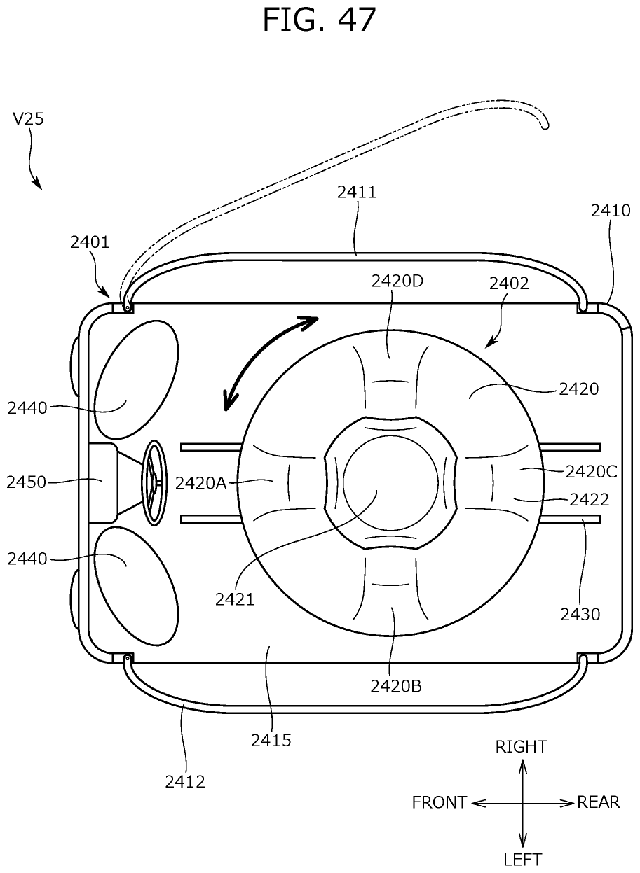

Next, a vehicle V25 according to a twenty-fifth embodiment will be described with reference to FIG. 47.

Meanwhile, the repeated description of the same contents as the vehicles V1 to V24 described above will be omitted.

As shown in FIG. 47, a vehicle body 2401 includes a vehicle body-outer wall part 2410 that is disposed to surround a vehicle seat 2402 and a vehicle body floor 2415 on which the vehicle seat 2402 is disposed.

The vehicle body-outer wall part 2410 includes a right curved door 2411 and a left curved door 2412 as doors that allow occupants to get in and off the vehicle.

As shown in FIG. 47, each door is a curved door that bulges outward in the vehicle width direction and has a curved shape.

As shown in FIG. 47, the vehicle seat 2402 includes a seat body 2420, a rail device 2430 that supports the seat body 2420 to allow the seat body 2420 to move forward and rearward with respect to the vehicle body floor 2415, and storage parts 2440 that store occupant's baggage.

The seat body 2420 is a seat having a substantially circular shape in a top view, and includes a seat back 2421 that is provided at a center of the seat body 2420 and a doughnut-shaped seat cushion 2422 that is provided at a peripheral edge portion of the seat back 2421.

The seat back 2421 is a backrest part that supports the backs of seated occupants. The seat cushion 2422 is a seat part that supports seated occupants from below.

For example, four occupants can be seated on the seat body 2420, and the seat body 2420 includes a first seat body 2420A, a second seat body 2420B, a third seat body 2420C, and a fourth seat body 2420D. Concave portions are formed on the seat cushion 2422 at positions corresponding to the first to fourth seat bodies 2420A to 2420D so that occupants are easily seated. The number of persons who can be seated on the seat body 2420 is not limited to four.

The seat body 2420 is mounted to be rotatable with respect to the vehicle body floor 2415 about an axis parallel to the up to down direction. Each of the first to fourth seat bodies 2420A to 2420D is rotated to a driving position facing a steering wheel 2450. Each of the first to fourth seat bodies 2420A to 2420D is locked not to rotationally move to the driving position facing the steering wheel 2450. Since a position (driver seat) on the seat body 2420 facing the steering wheel 2450 can be rotated as described above, an occupant who drives the vehicle can be easily replaced.

Meanwhile, a driving-prohibited seat may be provided at a part of the seat body 2420 to prohibit an occupant not having a driver's license from driving the vehicle.

For example, in a case where the first seat body 2420A and the second seat body 2420B are set as driving-allowable seats and the third seat body 2420C and the fourth seat body 2420D are set as driving-prohibited seats in FIG. 47, each of the first seat body 2420A and the second seat body 2420B is rotated to be lockable at the driving position facing the steering wheel 2450. Further, each of the third seat body 2420C and the fourth seat body 2420D is rotated not to be lockable at the driving position facing the steering wheel 2450.

Since the driving-prohibited seat is not locked at the driving position facing the steering wheel 2450 as described above, an occupant seated in the driving-prohibited seat is prohibited from driving the vehicle. Accordingly, an occupant not having a driver's license can also be seated on the seat body 2420 together.

As shown in FIG. 47, the rail device 2430 moves the seat body 2420 in the front to rear direction as a rail operation lever is operated by an occupant.

Since the seat body 2420 is moved forward as an occupant operates the rail operation lever, the seat body 2420 serving as a driver seat can be moved to a position close to the steering wheel 2450.

Meanwhile, only a part (for example, the first seat body 2420A) of the seat body 2420 may be adapted to be separated from the seat body 2420 and to be moved to a position close to the steering wheel 2450.

### Twenty-Sixth Embodiment

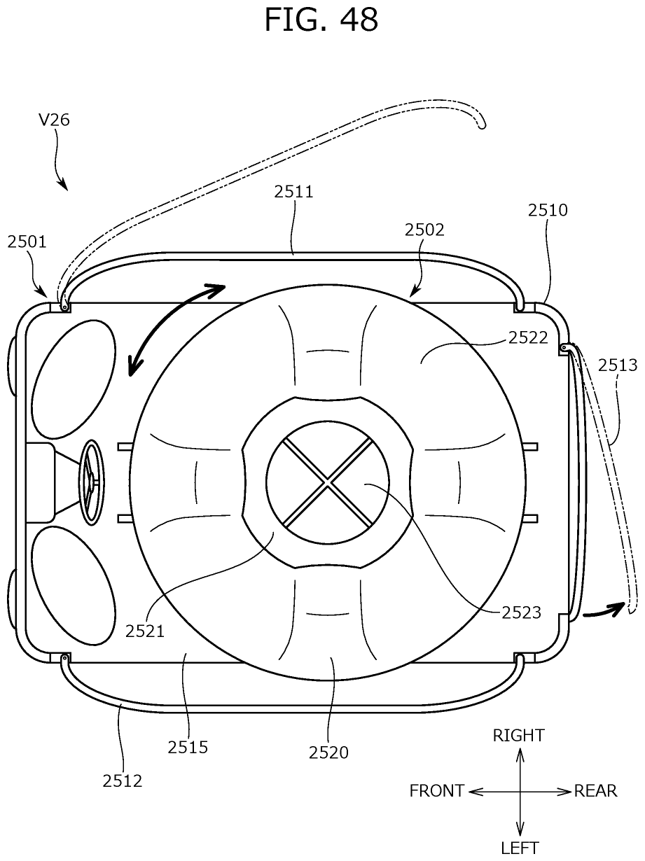

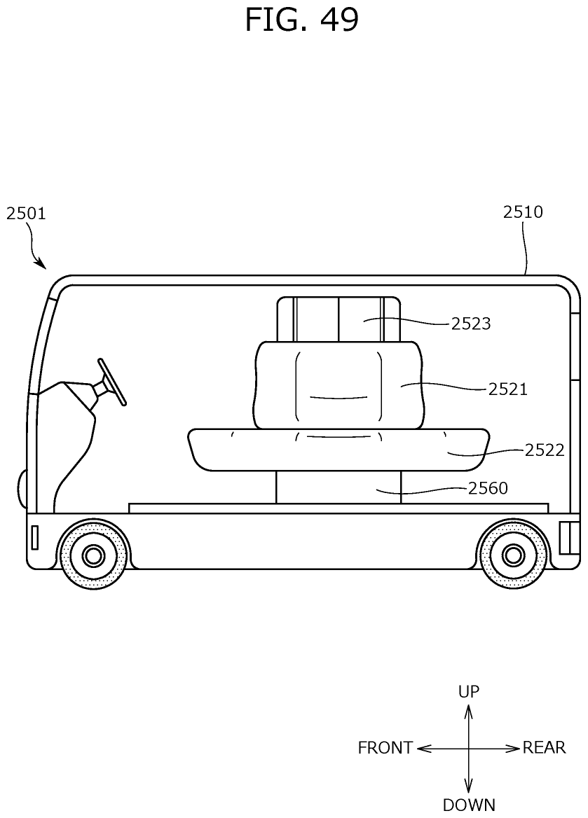

Next, a vehicle V26 according to a twenty-sixth embodiment will be described with reference to FIGS. 48 and 49.

Meanwhile, the repeated description of the same contents as the vehicles V1 to V25 described above will be omitted.

The vehicle V26 according to the twenty-sixth embodiment is mainly different from the vehicles V1 to V25 in terms of the configuration of a seat body 2520 and a rear curved door 2513.

As shown in FIGS. 48 and 49, a vehicle body 2501 includes a vehicle body-outer wall part 2510 that is disposed to surround a vehicle seat 2502 and a vehicle body floor 2515 on which the vehicle seat 2502 is disposed.

The vehicle body-outer wall part 2510 includes a right curved door 2511, a left curved door 2512, and a rear curved door 2513 as doors that allow occupants to get in and off the vehicle.

As shown in FIG. 48, the rear curved door 2513 is a curved door that bulges rearward in the front to rear direction and has a curved shape.

As shown in FIGS. 48 and 49, the vehicle seat 2502 includes a seat body 2520 and a rotating device 2560 that allows the seat body 2520 to be mounted and to rotate with respect to a vehicle body floor 2515 about an axis parallel to the up to down direction.

The seat body 2520 is a seat having a substantially circular shape in a top view, and includes a seat back 2521 that is provided at a center of the seat body 2520, a doughnut-shaped seat cushion 2522 that is provided at a peripheral edge portion of the seat back 2521, and a seat storage part 2523 that is provided at an upper portion of the seat back 2521.

The seat back 2521 is a backrest part that supports the backs of seated occupants. The seat cushion 2522 is a seat part that supports seated occupants from below. The seat storage part 2523 is a storage part that stores occupant's baggage.

As shown in FIG. 48, the seat cushion 2522 is disposed at a position at which a peripheral edge portion of the seat cushion 2522 enters curved concave portions of the right curved door 2511 and the left curved door 2512. Since each door is formed of a curved door, the size of the seat cushion 2522 can be increased as much as possible.

### Twenty-Seventh Embodiment

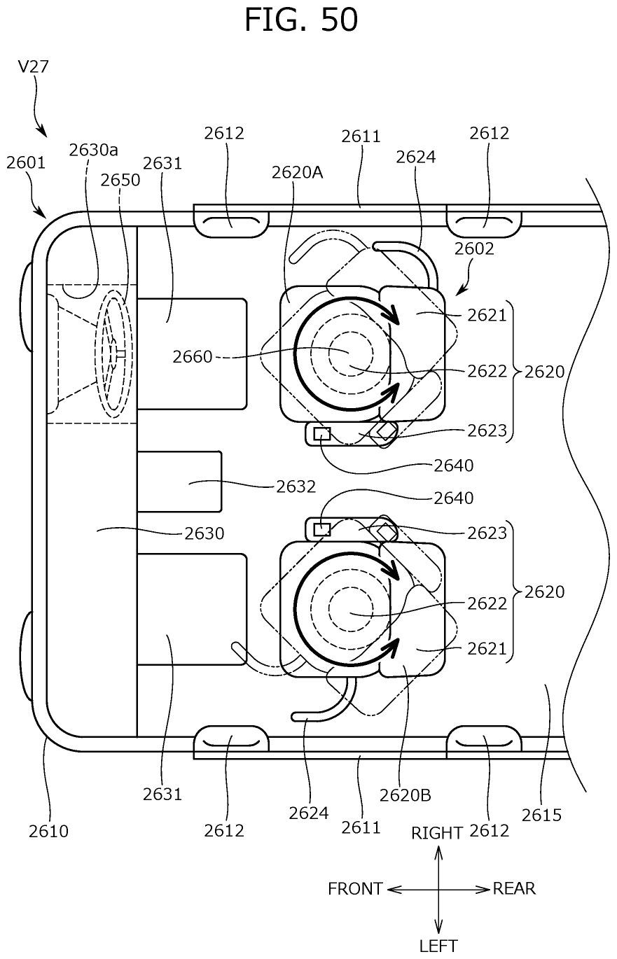

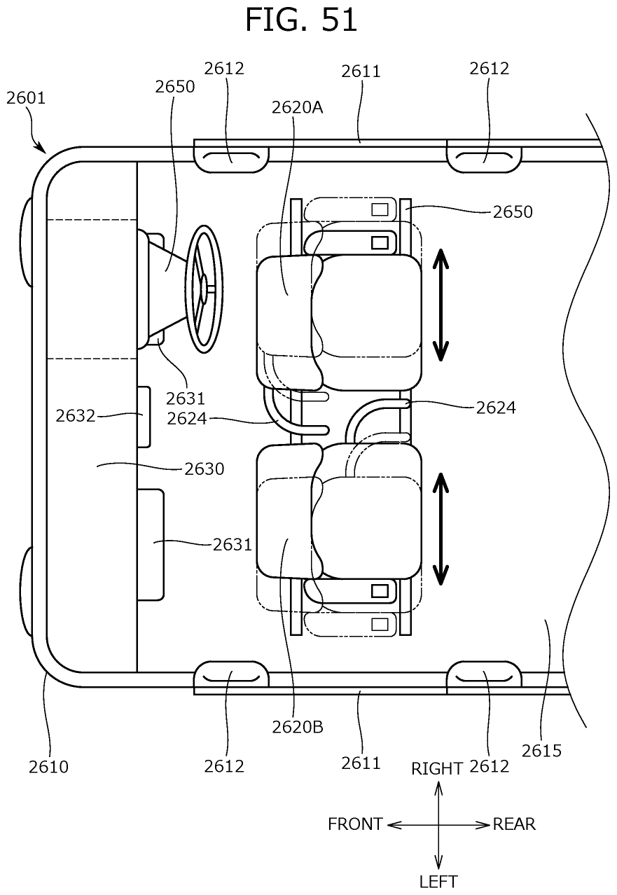

Next, a vehicle V27 according to a twenty-seventh embodiment will be described with reference to FIGS. 50 and 51.

Meanwhile, the repeated description of the same contents as the vehicles V1 to V26 described above will be omitted.

As shown in FIGS. 50 and 51, a vehicle body 2601 includes a vehicle body-outer wall part 2610 that is disposed to surround vehicle seats 2602, a vehicle body floor 2615 on which the vehicle seats 2602 are arranged, an instrument panel part 2630, operation buttons 2640 that are mounted on the vehicle seats 2602, a steering wheel 2650, a rail device 2660, and rotating devices 2670.

The vehicle body-outer wall part 2610 includes door parts 2611 as doors that allow occupants to get in and off the vehicle, and door pockets 2612 that are provided on passenger compartment sides of the door parts 2611.

The door pocket 2612 is provided on the door part 2611 in a state where the door pocket 2612 is divided into front and rear parts.

The instrument panel part 2630 includes footrests 2631 that support feet of occupants seated on seat bodies 2620 from below, and a table 2632 that serves as a desk for occupants.

The footrest 2631 is mounted on the instrument panel part 2630 to be rotationally movable, and is rotationally moved to be switchable between a use position (FIG. 50) at which the footrest 2631 can support feet of an occupant and a storage position (FIG. 51) at which the footrest 2631 is stored on the side surface of the instrument panel part 2630.

As the operation button 2640 is pressed by an occupant, a footrest drive motor (not shown) is operated and the footrest 2631 is rotationally moved between the use position and the storage position.

When the footrest 2631 is in the use position, the footrest 2631 is disposed at a position higher than an occupant's chest (the position of the heart).

Meanwhile, a rearview mirror provided on a ceiling surface of the vehicle body-outer wall part 2610 facing a passenger compartment may be adapted to move up and down or to move in the right to left direction to avoid interference with the footrest 2631 when the footrest 2631 is in the use position.

Alternatively, the rearview mirror may be integrated with a windshield to avoid interference with the footrest 2631.

Meanwhile, the footrests 2631 may be adapted to move up and down or may be adapted to move in the right to left direction, instead of being adapted to rotationally move. In a case where the footrest 2631 is freely driven, the position of the footrest 2631 can be adjusted according to occupant's preference. Further, an occupant can perform exercises using the footrest 2631 by changing the disposition of the footrest 2631.

The table 2632 is mounted on the instrument panel part 2630 to be rotationally movable, and is rotationally moved to be switchable between a use position (FIG. 50) at which an occupant can use the table 2632 and a storage position (FIG. 51) at which the table 2632 is stored on the side surface of the instrument panel part 2630.

As the operation button 2640 is pressed by an occupant, a table drive motor (not shown) is operated and the table 2632 is rotationally moved between the use position and the storage position.

The operation button 2640 is a button to be pressed by an occupant, and is provided on the seat body 2620 of the vehicle seat 2602. Specifically, the operation button 2640 is mounted on a tip portion of an armrest 2623 provided on the seat body 2620.

Meanwhile, the position of the operation button 2640 is no limited to the tip portion of the armrest 2623, and the operation button 2640 may be provided separately from the vehicle body 2601 or the vehicle seat 2602 like a remote controller.

In this case, the remote controller may be stored in the door pocket 2612 of the door part 2611. Further, a pocket for storing the remote controller may be provided on the instrument panel part 2630 or on a partition that partitions off private spaces for occupants.

The steering wheel 2650 is a driving steering wheel to be operated by an occupant who drives the vehicle, and is provided on the instrument panel part 2630.

The steering wheel 2650 is provided to be switchable between a use position (FIG. 51) at which an occupant can drive the vehicle and a storage position (FIG. 50) at which the steering wheel 2650 is stored in a storage recess 2630a formed in the instrument panel part 2630.

In a case where the steering wheel 2650 is unnecessary due to autonomous driving, an occupant can store the steering wheel 2650 at the storage position. Accordingly, when the seat bodies 2620, the footrests 2631, or the table 2632 is moved, interference between the steering wheel 2650 and the seat bodies 2620, the footrests 2631, or the table 2632 can be suppressed.

Meanwhile, a position in which the steering wheel 2650 is stored is not limited to a position formed in the instrument panel part 2630. For example, the steering wheel 2650 may be moved up and down not to interfere with the seat bodies 2620, the footrests 2631, or the table 2632.

Further, when the steering wheel 2650 is in the storage position, the deployment of an airbag may be limited (the volume of the airbag to be deployed may be reduced or the deployment of the airbag may be prohibited).

Airbags are provided in the ceiling surface of the vehicle body-outer wall part 2610, which faces the passenger compartment, and the seat body 2620 and are deployed between an occupant and the windshield. In a case where the footrest 2631 is in the use position, the airbag provided in the ceiling surface is deployed. In a case where the footrest 2631 is in the storage position, the airbag provided in the seat body 2620 is deployed.

As shown in FIGS. 50 and 51, the vehicle seat 2602 includes a seat body 2620 that includes a seat back 2621 and a seat cushion 2622, an armrest 2623 that is mounted to be rotationally movable with respect to the seat back 2621, and a seat lever 2624 that is mounted on the seat cushion 2622.

The vehicle V27 includes a plurality of seat bodies 2620. Specifically, the vehicle V27 includes a right front seat body 2620A and a left front seat body 2620B disposed on the left side of the right front seat body 2620A, on the vehicle body floor 2615.

The rail device 2660 is disposed between the seat body 2620 and the vehicle body floor 2615 in the up to down direction, and allows the seat body 2620 to move with respect to the vehicle body floor 2615 in the right to left direction.

An occupant can manually move a rail operation lever to adjust the position of the seat body 2620. Meanwhile, a drive motor provided in the rail device 2660 may be operated by a button pressing operation for the operation button 2640 to adjust the position of the seat body 2620 to a desired position.

The rotating device 2670 is mounted below the seat body 2620 and allows the seat body 2620 to rotatably move with respect to the vehicle body floor 2615.

An occupant can manually move the seat lever 2624 to adjust the orientation of the seat body 2620. Meanwhile, a drive motor provided in the rotating device 2670 may be operated by a button pressing operation for the operation button 2640 to adjust the orientation of the seat body 2620 to a desired position.

When the seat bodies 2620 are to be moved inward in the right to left direction, the rail device 2660 moves the seat bodies 2620 to positions where the seat bodies 2620 are close to each other. In this case, the seat levers 2624 provided on the seat bodies 2620 are arranged at positions where the seat levers 2624 do not interfere with each other.

For example, when the seat bodies 2620 are to be moved to positions where the seat bodies 2620 are close to each other, the seat lever 2624 of the right front seat body 2620A may be stored in a concave portion formed in the seat cushion 2622 of the left front seat body 2620B and the seat lever 2624 of the left front seat body 2620B may be stored in a concave portion formed in the seat cushion 2622 of the right front seat body 2620A. Accordingly, even though the seat levers 2624 are disposed at positions where the seat levers 2624 protrude from the seat bodies 2620, the seat bodies 2620 can be moved to positions where the seat bodies 2620 are in contact with each other.

Further, when the seat bodies 2620 are to be moved outward in the right to left direction, the rail device 2660 may move the seat bodies 2620 to positions where the seat bodies 2620 are in close contact with the door parts 2611. When the door parts 2611 and the seat bodies 2620 are in close contact with each other, air-conditioning performance in an interior space of the vehicle body 2601 can be improved.

Further, since a gap is formed between the front and rear door pockets 2612, interference between the seat body 2620 and the door pockets 2612 can be suppressed when the seat body 2620 is rotated.

Furthermore, concave portions for avoiding interference may be formed on pillars of the vehicle body-outer wall part 2610 so that interference between the seat body 2620 and the pillars is avoided when the seat bodies 2620 are rotated.

### Twenty-Eighth Embodiment

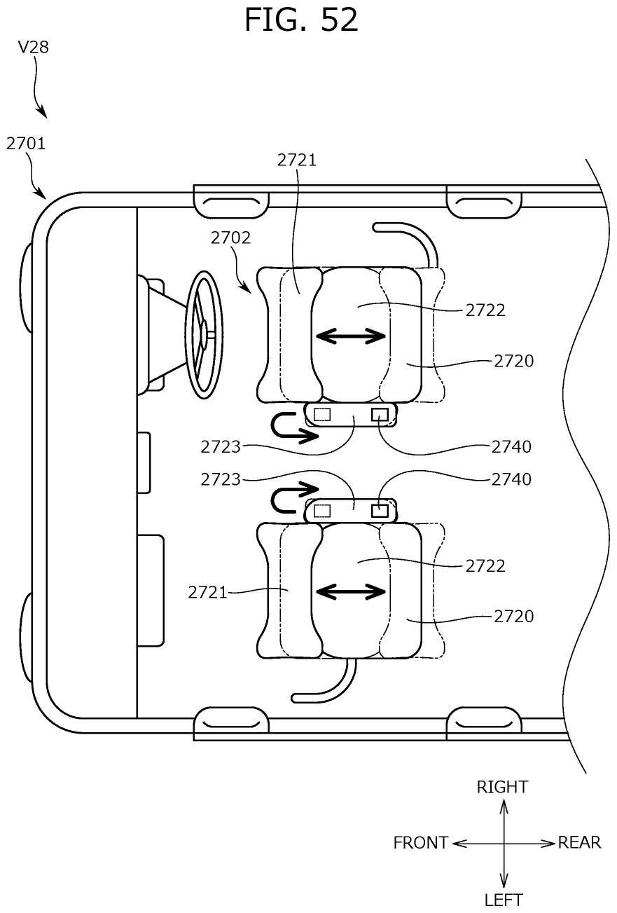

Next, a vehicle V28 according to a twenty-eighth embodiment will be described with reference to FIG. 52.

Meanwhile, the repeated description of the same contents as the vehicles V1 to V27 described above will be omitted.

A vehicle seat 2702 is a convertible cross seat. As shown in FIG. 52, the vehicle seat 2702 includes a seat body 2720 that includes a seat back 2721 and a seat cushion 2722, an armrest 2723 that is mounted to be rotationally movable with respect to the seat back 2721, and a conversion device (not shown) that allows the seat back 2721 to be mounted and to move forward and rearward with respect to the seat cushion 2722.

The conversion device moves the seat back 2721 with respect to the seat cushion 2722 to switch the seat back 2721 from a forward position (a solid line in FIG. 52) to a rearward position (a dotted line in FIG. 52) such that the orientation of the seat body 2720 is converted by an angle of 180 degrees in the front to rear direction of a vehicle body 2701.

An occupant can manually move the seat back 2721 to convert the orientation of the seat body 2720 in the front to rear direction. Meanwhile, a drive motor provided in the conversion device may be operated by a button pressing operation for an operation button 2740 to change the orientation of the seat body 2720.

When the seat back 2721 is switched from the forward position to the rearward position by the conversion device, the armrest 2723 is rotated with respect to the seat back 2721 to correspond to the position of an occupant's arm.

At this time, the positions of upper and lower surfaces of the armrest 2723 are reversed. For this reason, the operation button 2740 may be provided on both the upper and lower surfaces of the armrest 2723.

Meanwhile, the operation button 2740 may be provided on a tip face of the armrest 2723 so that the operation button 2740 can be operated even in a case where the positions of the upper and lower surfaces of the armrest 2723 are reversed.

Further, the armrest 2723 may slide in the front to rear direction such that the position of the armrest 2723 is switched.

Cases where the vehicle is an automobile have been described as specific examples in the above-mentioned embodiments. However, the present invention is not particularly limited, and can be used for an airplane, a ship, and the like in addition to an electric train, a bus, and the like.

The vehicles according to the present invention have been mainly described in the above-mentioned embodiments.

However, the above-mentioned embodiments are merely examples for easy understanding of the present invention, and do not limit the present invention. The present invention may be modified and improved without departing from the scope of the present invention, and it goes without saying that the present invention includes equivalents thereof.

### REFERENCE SIGNS LIST

### First Embodiment

V1: vehicle
1: vehicle body
2: vehicle seat
3: battery
10: vehicle body-outer wall part
11: vehicle body-bottom wall portion
12: vehicle body-upper wall portion
12a: opening
13A: vehicle body-front wall portion
13B: vehicle body-rear wall portion
14: vehicle body-side wall portion
15: vehicle body floor
16: sunroof
16a: front end portion (one end portion)
16b: rear end portion (the other end portion)
17: sunroof drive mechanism
18: windshield
19: tailgate
19a: rear glass
20: seat body
21: seat back
22: seat cushion
23: headrest
30: lifting device (moving device)
31: link mechanism
32: lifting operation part (operation part)
40: rotating device
41: rotating operation member
50: rail device
51: lower rail
52: upper rail
60: reclining device
P1: closed position
P2: open position
P3: reference position
P4: upper position

### Second Embodiment

V2: vehicle
101: vehicle body
103: battery
110: vehicle body-outer wall part
112: vehicle body-upper wall portion
112a: opening
115: vehicle body floor
116: sunroof
116a: front end portion
116b: rear end portion
117: sunroof drive mechanism
120: seat body
120A: front seat body (first seat body)
120B: rear seat body (second seat body)
123A: front headrest
123B: rear headrest
130: lifting device (moving device)
132: lifting operation part (operation part)
140: rotating device
150: rail device
P1: closed position
P2: open position
P3: reference position
P4a, P4b: upper position

### Third Embodiment

V3: vehicle
201: vehicle body
203: battery
210: vehicle body-outer wall part
212: vehicle body-upper wall portion
212a: opening
215: vehicle body floor
216A: front sunroof (first sunroof)
216Aa: front end portion
216Ab: rear end portion
216B: rear sunroof (second sunroof)
216Ba: front end portion
216Bb: rear end portion
217: sunroof drive mechanism
220: seat body
220A: front seat body
220B: rear seat body
223A: front headrest
223B: rear headrest
230: lifting device (moving device)
232: lifting operation part (operation part)
240: rotating device
250: rail device
P1: closed position
P2a, P2b: open position
P3: reference position
P4a, P4b: upper position

### Fourth Embodiment

V4: vehicle
301: vehicle body
303: battery
310: vehicle body-outer wall part
312: vehicle body-upper wall portion
312a: opening
315: vehicle body floor
316: sunroof
316a: front end portion
316b: rear end portion
317: sunroof drive mechanism
320: seat body
320A: front seat body
320B: rear seat body
323A: front headrest
323B: rear headrest
330: lifting device (moving device)
332: lifting operation part (operation part)
340: rotating device
350: rail device
P1: closed position
P2: open position
P3: reference position
P4: upper position

### Fifth Embodiment

V5: vehicle
401: vehicle body
402: vehicle seat
403: battery
410: vehicle body-outer wall part
411: right front sliding door
412: right rear sliding door
413: left front sliding door
414: left rear sliding door
415: vehicle body floor
420: seat body
420a: seat end portion
421: seat back
422: seat cushion
430: lifting device
440: rotating device
450: rail device (moving device)
450a: lower rail
450b: upper rail
460: reclining device
470: awning device
471: front awning part
472: rear awning part
P1: closed position
P2: open position
P3: reference position
P4: side position

### Sixth Embodiment

V6: vehicle
501: vehicle body
502: vehicle seat
503: battery
510: vehicle body-outer wall part
511: right front sliding door
512: right rear sliding door
513: left front sliding door
514: left rear sliding door
515: vehicle body floor
516: sunroof
520: seat body
520A: right front seat body
520B: right rear seat body
520C: left front seat body
520D: left rear seat body
521: seat back
522: seat cushion
523: headrest
523a: headrest cover
524: footrest
530: lifting device (moving device)
532: lifting operation part (operation part)
540: rotating device
550: rail device (moving device)
550a: lower rail
550b: first upper rail
550c: second upper rail
560: reclining device
570: awning device
P1, P5: closed position
P2, P6: open position
P3a, P3b, P7: reference position
P4a, P4b: side position
P8: upper position

### Seventh Embodiment

V7: vehicle
601: vehicle body
603: battery
610: vehicle body-outer wall part
611: right front sliding door
612: right rear sliding door
613: left front sliding door
614: left rear sliding door
615: vehicle body floor
616: sunroof
616A: right front sunroof
616B: right rear sunroof
616C: left front sunroof
616D: left rear sunroof
620: seat body
620A: right front seat body
620B: right rear seat body
620C: left front seat body
620D: left rear seat body
620e: small object storage part
620f: drink storage part
621: seat back
622: seat cushion
623: headrest
624: footrest
630: lifting device (moving device)
640: rotating device
650: rail device (moving device)
650a: lower rail
650b: first upper rail
650c: second upper rail
650d: first sub-rail
650e: second sub-rail
660: reclining device
670: windshield
680: rear glass
P1, P5: closed position
P2, P6: open position
P3, P7: reference position
P4: side position
P8: upper position

### Eighth Embodiment

V8: vehicle
701: vehicle body
703: battery
710: vehicle body-outer wall part
716: sunroof
716a: movable end portion
716b: fixed end portion
720: seat body
720A: right front seat body
720C: left front seat body
721: seat back
722: seat cushion
723: headrest
730: lifting device
732: lifting operation part (operation part)
740: rotating device
750: rail device
750a: lower rail
750b: first upper rail
750c: second upper rail
760: reclining device
770: massage device
P1: closed position
P2: open position
P3: reference position
P4: upper position

### Ninth Embodiment

V9: vehicle
801: vehicle body
803: battery
810: vehicle body-outer wall part
815: vehicle body floor
816: sunroof
817: sunroof drive mechanism
818: windshield
819: tailgate
819a: rear glass part
819b: gate part
819c: awning part
820: seat body
820A: right front seat body
820B: right rear seat body
820C: left front seat body
820D: left rear seat body
820E: first auxiliary seat
820F: second auxiliary seat
820G: third auxiliary seat
820H: U-shaped seat
830: lifting device (moving device)
840: rotating device
850: rail device (moving device)
850a: lower rail
850b: upper rail
850c: sub-rail
850d: U-shaped rail
860: reclining device
870: steering wheel
871: partition
P1, P5: closed position
P2, P6: open position
P3, P7: reference position
P4: upper position
P8: rear position

### Tenth Embodiment

V10: vehicle
901: vehicle body
903: battery
910: vehicle body-outer wall part
912: vehicle body-upper wall portion
913: vehicle body-front wall portion
915: vehicle body floor
918: front part
918a: front portion
918b: rear portion
919: tailgate
920: seat body
920A: front seat body
920B: middle seat body
920C: rear seat body
923: headrest
930: lifting device
932: lifting operation part
940: rotating device
950: rail device
960: reclining device
H1, H2, H3: sight line-height-position

### Eleventh Embodiment

V11: vehicle
1001: vehicle body
1003: battery
1010: vehicle body-outer wall part
1012: vehicle body-upper wall portion
1012a: upper wall-rear end portion
1015: vehicle body floor
1016: sunroof
1018: front part
1019: tailgate
1020: seat body
1020A: front seat body
1020B: middle seat body
1020C: rear seat body
1021: seat back
1022: seat cushion
1023: headrest
1024: support part
1024a: first support part
1024b: second support part
1025: seat band
1030: lifting device
1032: lifting operation part
1040: rotating device
1050: rail device
1060: reclining device
1070: exercise device
1071: seat handle
1072: roof handle

### Twelfth Embodiment

V12: vehicle
1101: vehicle body
1103: battery
1110: vehicle body-outer wall part
1112: vehicle body-upper wall portion
1115: vehicle body floor
1119: tailgate
1120: seat body
1120A: front seat body
1120B: middle seat body
1120C: rear seat body
1121: seat back
1122: seat cushion
1123: headrest
1124: support part
1125: seat band
1130: lifting device
1140: rotating device
1150: rail device
1160: reclining device
1180: illumination device
1180a: illumination mounting portion

### Thirteenth Embodiment

V13: vehicle
1201: vehicle body
1203: battery
1210: vehicle body-outer wall part
1212: vehicle body-upper wall portion
1212a: upper wall-front portion
1212b: upper wall-middle portion
1212c: upper wall-rear portion
1213: vehicle body-front wall portion
1215: vehicle body floor
1218: front part
1218a: front portion
1218b: rear portion
1219: tailgate
1220: seat body
1220a: front seat body
1220b: middle seat body
1220c: rear seat body
1221: seat back
1222: seat cushion
1230: lifting device
1232: lifting operation part
1240: rotating device
1250: rail device
1260: reclining device
1270: exercise device
1271: roof handle

### Fourteenth Embodiment

V14: vehicle
1301: vehicle seat
1302: seat back
1303: seat cushion
1304: rotating device
1305: cushion-rotational movement device

### Fifteenth Embodiment

V15: vehicle
1401: vehicle seat
1402: seat back
1402a: middle support portion
1402b: side support portion
1403: seat cushion
1403a: middle support portion
1403b: side support portion
1404: headrest
1404a: headrest pillar
1405: armrest
1406: armrest ventilation channel
1410: operation device
1411: mat part
1411a: first mat portion
1411b: second mat part
1411c: third mat part
1411d: fourth mat part
1411e: fifth mat part
1411f: mat bending portion
1412: mat holding part
1413: sensor part
1420: blower device
1421: first blow-out port
1422: second blow-out port
1423: third blow-out port
1424: fourth blow-out port
1430: heating device
1440: airbag module
1450: door panel
1451: door panel ventilation channel
1460: control device

### Sixteenth Embodiment

V16: vehicle
1501: vehicle seat
1502: seat back
1503: seat cushion
1504: headrest
1505: armrest
1506: armrest ventilation channel
1510: sensor part
1520: blower device
1521: seat-side blow-out port
1522: door-side blow-out port
1530: door panel
1531: door armrest
1532: movable arm part
1533: movable arm ventilation channel
1540: control device

### Seventeenth Embodiment

V17: vehicle
1601: vehicle seat
1602: instrument panel part
1603: first pillar portion
1604: second pillar portion
1605: ceiling portion
1606: console box
1610: sterilization device
1611: chemical storage part
1620: blower device
1621: instrument panel blow-out port
1622: console box blow-out port
1623: first slit blow-out port
1624: second slit blow-out port

### Eighteenth Embodiment

V18: vehicle
1701: vehicle seat
1702: seat back
1703: seat cushion
1704: headrest
1710: sterilization device

### Nineteenth Embodiment

V19: vehicle
1801: vehicle body
1802: vehicle seat
1810: vehicle body-outer wall part
1810a: charging unit
1810b: state detection sensor
1810c: upper detection sensor
1811: door part
1812: front tire
1813: rear tire
1814: tire link part
1820: seat body
1821: seat drive device
1822: seat transformation device
1830: display device
1840: storage device
1841: storage part
1842: storage rotating part
1843: storage link part
1850: control device

### Twentieth Embodiment

V20: vehicle
1901: vehicle body
1902: vehicle seat
1910: vehicle body-outer wall part
1910a: front vehicle body part
1910b: rear vehicle body part
1910c: detection sensor
1911: door part
1912: front tire
1913: rear tire
1914: tire link part
1920: seat body
1930: display device
1940: storage device
1941: storage part

### Twenty-First Embodiment

V21: vehicle
2001: vehicle body
2002: vehicle seat
2010: vehicle body-outer wall part
2011: door part
2011a: upper detection sensor
2012: front tire
2013: rear tire
2014: door drive unit
2020: seat body
2021: seat drive device
2022: seat transformation device
2030: display device
2040: storage device
2050: control device

### Twenty-Second Embodiment

V22: vehicle
2101: vehicle body
2102: vehicle seat
2103: battery
2104: heat sink
2110: vehicle body-outer wall part
2111: vehicle body-bottom wall portion
2112: vehicle body-upper wall portion
2113: vehicle body-front wall portion
2114: vehicle body-rear wall portion
2115: vehicle body floor
2116: vehicle body-side wall portion
2120: seat body
2121: seat back
2122: seat cushion
2122a: cushion ventilation channel
2130: seat-air conditioner
2131: first blower body
2132: second blower body
2133: blower passage
2133a: lid
2134: cabin-connecting passage

### Twenty-Third Embodiment

V23: vehicle
2201: vehicle seat
2202: seat back
2203: seat cushion
2204: headrest
2210: heating/cooling device
2220: console box
2230: door panel
2231: door armrest
2240: control device

### Twenty-Fourth Embodiment

V24: vehicle
2301: vehicle body
2302: vehicle seat
2310: vehicle body-outer wall part
2311: right front curved door
2312: right rear curved door
2313: left front curved door
2314: left rear curved door
2315: vehicle body floor
2320: seat body
2320A: right front seat body
2320B: right rear seat body
2320C: left front seat body
2320D: left rear seat body
2330: rail device
2331: right-left rails
2332: front-rear rails
2340: movable storage unit
2341: storage part
2342: storage part rails
2350: partition
2351: right-left partition part
2352: front-rear partition part
2361: rotary desk
2362: sliding desk
2370: fixed storage part

### Twenty-Fifth Embodiment

V25: vehicle
2401: vehicle body
2402: vehicle seat
2410: vehicle body-outer wall part
2411: right curved door
2412: left curved door
2415: vehicle body floor
2420: seat body
2420A: first seat body
2420B: second seat body
2420C: third seat body
2420D: fourth seat body
2421: seat back
2422: seat cushion
2430: rail device
2440: storage part
2450: steering wheel part

### Twenty-Sixth Embodiment

V26: vehicle
2501: vehicle body
2502: vehicle seat
2510: vehicle body-outer wall part
2511: right curved door
2512: left curved door
2513: rear curved door
2515: vehicle body floor
2520: seat body
2521: seat back
2522: seat cushion
2523: seat storage part
2540: storage part
2550: steering wheel part
2560: rotating device

### Twenty-Seventh Embodiment

V27: vehicle
2601: vehicle body
2602: vehicle seat
2610: vehicle body-outer wall part
2611: door part
2612: door pocket
2615: vehicle body floor
2620: seat body
2620A: right front seat
2620B: left front seat
2621: seat back
2622: seat cushion
2623: armrest
2624: seat lever
2630: instrument panel part
2631: footrest
2632: table
2640: operation button
2650: steering wheel
2660: rail device
2670: rotating device

### Twenty-Eighth Embodiment

V28: vehicle
2701: vehicle body
2702: vehicle seat
2720: seat body
2721: movable seat back
2722: seat cushion
2723: armrest
2740: operation button

1. A vehicle, comprising:
a vehicle body; and
vehicle seats that are arranged in an interior space of the vehicle body,
wherein the vehicle body includes a vehicle body floor on which the vehicle seats are arranged and a vehicle body-outer wall part that is disposed to surround the vehicle seats,
the vehicle seat includes a seat body on which an occupant is seated, and a moving device that allows the seat body to be mounted and to move with respect to the vehicle body floor,
at least a part of the vehicle body-outer wall part is provided to be switchable between a closed position at which an interior space of the vehicle body is closed and an open position at which the interior space of the vehicle body is opened,
the moving device includes an operation part to be operated by the occupant and moves the seat body between a reference position and an upper position moved upward from the reference position as the operation part is operated, and
at least a part of the seat body is disposed above at least the part of the vehicle body-outer wall part having been in the closed position when at least the part of the vehicle body-outer wall part is in the open position and the seat body is in the upper position.

2. The vehicle according to claim 1,
wherein the seat body includes a seat back and a headrest provided above the seat back, and
when at least the part of the vehicle body-outer wall part is in the open position and the seat body is in the upper position, an upper end portion of the headrest is disposed above at least the part of the vehicle body-outer wall part having been in the closed position.

3. The vehicle according to claim 1,
wherein the vehicle body-outer wall part includes a vehicle body-upper wall portion that is disposed above the vehicle seats, and a sunroof that is mounted on the vehicle body-upper wall portion and is disposed at a position corresponding to the seat bodies,
the sunroof is provided to be switchable between the closed position and the open position, and
when the sunroof is in the open position and the seat body is in the upper position, at least the part of the seat body is disposed above the sunroof having been in the closed position.

4. The vehicle according to claim 3,
wherein one end portion and the other end portion of the sunroof in a front to rear direction are arranged at the same height position as the vehicle body-upper wall portion when the sunroof is in the closed position, and the one end portion and the other end portion are arranged at a position higher than the vehicle body-upper wall portion when the sunroof is in the open position.

5. The vehicle according to claim 3,
wherein one end portion and the other end portion of the sunroof in a front to rear direction are arranged at the same height position as the vehicle body-upper wall portion when the sunroof is in the closed position, and the one end portion is disposed at the same height position as the vehicle body-upper wall portion and the other end portion is disposed at a position higher than the vehicle body-upper wall portion when the sunroof is in the open position.

6. The vehicle according to claim 3,
wherein the vehicle includes a first seat body and a second seat body disposed behind the first seat body, on the vehicle body floor,
the moving device moves the second seat body between the reference position and the upper position as the operation part is operated, and
an upper end portion of the second seat body is disposed above the sunroof having been in the closed position and above an upper end portion of the first seat body when the sunroof is in the open position and the second seat body is in the upper position.

7. The vehicle according to claim 3,
wherein the vehicle body-outer wall part includes a first sunroof mounted on the vehicle body-upper wall portion and a second sunroof disposed behind the first sunroof, and
at least one of the first sunroof and the second sunroof is provided to be switchable between the closed position and the open position.

8. The vehicle according to claim 3,
wherein the vehicle includes a first seat body disposed below the vehicle body-upper wall portion and a second seat body disposed below the sunroof and behind the first seat body, on the vehicle body floor,
the moving device moves the second seat body between the reference position and the upper position as the operation part is operated, and
at least a part of the second seat body is disposed above the sunroof having been in the closed position when the sunroof is in the open position and the second seat body is in the upper position.

9. The vehicle according to claim 1,
wherein the vehicle includes a first seat body and a second seat body disposed behind the first seat body, on the vehicle body floor,
the moving devices move the first seat body and the second seat body between the reference position and the upper position as the operation parts are operated, and
the first seat body is disposed at a height position different from a height position of the second seat body when at least the part of the vehicle body-outer wall part is in the open position and the first seat body and the second seat body are in the upper position.

10. The vehicle according to claim 1,
wherein the vehicle seat includes a rotating device that allows the seat body to be mounted and to rotate with respect to the vehicle body floor about an axis parallel to an up to down direction, and
the rotating device rotates the seat body by being operated by the occupant when at least the part of the vehicle body-outer wall part is in the open position and the seat body is in the upper position.
